(19) United States
(12) Patent Application Publication
(10) Pub. No.: US 2024/0297314 A1
(43) Pub. Date: Sep. 5, 2024

(54) METAL OXIDATION WARMING SYSTEMS

(71) Applicant: Astrobotic Technology, Inc., Pittsburgh, PA (US)

(72) Inventors: CHANDRASHEKHAR SONWANE, MOJAVE, CA (US); GURJAP SINGH, UNIVERSITY PARK, PA (US); LAURENCE PETER LOHMAN, MOJAVE, CA (US); ALEXANDER RATTNER, UNIVERSITY PARK, PA (US); MATTHEW KUHNS, MOJAVE, CA (US)

(21) Appl. No.: 18/278,857

(22) PCT Filed: Feb. 24, 2022
(86) PCT No.: PCT/US2022/017701

§ 371 Date: Aug. 25, 2023

Related U.S. Application Data
(60) Provisional application No. 63/154,323, filed on Feb. 26, 2021.

(51) Int. Cl. H01M 8/04082; B01J 8/02; C01B 3/06; C01B 3/08; F24V 30/00; H01M 8/04007; H01M 8/0606

(52) U.S. Cl. CPC H01M 8/04216; B01J 8/0278; B01J 8/0285; C01B 3/065; C01B 3/08; F24V 30/00; H01M 8/04074; H01M 8/0606; B01J 2208/00176

(57) ABSTRACT

Embodiments of various aspects described herein are directed to a metal oxidation warming system (MOWS), a hydrogen storage system, and a co-generation system. These systems include an enclosure subdivided into a plurality of compartments, a fluid reservoir connected to a fluid manifold, and a plurality of fluid conduits connected through an inlet to the fluid manifold. Compartments include an active metal that reacts with a fluid delivered through the inlets and produces heat and hydrogen gas, which can be captured for heat and for driving a fuel cell.

### CROSS-REFERENCE TO RELATED APPLICATIONS

This application claims priority to and the benefit of U.S. Provisional Patent Application No. 63/154,323, filed on Feb. 26, 2021, which is hereby incorporated by reference herein in its entirety.

### STATEMENT REGARDING FEDERALLY SPONSORED RESEARCH

This invention was made with government support under contract No. 80NSSC20C0177 awarded by NASA. The Government has certain rights in the invention.

### TECHNICAL FIELD

The present invention relates to warming and power generation systems that can operate for extended periods of time, in any orientation, in microgravity, and in gravity free environments. More specifically, the present invention relates to metal oxidation warming systems (MOWS) and co-generation, based on MOWS, for use in space and other extreme environments.

### BACKGROUND

A critical need for crewed and un-crewed access to extreme environments is the need for controlling temperature and providing energy for the various systems needed to operate in the extreme environment. For example, for future lunar missions, both human and robotic, there is a need for landers, rovers, and instrumentation to survive and operate through the lunar night, which lasts approximately two Earth weeks. In addition, more broadly in space exploration, maintenance of onboard systems is critical during travel to the Moon or other extraterrestrial destination. Similarly, extreme environments on earth, such as at the poles or in the upper atmosphere, require heating and power solutions for vehicles and the like to remain operational for extended periods of time once deployed. Such environments present special challenges, such as reduced, micro, or no gravity; reduced atmosphere or vacuum; extremes of cold and heat; reduced sunlight; bombardment with radiation; and extremes in orientation as, for example, a vehicle enters a crater or crevasse.

The proven solution for surviving extreme environments, such as lunar environments, is a radioisotope thermoelectric generator (RTG). While these systems are robust and have flight heritage, they are highly radioactive, which imposes severe constraints on cost, availability, and safety. For near-term lunar missions, RTGs are impractical due to their prohibitive costs and associated regulatory concerns. Other existing thermal control systems use lithium-ion batteries or alkaline fuel cells, which are more available and cost-effective. However, these impose significant mass penalties, have relatively short lifespans, and require complex thermal or fluid systems.

Thus, there is a need for a new approach in power and heat generation for extreme environments to resolve the mismatch between practical requirements and limitations of the available solutions. The present disclosure is directed to solving these and other problems.

### SUMMARY

According to one implementation, a metal oxidation warming system (MOWS) includes an enclosure subdivided into a plurality of compartments; a fluid reservoir connected to a fluid manifold; a plurality of fluid conduits connected through an inlet to the fluid manifold; a thermal conduit connecting an interior of the enclosure to an exterior of the enclosure; and a gas exhaust conduit having a first end positioned in the interior of the enclosure and a second end positioned exterior to the enclosure. Each one of the plurality of fluid conduits is fluidly connected to a corresponding one of the plurality of compartments through an outlet.

According to another implementation, a method of heating an object using the MOWS, as described herein, includes placing an active metal in a compartment of the MOWS; adding fluid to the fluid reservoir; flowing the fluid from the reservoir to the fluid manifold; flowing the fluid from the fluid manifold through the fluid conduit to the compartment; allowing the fluid to exothermically react with the active metal; and directing the heat produced to an object by contacting the second end of the thermal conduit to the object.

According to another implementation, a MOWS includes a reactor, including a plurality of compartments, each compartment connected to a fluid conduit, and a gas exhaust conduit having a first end positioned in the interior of the enclosure and a second end positioned exterior to the enclosure. The MOWS also includes a fluid storage connected to a fluid manifold, the fluid manifold connected to the fluid conduit; a thermal conduit connected to the reactor; and a universal adaptor connected to the thermal conduit.

According to another implementation, a co-generation system includes a MOWS having the gas exhaust conduit, as described herein, and a hydrogen fuel cell connected to the gas conduit at the second end of the gas conduit, positioned exterior to the enclosure.

According to another implementation, a method of heating an object and producing electricity using the co-generation reactor, which includes the MOWS, as described herein. The method includes placing an active metal in a compartment of the co-generation system; adding fluid to the fluid reservoir; flowing the fluid to the fluid manifold; flowing the liquid from the fluid manifold through the fluid conduit to the compartment; and allowing the fluid to exothermically react with the active metal and produce hydrogen. The method further includes directing the heat produced to an object by contacting the second end of the thermal conduit to the object; and providing the hydrogen produced by the reaction to the fuel cell through the gas conduit.

According to another implementation, a co-generation system includes an enclosure, including a plurality of compartments, each compartment connected to a liquid conduit, and a gas exhaust conduit having a first end positioned in the interior of the enclosure and a second end positioned exterior to the enclosure. The co-generation system also includes a fluid storage connected to a fluid manifold, the fluid manifold connected to the fluid conduit; a fuel cell connected to the second end of the gas conduit; a thermal conduit connected to the enclosure and, directly or indirectly, connected to the fuel cell; and a universal adaptor connected to the fuel cell and to the thermal conduit.

According to some implementations, a flight stack includes an adaptor configured to connect to a heat pipe; a heat spreader connected to the adaptor; a stack of thermally conductive PCB boards; and an enclosure surrounding the stack. The stack is connected on a first end to the heat spreader and on a second end to an insulating base. The enclosure is also in contact with the insulating base and includes a thermally isolated opening for the heat pipe.

According to some implementations, a hydrogen storage system includes an enclosure subdivided into a plurality of compartments; a fluid reservoir connected to a fluid manifold; a plurality of fluid conduits connected through an inlet to the fluid manifold; and a hydrogen exhaust conduit having a first end positioned in the interior of the enclosure and a second end positioned exterior to the enclosure. Each one of the plurality of fluid conduits fluidly connected to a corresponding one of the plurality of compartments through an outlet. Optionally, at least one of the compartments includes an active metal, wherein the active metal reacts with water producing hydrogen.

According to some implementations, a wick includes an inert wicking material in contact with an active metal. Optionally, the active metal is an alkali metal, an alkali earth metal, a first row transition metal, a main group metal, a metalloid, yttrium, zirconium, a hydride thereof, a mixture thereof, or a salt thereof.

According to some implementations, a method of producing heat includes contacting a portion of a wick, as described herein, with a liquid. The liquid flows into the wick and reacts exothermically with the active metal when the liquid contacts the metal.

The above summary is not intended to represent each implementation or every aspect of the present disclosure. Additional features and benefits of the present disclosure are apparent from the detailed description and figures set forth below.

### BRIEF DESCRIPTION OF THE DRAWINGS

The disclosure will be better understood from the following description of exemplary embodiments together with reference to the accompanying drawings.

FIG. 1 depicts a wick, according to some implementations.

FIG. 2 depicts another wick, according to some implementations.

FIG. 3 depicts a wick with gaps, according to some implementations.

FIG. 4 shows the heat/H₂ output of the wick depicted by FIG. 3, according to some implementations.

FIG. 5A. shows a side view of a wick with active metal, according to some implementations.

FIG. 5B is a top view of the wick shown in FIG. 5A.

FIG. 6 depicts a MOWS, including co-generation, according to some implementations.

FIG. 7A is a perspective view of a flight stack, according to some implementations.

FIG. 7B is a perspective view of an enclosure for the flight stack shown in FIG. 7A.

FIG. 8A depicts a front cross section view of a MOWS, according to some implementations.

FIG. 8B depicts a top cross section view of the MOWS shown by FIG. 8A.

FIG. 8C depicts a top cross section view of a MOWS having a cylindrical shape, according to some implementations.

FIG. 9A depicts a perspective view of a co-generation system, according to some implementations.

FIG. 9B depicts a top section view of the co-generation system show by FIG. 9A.

FIG. 10A depicts a front section view of a co-generation system, according to some implementations

FIG. 10B depicts a top section view of the co-generation system shown by FIG. 10A.

FIG. 11 shows a schematic of a hydrogen generation system using water vapor, according to some implementations.

FIG. 12 shows a schematic of a hydrogen generation system using liquid water, according to some implementations.

FIG. 13 depicts a small-scale, test-tube reactor, according to some implementations.

FIG. 14 depicts the small-scale, test-tube reactor of FIG. 13 and a data acquisition system, according to some implementations.

FIG. 15 shows a plot of water addition vs. hydrogen flow rate for a first test, according to some implementations.

FIG. 16 depicts the cumulative evolution of hydrogen vs. water added for the first test, according to some implementations.

FIG. 17 depicts a reactant-specific energy plot for the first test, according to some implementations.

FIG. 18 shows a plot of water addition and hydrogen flow rate for a second test, according to some implementations.

FIG. 19 shows the cumulative evolution of hydrogen vs. water added for the second test, according to some implementation.

FIG. 20 depicts a reactant specific energy plot for the second test, according to some implementations.

FIG. 21 shows a plot of water addition vs. hydrogen flow rate for a third test, according to some implementations.

FIG. 22 shows cumulative evolution of hydrogen vs. water added for the third test, according to some implementations.

FIG. 23 shows a reactant specific energy plot for the third test, according to some implementations.

FIG. 24. Shows a plot of water addition vs. hydrogen flow rate for lithium hydride powder, according to some implementations.

FIG. 25. Shows cumulative evolution of hydrogen vs. water added for lithium hydride, according to some implementations.

FIG. 26 shows reactant specific energy plot for lithium hydride powder, according to some implementations.

FIG. 27 depicts a reactor with a water dripper, according to some implementations.

FIG. 28 depicts a reactor with a water sprayer, according to some implementations.

FIG. 29A-29F show stills from high-speed photography, according to some implementations. FIG. 29A shows a Nikon D5100 camera upwards spray, FIG. 29B shows a Nikon D5100 camera sideways/horizontal spray, FIG. 29C shows a Nikon D5100 camera downwards spray, FIG. 29D shows a Phantom camera upwards spray, FIG. 29E shows a Phantom camera sideways/horizontal spray, FIG. 29F shows a Phantom camera downwards spray.

FIG. 30 depicts a reactor with a wick, according to some implementations.

FIG. 31A-31B depict aspects of a bottle reactor, according to some implementations. FIG. 31A is a plot of heat delivery vs. time. FIG. 31B is a plot of temperature vs. time. FIG. 31C shows the bottle reactor top to bottom: pre-test, after first oxidizer injection, after an additional 0.5 hours, and post-test.

FIG. 32A-32E are time series plots showing experimental data (blue line, brown line) and lumped-parameter dynamic model outputs (red line) for the bottle reactor, according to some implementations. FIG. 32A depicts estimated water flow rate. FIG. 32B depicts heat delivery. FIG. 32C depicts reactor temperature. FIG. 32D depicts thermal ground plane temperature. FIG. 32E depicts enclosure temperature.

FIG. 33A-33C are time series plots for PI controller simulation, according to some implementations. FIG. 33A depicts commanded water flow rate (blue line). FIG. 33B depicts reactor temperature (blue line). FIG. 33C depicts enclosure temperature (reference: blue line, simulation output: brown).

FIG. 34A-34C are time series plots for bang-bang thermostat controller simulation, according to some implementations. FIG. 34A depicts commanded water flow rate (blue line).

FIG. 34B depicts reactor temperature (blue line). FIG. 34C depicts enclosure temperature (reference: blue line, simulation output: brown).

FIG. 35 depicts a reaction test stand, according to some implementations.

FIG. 36 depicts the progression of a lithium-water reaction over time, according to some implementations.

FIG. 37 depicts an experimental apparatus for vapor-phase oxidizer testing, according to some implementations.

FIG. 38A-38B depict a low-temperature testing apparatus, according to some implementations. FIG. 38A depicts the experimental apparatus, including silicone oil bath and circulating chiller. FIG. 38B depicts reaction test tube displaying foaming behavior.

FIG. 39 depicts a thermal resistance circuit for heat transfer from a reactor to the enclosure, according to some implementations.

FIG. 40 is an illustration of a flight stack, according to some implementations.

FIG. 41 is an illustration of the flight stack enclosure, according to some implementations.

FIG. 42 depicts a heat pipe testing apparatus, according to some implementations.

FIGS. 43A and 43B show a top view of fin configurations for wall separating an enclosure, according to some embodiments. FIG. 43A is a first design. FIG. 43B is a second design.

FIG. 44 depicts a printed test tube, according to some implementations.

FIG. 45 depicts a printed NPT thread, according to some implementations.

FIG. 46 depicts a perspective view of a reactor body, according to some implementations.

FIG. 47 depicts a section view of a reactor cap design, according to some implementations.

FIG. 48 depicts an exploded view of a reactor, according to some implementations.

FIG. 49 depicts CFD analysis of oxidizer flow through tubes, according to some implementations. Top: overall view of the analysis; bottom: detailed view of the holes.

FIG. 50 depicts a mesh for thermal analysis, according to some implementations.

FIG. 51 depicts an assembled flight stack, according to some implementations.

FIGS. 52A and 52B show an experimental setup, according to some implementations.

FIG. 52A shows the experimental setup and FIG. 52B shows the experimental setup covered by a vacuum chamber.

FIG. 53A-53B depicts a MOWS reactor system, according to some implementations.

FIG. 53A is a first side view. FIG. 53B is a second side view.

FIG. 54 depicts the experimental setup for measuring performance of a MOWS reactor, according to some implementations.

While the present disclosure is susceptible to various modifications and alternative forms, specific implementations and embodiments thereof have been shown by way of example in the drawings and will herein be described in detail. It should be understood, however, that it is not intended to limit the present disclosure to the particular forms disclosed, but on the contrary, the present disclosure is to cover all modifications, equivalents, and alternatives falling within the spirit and scope of the present disclosure as defined by the appended claims.

### DETAILED DESCRIPTION OF THE INVENTION

The present disclosure can be embodied in many different forms. Representative embodiments are shown in the drawings and will herein be described in detail. The present disclosure is an example or illustration of the principles of the present invention and is not intended to limit the broad aspects of the disclosure to the embodiments illustrated. To that extent, elements and limitations that are disclosed, for example, in the Abstract, Summary, and Detailed Description sections, but not explicitly set forth in the claims, should not be incorporated into the claims, singly or collectively, by implication, inference, or otherwise. For purposes of the present detailed description, unless specifically disclaimed, the singular includes the plural and vice versa; and the word “including” means “including without limitation.” Moreover, words of approximation, such as “about,” “almost,” “substantially,” “approximately,” and the like, can be used herein to mean “at,” “near,” or “nearly at,” or “within 3-5% of,” or “within acceptable manufacturing tolerances,” or any logical combination thereof, for example.

Embodiments of various aspects described herein are, at least in part, based on the discovery that metal oxidation reactions can be harnessed in systems for providing heat and electricity. Such systems are largely agnostic to gravity and so can be used in any orientation where there is gravity and also can operate where there is no gravity, such as in space or in micro/reduced gravity, such as on the Moon. The systems can also be operated under >1 g gravity. Additionally, the systems are operationally simple, having few moving parts and relying on thermodynamically driven chemical reactions, movement of fluids by capillary action, and at least partially passive collection of off-gas to drive fuel cells. The systems can be used, for example, in extreme environments, such as in space, on the Moon, and in polar regions of the earth.

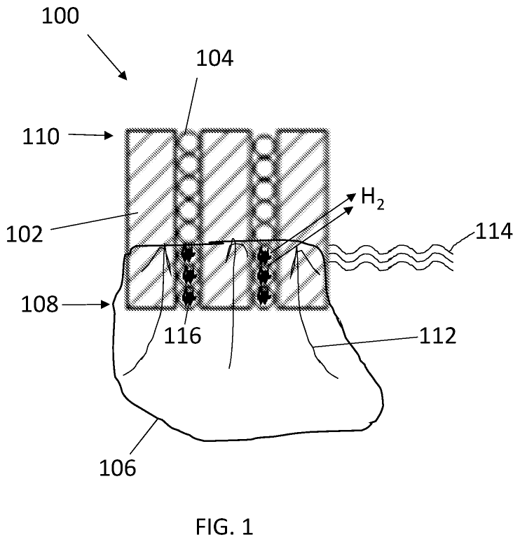

FIG. 1 depicts a wick 100, according to some implementations of the description. The wick includes an inert wicking material 102 in contact with an active metal 104. The inert wicking material 102 can be any material that provides movement of liquid therethrough. For example, contact of the liquid 106 at a first end 108 of the wick 100 provides transport of the liquid 106 by capillary action towards the second end 110, as indicated by arrows 112. As the liquid front moves through the wick 100, it contacts and reacts with the active metal 104, producing heat 114 and hydrogen gas H₂. Spent metal 116 is left in the inert wicking material 102 or dissolves in the liquid 106.

As used herein, “inert” refers to an element (e.g., compound, chemical element, material, or component) not reacting or otherwise interacting with other elements to impede their intended function. For example, the intended function of the wick material is to transport a liquid through the wick, and the intended function of the active metal is to react with the transported liquid. In some implementations, the wick is used in an inert gas environment, such as nitrogen, helium, or argon. In some implementations, the wick can be used in at least a partial hydrogen atmosphere. Where hydrogen is not generally regarded as inert, it is inert to at least some reactive metals, as described herein.

The active metal can be any metal or metal-containing compound that will react with the liquid to provide an exothermic reaction. For example, according to some implementations, the active metal is an alkali metal, an alkali earth metal, a first row transition metal, a main group metal, a metalloid, yttrium, zirconium, a hydride thereof, a mixture thereof, or a salt thereof. According to some implementations, the active metal can be Li, LiH, NaH, AlH₃, LiBH₄, NaBH₄, CaH₂, Al(BH₄)₃, or MgH₂. In some implementations, Li metal is used, and in some implementations, LiH is used.

The liquid can be any pure liquid or mixture that reacts with the selected active metal exothermically. In some implementations, the liquid includes water, hydrogen peroxide, organic peroxides, alcohols, or mixtures of these. In some implementations, the liquid is water. In some implementations, freezing point depression compounds or “anti-freeze” are added to the liquid. Without limitations and by way of example, these anti-freeze compounds can be a salt (e.g., sodium chloride, calcium chloride, magnesium chloride, sodium formate, potassium formate, sodium acetate, and potassium acetate), an alcohol (e.g., methanol, ethanol), a diol (e.g., ethylene glycol, propylene glycol, propylene methyl ether), a triol (e.g., glycerol), a polyol (e.g., polyethylene glycol), sugars (e.g., sorbitol), and mixtures of these. In some implementations, activating agents such as HCl and HF are added. Without being bound to a specific mechanism, it is believed that the additives help dissolve any reactant or side products that can form on the active metal 104, which would otherwise impede or slow further reaction of the active metal with the liquid.

Without limitation and by way of examples active metal 104 and liquid 106, the reaction of Li metal and water, is outlined in Equations 1 and 2.

Li(s)+H₂O(l)=LiOH(s)+½H₂(g);ΔHf=188.59 kJ/mol. Eq. 1:

Barring any conditions to stop further reaction, the LiOH(s) will react to form the hydrate, as shown in Equation 2. Since lithium hydroxide (Li(OH)·H₂O) is soluble in water, lithium hydroxide will dissolve in any additional water.

LiOH(s)+H₂O(l)=Li(OH)·H₂O(aq);ΔHf=19.54 kJ/mol. Eq. 2:

The first reaction produces half a mole of dihydrogen gas (H₂) per mole of Li and a mole of water and heat. The second reaction produces about a tenth of the heat and consumes an additional mole of water.

As another example, the reaction of LiH, as the reactive metal 104, and water, as the liquid 106, is outlined in Equation 3.

LiH(s)+H₂O(l)=LiOH(s)+H₂(q);ΔHf=97.96 kJ/mol. Eq. 3:

As in the previous reactions, the LiOH(s) will react to form the soluble hydrate as shown in Equation 2. The hydration reaction can be reversed under appropriate conditions of vacuum and heat.

As previously described, the wicking material 102 is an inert material. In some implementations, the inert wicking material 102 includes a synthetic organic polymer, cellulose, cotton, alumina-based glass, silica-based glass, or combinations of these. The exact material selected depends on the active metal/liquid reaction selection. For example, in the above reactions, the product of Equation 2, hydrated liquid hydroxide, is a base and will create a caustic aqueous solution to form. Under these conditions, some materials can react and degrade. For example, cotton and other cellulosic materials degrade under basic conditions and would not be appropriate as a wicking material unless degradation of the material is not important to a specific use for the wick 100. For example, if the heat of the degradation reaction is desired, then a reacting wick can be used. In some implementations, the inert wick material is a synthetic organic polymer, alumina-based glass, silica-based glass, or combinations of these.

The form of the inert wicking material is not particularly limited, as long as it can provide wicking through capillary action. As used herein, “capillary action” is defined as the ability of a liquid to flow through narrow spaces due to intermolecular forces between the liquid and the surrounding material defining the narrow spaces. For example, the narrow spaces can be provided by one or more thin “capillary” tubes; fibers positioned close to each other, such as in a web or mat fibers (woven or non-woven); and small interconnected pores, such as in a sponge. Accordingly, in some implementations, the inert wicking material can include fibers of an inert material. In some implementations, the wick comprises threads or strings (e.g., woven threads or strings). The threads or strings can be randomly arranged or more organized, such as in parallel or interweaved to form a larger unit such as a rope (e.g., a “traditional” wick such as for a candle). In some implementations, the wicking material is formed as a capillary bed. As used here, a “capillary bed” refers to a plurality of capillary tubes arranged as an interweaving network or parallel to each other. Each tube provides movement of water and can also include small pores or openings along the length of the capillary. In some implementations, the individual capillaries in the capillary bed have an average diameter less than about 1 mm (e.g., less than about 0.9 mm, 0.8 mm, 0.7 mm, 0.6 mm, or 0.5 mm). In some implementations, the average diameters of the narrow spaces provided by the wicking materials have an effective diameter less than about 1 mm (e.g., less than about 0.9 mm, 0.8 mm, 0.7 mm, 0.6 mm, or 0.5 mm). For example, the capillary sizes can be estimated by porometry methods, such as capillary flow porometry, bulk volume measurements, compression measurements, mercury porometry, gas expansion porometry, direct optical methods, SEM imaging, and X-ray tomography methods.

In some implementations, the active metal is a particulate or powder. For example, the active metal can be in the form of a powder, including particulates of any shape, such as rods, fibers, flakes, plates, lozenge, cubes, rhombohedrum, spheroids (sphere-like but not perfectly spherical body), and mixtures of these. In some implementations, the largest dimension of the particulate is less than about 10 mm (e.g., less than about 5 mm, less than about 2 mm, or less than about 1 mm). In some implementations, the particulate has an aspect ratio (largest to smallest dimension) between about 1.5 and 10. In some implementations, the active metal is a fine powder, having an average diameter of about less than 10 mm (e.g., less than about 5 mm, less than about 2 mm, or less than about 1 mm). For example, powder LiH is often sourced as a fine powder having an average diameter around 0.6 mm. In some implementations, the particulate has a narrow and mono-modal particle size distribution, such as with at least 80% (e.g., at least 90% or 95%) of the number of particles within ±10% of the average particle size. In some implementations, at least 80% (e.g., at least 90%, 95%) of the volume of particles is within ±10% of the average particle size. In some implementations, the metal is provided as a fine wire, or multiple fine wires, having a diameter less than about 5 mm (e.g., less than about 4 mm, less than about 2 mm, or less than about 1 mm) and a length of at least 10 times the width (e.g., at least 20, 30, 40, or 50 times the width).

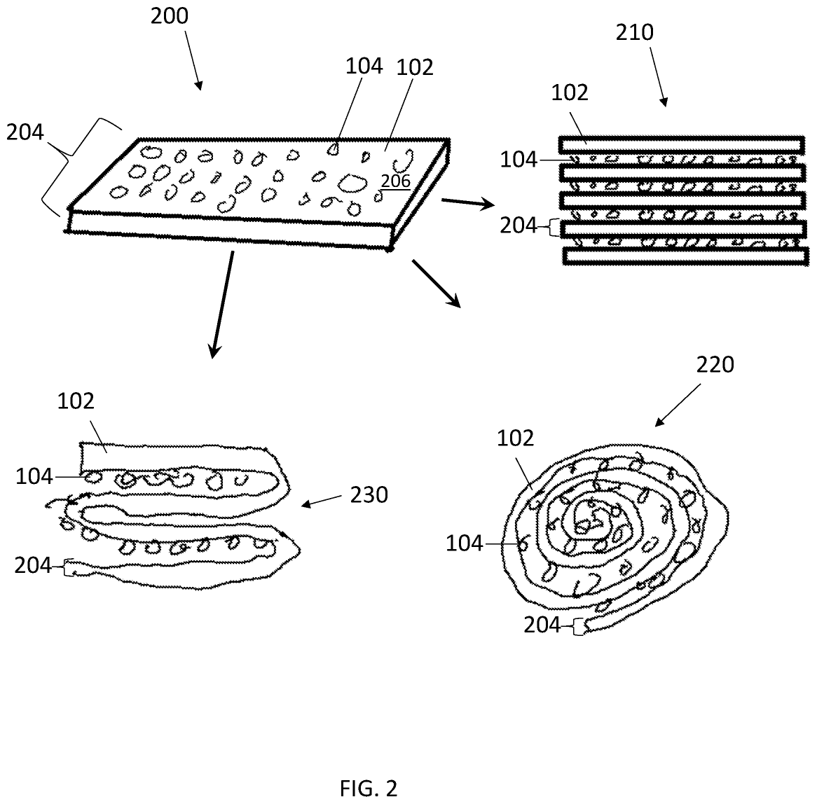

In some implementations, as illustrated in FIG. 2, the wick 200 is formed by a layer of active metal 104 on a sheet or layer 204 formed from the wicking material 102. The wick 200 can be further manipulated to be stacked into a multi-layer structure 210, a pinwheel structure 220, or an accordion structure 230. These structures surround the active metal 104 with the wicking material 102 from multiple sides providing liquid access to the active metal 104. These structures also provide a more compact form factor. The active metal 104 is shown in FIG. 2 as particulate. However, other configurations are contemplated, such as a foil, a grid, or wires. In addition, the active metal 104 can be more densely packed or less densely packed. In some implementations, the active metal 104 forms a monolayer of close-packed particles. In some implementations, the active metal 104 forms a multilayer of close-packed particles. In some implementations, the active metal 104 covers less than 100% of the surface area 206 of the layer 204 (e.g., less than 90%, less than 50%, less than 10%).

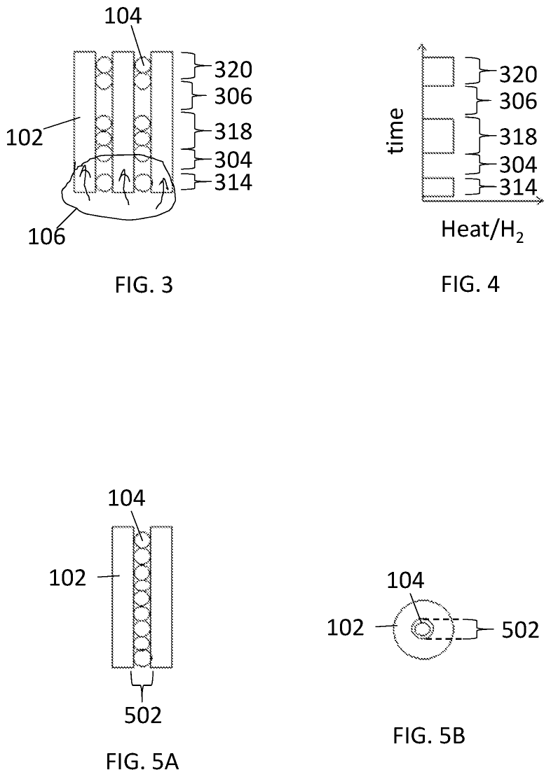

In some implementations, the active metal is arranged sequentially in a row or line, such as illustrated in FIG. 1. This arrangement can provide a constant reaction between the liquid 106 and active metal 104 as the liquid 106 progresses through the wick 100. In some implementations, the active metal is arranged in a row or line, including some gaps between the metals. For example, as shown in FIG. 3, where a particulate active metal 104 is arranged with gaps 304 and 306. Such an arrangement can provide variability in the reaction of active metal 104 as the liquid 106 flows through the wicking material 102. For example, if active metal 104 is lithium and the liquid 106 is water, heat/H₂ is produced in regions 314, 318, 320 when the liquid 106 passes through these regions. No heat/H₂ is produced in regions 304, 306 when the liquid 106 passes through those regions. This provides a heat/H₂ output roughly a square wave with respect to time, as illustrated in FIG. 4. As time progresses, heat/H₂ output is modulated: regions 314, 318, 320 correspond to high heat/H₂ output; regions 304, 306 correspond to low heat/H₂ output. It is contemplated that other arrangements can be used to provide other variable energy outputs. For example, denser packing or larger particles of active metal 302 can cause higher heat/H₂ outputs at a given time.

In some implementations, the active metal is arranged in a row or line and is surrounded by the inert wicking material. For example, where the inert material 102 forms a channel or tunnel 502 containing the active metal 104, as illustrated by FIG. 5A (cross-cut view) and FIG. 5B (top view).

In some implementations, the active metal is dispersed throughout the inert wicking material. In some implementations, the active metal is evenly distributed throughout the inert wicking material. For example, the concentration of active metal per cubic cm is about equal throughout the wicking material. In some implementations, the inert material can be a fibrous material blended with the active material particle to produce an even distribution throughout the inert material. In some implementations, the active material is unevenly distributed throughout the inert wicking material.

In some implementations, the wick is configured as a rectangular sheet or a cylinder. In some implementations, the wick includes supporting structures. In some implementations, the support structure is a structure external to the wick, such as a mesh, cylinder or the like surrounding the wick and contacting an outer surface of the wick. In some implementations, the support structure is internal to the wick. In some implementations, the support structure is made of an inert material. For example, in some implementations, the support structure is made of an inert metal, alloy, or a polymer. The support structure can be implemented for embodiments where the wick is not rigid enough to maintain its ideal shape for operating.

Because the wick operates by capillary action, the wick can be used in an environment that is gravity-free, a microgravity, an artificial gravity, or in any orientation in a gravity field. Only a source of liquid that reacts with the active metal is needed. Such a source can be provided by a container, for example, attached to end 108 (FIG. 1) of the wick 100. The wick can be implemented in the MOWS systems described herein and described in more detail in the forgoing.

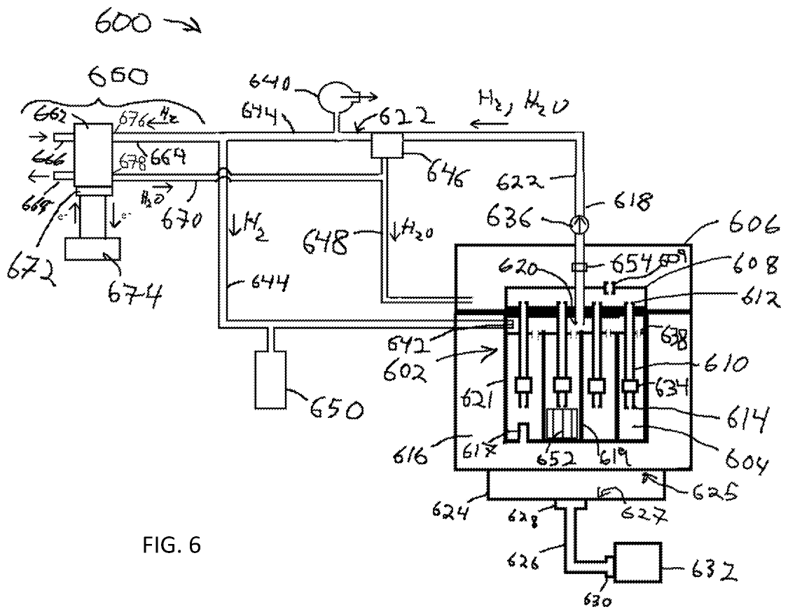

FIG. 6 depicts a front cross-section view of a MOWS 600 according to some implementations. The MOWS includes an enclosure 602 that is subdivided into a plurality of compartments 604. A fluid reservoir 606 is connected to a fluid manifold 608. For example, the connection can be through a fluid conduit 609. In some implementations, the fluid conduit 609 includes a valve for control of fluid flowed therethrough—(e.g., a one-way valve such as having a crack pressure 0.5, 1, 3, or 5 psi). In some implementations, the flow of fluid through fluid conduit 609 is controlled by a porous membrane and a pressure applied to the fluid placed in fluid reservoir 606.

A plurality of fluid conduits 610 are fluidly connected through an inlet 612 to the fluid manifold 608. Each one of the fluid conduits 610 is fluidly connected to the compartments 604 through an outlet 614. In some implementations, the outlet is configured as a porous wall or portion of wall that allows fluid to flow through fluid conduit 610, for example, responsive to pressure applied to a fluid in fluid manifold 608. A thermal conduit 616 connects the interior of the enclosure 602 to the exterior of the enclosure, thereby transferring heat from the interior of the enclosure 602 to the thermal conduit 616. A gas exhaust conduit 618 includes a first end 620 positioned in the interior of the enclosure 602 and a second end 622 positioned exterior to the enclosure.

As used herein a “thermal conduit” is a device or element, such as a pipe, covering, plate, or wall, that has a high thermal conductivity and transmits thermal energy efficiently (e.g., with low loss). In some implementations, the thermal conduit includes one or more thermally conductive materials such as copper and other metals, diamond, carbon nanotubes, and carbon fibers. In some implementations, the thermal conduit includes a heat pipe.

According to some implementations, the thermal conduit 616 includes a portion positioned in one or more of the compartments, such as a protrusion 617. In some implementations, the thermal conduit includes a wall 619 partitioning the enclosure into the plurality of compartments. In some implementations, the thermal conduit is a wall 621 that defines the interior of the enclosure 602.

According to some implementations, the thermal conduit 616 is connected to a universal heat adaptor 624. In some implementations, the universal heat adapter 624 includes a first surface 625 that facilitates transfer of heat from the thermal conduit 616 to the universal heat adaptor 624, and a second surface 627 that facilitates transfer of heat from the universal heat adaptor 624 to an external load. In some implementations, the universal heat adaptor 624 is coupled to an external thermal conduit 626 through a first end 628. The external thermal conduit 626 is connected by a second end 630 to the external thermal load 632. The external thermal conduit 626 can be of any length and shape, for example, to reach an external load 632 that is close to the universal heat adaptor 624 or to reach an external load 632 that is placed further from the universal heat adaptor 624. In some implementations, the thermal load 632 is directly coupled to the universal adaptor 624, such as by direct contact with surface 627, obviating the need for the external thermal conduit 626.

In some implementations, coupling at the first end 628 and/or second end 630 is reversible. For example, physical couplings can include bolts, nuts, clips, latches, screws, compression fittings, male to female fittings, rail and groove, ball and socket, and other fasteners. In some implementations, a thermal paste is included at the interface of the first end 628 and surface 627 of the universal coupler 628. In some implementations, a thermal paste is used at the interface of the second end 630 and the thermal load 630. In implementations where the thermal load 632 is directly coupled to universal heat adaptor 624, the coupling can be similarly reversible, for example, include physical couplers, as described herein, and optional thermal paste. In some implementations, coupling of the first end 628 and/or second end 630 is not reversible. For example, coupling can be by welding, or the universal heat adaptor 624, external thermal conduit 626, and thermal load 632 can be formed of a single machined piece.

In some implementations, the MOWS 600 includes a mister or atomizer 634 in line with the fluid conduits 610. In some implementations, the outlet 614 is configured as a spray nozzle. The mister 634 or spray nozzle provides a fluid through outlet 614 as a mist to the compartments 604. For example, providing micro or nano-sized drops. In some implementations, flow is controlled through the outlet 614, at least in part, by a pump coupled to the manifold 608 and fluid conduits 610. In some implementations, the flow is controlled through outlet 614, at least in part, by a pump coupled to the reservoir 606 and manifold 608. For example, a pump can be configured to flow fluid from the reservoir 606 to the manifold 608 and then through outlet 614 (e.g., by creating a pressure difference between manifold 608 and conduit 610). In some implementations, fluid manifold 608 includes a valve to control the flow of fluid to each of the plurality of fluid conduits 610. In some implementations, flow is controlled through outlet 614 by a valve placed anywhere in line with conduit 610, such as a valve at inlet 612, a valve at outlet 614, or a valve at any position between 612 and 614. In some implementations, the valve is a one-way valve, for example, having a crack pressure of 0.5, 1, 3, or 5 psi.

In some implementations, no pump is used for flowing fluid through fluid conduits 610, for example, in implementations wherein a wick as previously described is used. In such implementations, the wick can draw the liquid out of the manifold 608 without need of a pump. In some implementations, a wick 652 is placed in the compartments 604 and can include any of the wicks as previously described. In some implementations, the wick 652 directly contacts the outlet 614. In some implementations, the wick can fill a larger portion of the compartment 604 than shown. For example, the wick can fill greater than 50% of available volume in compartment 604, or greater than 60%, 70%, 80%, or 90%. However, expansion due to reaction and liquid adsorption requires some expansion space to be provided for. According to some implementations, less than 90%, less than 80%, less than 70% of the available volume is used for the wick 652.

In some implementations, wicking is provided by a superwicking nanostructured surface, such as a nanostructure patterned on walls 619. This superwicking nanostructured surface can be used in addition to the wick 652 or instead of wick 652. Such superwicking nanostructured surfaces can be as described in Sananta et al., “Nanosecond Pulsed Laser Processing Turns Engineering Metal Alloys Antireflective and Superwicking,” Procedia Manufacturing 34 (2019) 260-268.

In some implementations, each fluid compartment 604 is fluidly sealed. That is, fluid does not flow between each of the compartments, and each compartment is configured to independently contain reactants and products therein without contamination from neighboring compartments 604. In other implementations, the walls 619 are porous or have fluid conduits that allow the passage of liquids between compartments 604. In such implementations, the flow can be responsive to pressure to control the amount of fluid flowing between compartments 604.

In some implementations, the gas exhaust conduit 618 includes a check valve or pressure relief valve 636 oriented to allow flow of gas out of the enclosure but not into the enclosure. For example, check valve 636 can have a 0.5, 1, 3, or 5 psi crack pressure. In some implementations, the compartments 604 include an inlet 638 to the first end 620 of the exhaust gas conduit 618. The inlets 638 can include a check valve oriented to allow flow of gas out of the compartment 604.

In some implementations, the gas exhaust conduit 618 is connected to low-pressure source 640 at a second end 622. For example, the lower pressure source can be space, an extraterrestrial atmosphere, a vacuum pump, or a blower. The gas exhaust conduit 618 can also be connected through branch 644 of exhaust conduit 618 to an inlet 642 to the enclosure 602. Therefore, the exhaust conduit 618, branch 644, and enclosure 602, in some implementations, form a recycling system for gases. In some other implementations, the second end 622 is open to the environment for expelling any exhaust gas in exhaust conduit 618 to an atmosphere.

In some implementations, the gas exhaust conduit 618 is connected to a dehydration system 646. For example, the dehydration system can be positioned between the first end 620 and a second end 622. Without limitation and by way of example, the gas exhaust conduit can include a desiccant, a condenser, a bubbler, a separation membrane, or any combination of these. In some implementations, the dehydration system 646 is connected to a branch 648. The branch 648 is connected to the liquid manifold 608. Therefore, the dehydration system can, in some implementations, provide a liquid stream to liquid manifold 608 through branch 648 and a dry gas stream to enclosure 602 through branch 644. The dry gas branch 644 can optionally be connected to a dry gas source 650 (e.g., an inert gas such as He, Ar, N₂) to compensate for any losses, for example, to low-pressure source 640.

According to some implementations, a mesh or filter 654 is positioned in-line with the gas exhaust. In some implementations, a mesh of filter is positioned in the enclosure 602, such as at inlets 638. The mesh or filter 654, similarly placed in enclosure 602, are configured to allow gases and aerosolized liquids into the gas exhaust but exclude solid particulates. In some implementations, the filter 654 has a mesh size greater than 75 (e.g., greater than about 100, 150, or 200).

In some implementations, the MOWS 600 includes a thermal reservoir. The thermal reservoir is configured to absorb heat from any reaction heat produced in enclosure 602 and provide a slower release to the thermal conduit 616. This can mitigate against any fluctuations in production of heat or demand for heat. In some implementations, the thermal reservoir includes a material that undergoes a phase change, such as a wax, to absorb or release heat. In some implementations, the thermal reservoir includes elements or compounds that undergo a reversible chemical reaction to absorb or release heat. In some implementations, the thermal reservoir is enclosed in a container to avoid cross contamination with reactants that are placed in the compartments 604. In some implementations, the thermal reservoir can be part of the walls 619 or a floor/ceiling of the compartments 604.

The MOWS 600 can be used to produce heat and, for example, heat a thermal load 632. In some implementations, at least one of the compartments 604 is charged with an active metal, wherein the active metal reacts exothermically with a fluid delivered from the fluid conduit 610. In some implementations, the active metal is a finely divided powder with an average particle size diameter below about 10 mm. In some implementations, the active metal can include an alkali metal, an alkali earth metal, a first-row transition metal, a main group metal, a metalloid, yttrium, zirconium, a hydride thereof, a mixture thereof, or a salt thereof. As previously described, a wick 652 can be used, which includes one or more active metals.

Heat can be produced, according to some implementations, by adding fluid to the fluid manifold 606 and flowing the fluid from the fluid manifold. The manifold distributes fluid through fluid conduit 610 to compartments 604. The fluid reacts exothermically with the active metal in compartments 604, and heat that is produced is directed through thermal conduit 616 out of enclosure 602. The heat can further be directed to the thermal load 632 through universal heat adaptor 624 and external heat conduit 626.

In some implementations, the interior of the enclosure 602 includes an inert gas atmosphere. For example, nitrogen, argon, helium, or mixture of these. In some implementations, the inert atmosphere includes less than 1% oxygen. In some implementations, the inert atmosphere includes H₂. Since H₂ is a reaction product between water and active metals described herein, H₂ will not further react with or contaminate the active metals. Accordingly, in some implementations, a gas including H₂O, H₂, or combinations of these is exhausted through fluid conduit 618. The H₂O can be recycled by implementing condenser 646 and returning liquid H₂O through branch 648 to fluid reservoir 606. The H₂ can be returned to enclosure 602 through branch 644. In some implementations, the H₂O and H₂ are removed from the system through a low-pressure source 640.

In some implementations, the H₂ is harnessed and used for co-generation. For example, 660 illustrates a fuel cell subsystem. In this implementation, a hydrogen fuel cell 662 is connected via fuel cell branch 664 to the exhaust gas conduit 618 through second end 622 and branch 644. An H₂ inlet 676 and H₂/H₂O outlet 678, and an oxidant inlet 666 and oxidant outlet 668 are shown. In some implementations, the oxidant is stored oxygen, hydrogen peroxide, N₂O, Ozone, or combinations of these. In some implementations, the oxidant is oxygen provided by air, such as when the system is used on earth. In some implementations, a further system can be used to provide oxygen through electrolysis. For example, water sourced from fluid reservoir 606 or from branch 644 can supply the water to an electrolysis system. In some implementations, the fuel cell includes an H₂O exhaust connected to a H₂O conduit 670. The H₂O conduit is connected to branch 648 or directly to fluid reservoir 606.

In some implementations, the fuel cell subsystem 660 includes a universal electric adaptor 672. The universal adaptor can include multiple connectors such as plugs or contact pads for connecting to a system requiring electric power, such as electric load 674. The universal adaptor can also include switches to toggle between different transformers or voltage dividers to provide different voltages and/or changes from DC to AC voltage supply.

In some implementations, the fuel cell is a flow through a proton exchange membrane (PEM) fuel cell. In some implementations, the fuel cell is a dead-ended PEM fuel cell. In some implementations, the thermal conduit 616 includes a wall that is in direct contact with a wall of the fuel cell.

In operation, the MOWS 600, where the fuel cell subsystem 660 is used, can heat an object, such as thermal load 632, and provide electric power to an electric load 674.

In some implementations, only an electricity generation system is needed. The system 600 can be appropriately modified by eliminating heat conduits 616, universal heat adaptor 624, external heat pipe 626, and thermal load 632.

According to some implementations, the system 600 can be adapted for hydrogen storage. For such implementations, the heat conduits 616, universal heat adaptor 624, external heat pipe 626, and thermal load 632 are not required. Additionally, the subsystem 660 is not required when system 600 is modified for hydrogen storage.

The various components of MOWS system 600 can be made using any materials. For example, the components can include one or more metals, ceramics, or plastics. These can be bought as off-the-shelf components or specialty made. In some implementations, materials for construction include metals (e.g., stainless steel, titanium, copper, aluminum), thermoplastics, thermosets, UV-curable polymers, carbon fiber, synthetic rubber, and natural rubber. In some implementations, the materials are selected to have a low degree of outgassing to the environment around MOWS 600. In some implementations, materials are selected to RML<1.0% and CVCM <0.1% on based upon the micro-VCM test as per ECSS-Q-70. In some implementations, the materials are selected based on NASA Reference Publication 1124, 4th edition, June 1997 “Outgassing Data for Selecting Spacecraft Materials.”

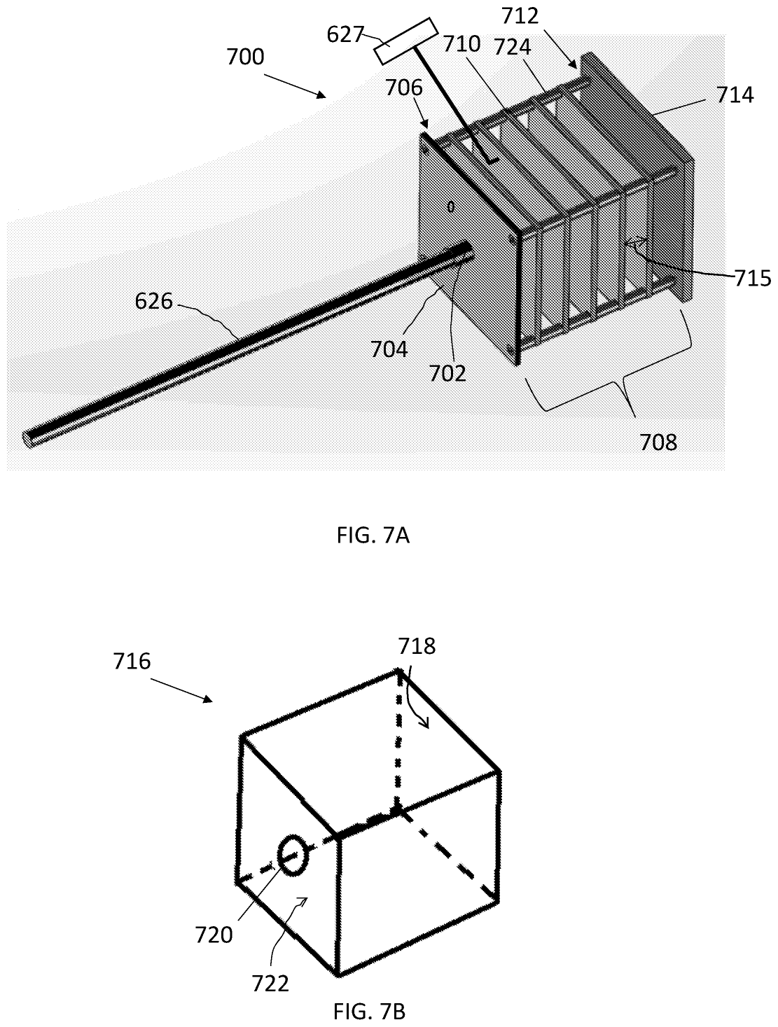

The thermal load 632 can be any object in need of heating. In some implementations, the thermal load is a flight stack 700, as depicted by FIG. 7A. The flight stack 700 includes an adaptor 702 that is configured to connect the heat conduit 626. For example, in some implementations, the conduit 626 is a heat pipe. The adaptor is connected to a heat spreader 704. The adaptor 702 can be configured as any adaptor, such as a male-female connector. In addition to physical connection, the connector provides a thermal connection, and a thermal paste can be applied to any connecting surfaces between adaptor 702 and heat conduit 626.

The heat spreader 704 is thermally connected on a first end 706 to a stack 708 of thermally conductive PCB boards 710. Although not shown for clarity, the PCB board includes various electrical components, such as wires (e.g., any electric contacts/lines), microchips, microcontrollers, memory, CPUs, receivers, and transmitters. The stack 708 is thermally connected on a second end 712 to an insulating base 714. The stack 708 is surrounded by an enclosure 716, depicted by FIG. 7B. A wall 718 of enclosure 716 contacts the insulating base 714. An opening 720, on a wall 722 opposite to wall 718, provides a thermally isolated opening for the heat conduit 626. In some implementations, the edges of wall 720 defining opening 720 are thermally isolated from heat conduit 626 by a gap. In some implementations, the edges of wall 718 are isolated from heat conduit 626 by a thermally insulating material.

In some implementations, the enclosure 716 provides a physical protection to the flight stack 700. For example, the enclosure 716 can provide protection to the flight stack in the event of some foreign object inadvertently introduced in the environment, such as dust or a loose piece of external equipment (e.g., due to accidental release/damage). In some implementations, the enclosure 716 provides protection from external radiation and/or radio waves. In some implementations, the enclosure 716 is thermally conductive, such as made of a metal. Accordingly, it is isolated from heat provided by thermal conduit 626 as described: only the insulating board 714 is in direct contact with the enclosure 716 at wall 718. In some implementations, the enclosure is made with thermally insulating materials. In these implementations, more points, or surfaces of contact, from the enclosure to the flight stack 700 can be made. For example, the wall 722 can make contact with the heat spreader 704 and connector 702.

According to some implementations, the thermally conductive PCB boards 710 include embedded thermally conductive materials in addition to electric conductors and electric components. For example, in some implementations, the embedded thermally conductive materials are electrically isolated from the electric conductors and electric components. In some implementations, the thermally conductive material is a metal. In some implementations, the thermally conductive material is diamond, silver, copper, gold, aluminum nitride, silicon carbide, aluminum, tungsten, graphite, carbon nanotube, carbon fibers, zinc, or combinations thereof.

The stack 708 can also include one or more spacer(s) to provide a gap 715 between PCB boards 710. In some implementations, the one or more spacer(s) between PCB boards 710 is/are an insulator. In some implementations, the one or more spacer(s) is/are configured as a heat conduit 724 perpendicular to the stack, the heat conduits 724 connected to the PCB boards 710 and to the heat spreader 704. The heat conduits 724 can include any thermally conductive material, such as metals (e.g., silver, copper, gold, aluminum, tungsten, and zinc), diamond, aluminum nitride, silicon carbide, graphite, carbon nanotubes, carbon fibers, or combinations thereof.

In some implementations, one or more of the boards 710 are electrically connected to an external power source. For example, in some implementations, PCB board 710 is connected to universal electric adaptor 627 and the fuel cell subsystem 660 of MOWS 600. In some implementations, all the PCB boards 710 in stack 708 are electrically connected, for power and signal exchange. The PCB boards 710 can include heat-producing components, and in some implementations, the heat producing components are thermally connected to the heat spreader and thermal conductors in the PCB board 710. The dissipation of or spread of heat from the heat-producing components allows cooling of the component for efficient operation while supplying excess heat to the rest of the flight stack 708 that may require more heat.

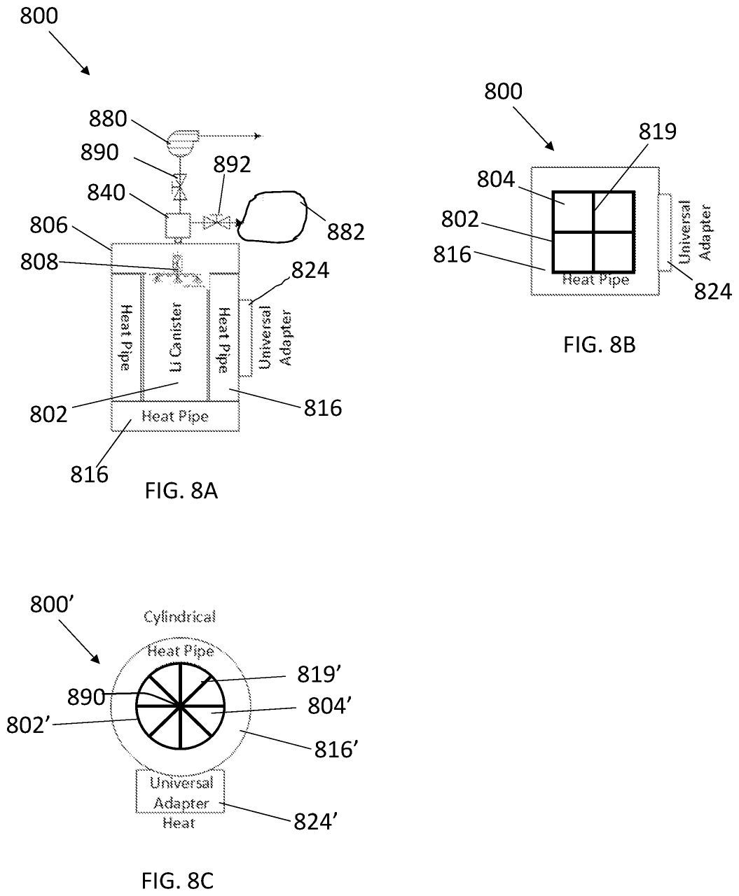

FIG. 8A depicts a front section view of a MOWS 800 according to some implementations. The MOWS 800 is a rectangular or square object having an enclosure 802, a fluid reservoir 806, a fluid manifold 808, a thermal conduit 816, and a universal heat adaptor 824. A low-pressure source 840 is optionally supplied by a vacuum pump 880 or a space vacuum 882. Valves 890 or 892 can control/select between vacuum pump 880 or space vacuum 882, respectively.

A top section view of the MOWS 800 is shown by FIG. 8B. The enclosure 802 is subdivided into compartments 804 by walls 819. The thermal conduit 816 surrounds the enclosure 802. The universal heat adaptor 824 is connected to an outer wall of the thermal conduit 816.

FIG. 8C shows a top section view of a MOWS 800′ with a cylindrical configuration. Thermal conduit 816′ is similar to thermal conduit 816 shown in FIG. 8B except it is cylindrical and wraps around the enclosure 802′, which is also cylindrical. Compartments 804′ are formed by walls 819′ that project radially from the center 890 of the enclosure 802. Although not shown, the center 890 can include a sleeve or channel for a thermal conduit. Universal heat adaptor 824′ is configured to interface with the cylindrical thermal conduit 816′. The front cross-section view of MOWS 800′ is the same as the view of MOWS 800 depicted by FIG. 8A.

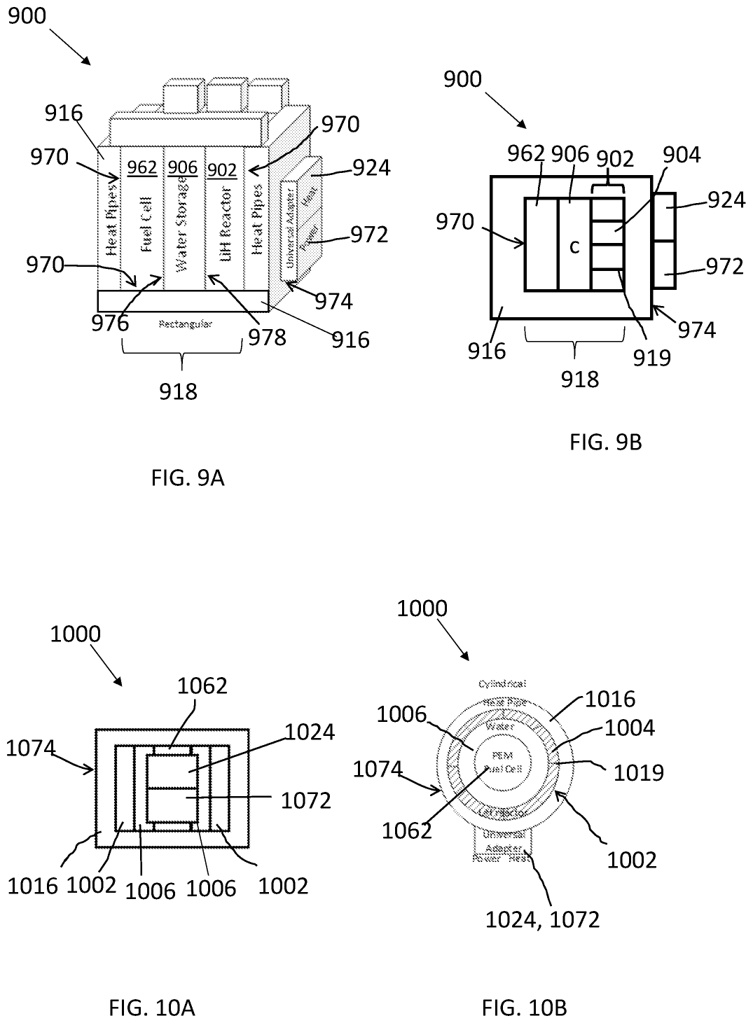

FIG. 9A depicts a perspective view with a cross section revealing the internal structure of a co-generation system 900. The co-generation system 900 is configured as a rectangular or square object having a thermal conduit 916, including an internal wall 970 defining an internal space 918, and the thermal conduit 916 includes an external wall 974. A universal heat adaptor 924 and a universal electric adaptor 972 are attached to the external wall 974. A fluid reservoir 906 is connected on a first side 976 to a fuel cell 962; the fluid reservoir 906 is connected on a second side 978 to an enclosure 902. The fuel cell 962 and the enclosure 902 are connected to the internal wall 970 of the thermal conduit 916.

FIG. 9B depicts a top section view of the co-generation system 900. The enclosure 902 is subdivided into compartments 904 by wall 919. Thermal conduit 916 surrounds the internal space 918, containing the fuel cell 962, fluid reservoir 906, and enclosure 902. The universal heat adaptor 924 and a universal electric adaptor 972 are attached to the external wall 974.

FIG. 10A depicts a front section view of a co-generation system 1000, according to some implementations. FIG. 10B depicts a top section view of the co-generation system 1000. The co-generation system 1000 is configured as a cylinder. A thermal conduit 1016 surrounds an enclosure 1002. The thermal enclosure 1002 surrounds a fluid reservoir 1006. The fluid reservoir 1006 surrounds a fuel cell 1062. A universal heat adaptor 1024 and universal electric adaptor 1072 are attached to an outer wall 1074 of the thermal conduit 1016. The enclosure 1002 is subdivided into compartments 1004 by wall 1019 (FIG. 10B).

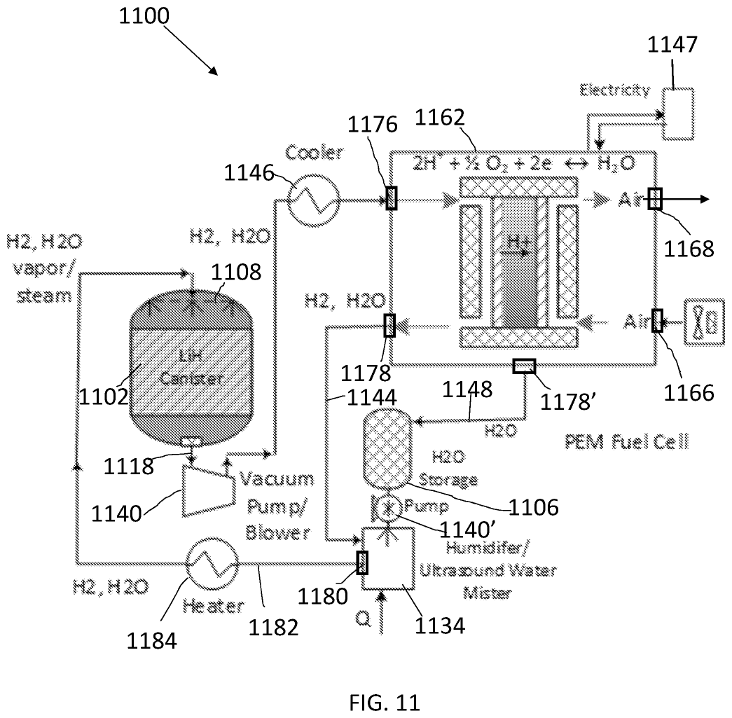

FIG. 11 shows a schematic of a hydrogen generation system 1100, using water vapor. The hydrogen generation system 1100 includes a flow-through PEM fuel cell 1162 for generating electricity. An enclosure 1102 and fluid manifold 1108 are shown. The fluid manifold 1108 provides water vapor to an active metal (e.g., Li, LiH) in the enclosure 1102. Reaction of the water vapor with the active metal produces an exothermic reaction, releasing hydrogen gas. The hydrogen gas and water vapor are transported from the enclosure 1102 through a gas exhaust conduit 1118. A low-pressure source (e.g., space, pump, or blower) 1140 helps drive the H₂/H₂O to a chiller 1146, which condenses and removes the water. The hydrogen gas is fed to the fuel cell 1162 through an H₂ inlet 1176. Oxidant gas, such as air or pure O₂, is fed through an inlet 1166, and unused oxidant gas exits through oxidant outlet 1168. The H₂ produced in enclosure 1102 and O₂ from the oxidant gas react in the fuel cell 1162 to form water and provide electricity to an electric load 1147. Unreacted H₂ and product H₂O exit the fuel cell through H₂/H₂O outlet 1178 as a gas. Liquid water exits the fuel cell through an outlet 1178′ to a fluid conduit 1148, which is connected to a fluid reservoir 1106. The water in the fluid reservoir 1106 is fed to a vaporizer (e.g., humidifier or ultrasound water mister) 1134, for example, using a pump 1140′. The H₂/H₂O gas is also directed to vaporizer 1134 from outlet 1178 through fluid conduit 1144. Combined streams of H₂O from fluid conduit 1148 and H₂/H₂O from fluid conduit 1144 are mixed, and the H₂/H₂O exits from outlet 1180, where it is directed through fluid conduit 1182 to a heater 1184 and then back to the fluid manifold 1108 to complete the cycle.

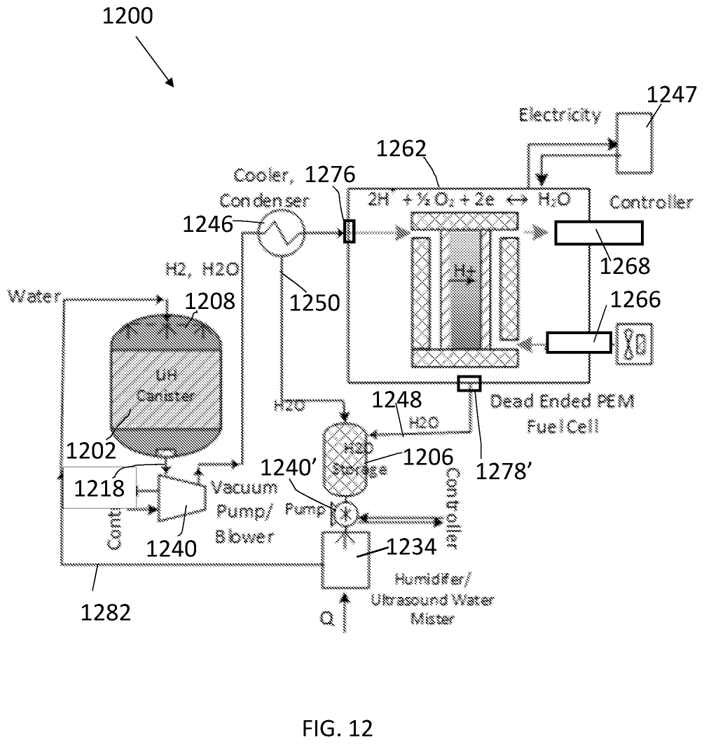

FIG. 12 shows a schematic of a hydrogen generation system 1200 using liquid water. The hydrogen generation system 1200 includes a dead-end PEM fuel cell 1262 for generating electricity. An enclosure 1202 and a fluid manifold 1208 are shown. The fluid manifold 1208 provides liquid water to an active metal (e.g., Li, LiH) in enclosure 1202. Reaction of the liquid water with the active metal produces an exothermic reaction releasing hydrogen gas. The hydrogen gas and water vapor are transported from the enclosure 1202 through a gas exhaust conduit 1218. A low-pressure source (e.g., space, pump, or blower) 1240 helps drive the H₂/H₂O to a chiller 1246, which condenses and separates water from H₂. The water is directed to a fluid conduit 1250, and the hydrogen gas is fed to the fuel cell 1262 through H₂ inlet 1276. Oxidant gas, such as air or pure O₂, is fed through inlet 1266, and unused oxidant gas exits through oxidant outlet 1268. The H₂ and O₂ from the oxidant gas react in the fuel cell 1262 to form water and provide electricity to an electric load 1247. Liquid water exits the fuel cell 1262 through an outlet 1278′ to a fluid conduit 1248, which is connected to a fluid reservoir 1206. Water from fluid conduit 1250 is also fed to fluid reservoir 1206. The water in the fluid reservoir 1206 is fed to a vaporizer (e.g., humidifier or ultrasound water mister) 1234, for example, using a pump 1240′. Water is directed back to fluid manifold 1208 through conduit 1282.

It should be understood that this invention is not limited to the particular methodology, protocols, and reagents, etc., described herein and as such may vary.

In one aspect, the present invention relates to the herein described compositions, methods, and respective component(s) thereof, as essential to the invention, yet open to the inclusion of unspecified elements, essential or not (“comprising”). In some embodiments, other elements to be included in the description of the composition, method, or respective component thereof are limited to those that do not materially affect the basic and novel characteristic(s) of the invention (“consisting essentially of”). This applies equally to steps within a described method as well as compositions and components therein. In other embodiments, the inventions, compositions, methods, and respective components thereof, described herein, are intended to be exclusive of any element not deemed an essential element to the component, composition, or method (“consisting of”).

The embodiments will be more readily understood by reference to the following examples, which are included merely for purposes of illustration, of certain aspects and embodiments of the present invention, and should not be construed as limiting. As such, it will be readily apparent that any of the disclosed specific constructs and experimental plans can be substituted within the scope of the present disclosure.

### Examples

The following examples illustrate some embodiments and aspects of the invention. It will be apparent to those skilled in the relevant art that various modifications, additions, substitutions, and the like can be performed without altering the spirit or scope of the invention, and such modifications and variations are encompassed within the scope of the invention as defined in the claims which follow. Other than in the operating examples, or where otherwise indicated, all numbers expressing quantities of ingredients or reaction conditions used herein should be understood as modified in all instances by the term “about.” The following examples do not, in any way, limit the invention.

### Surviving the Lunar Night Using Metal Oxidation Warming Systems I

### I-1. Introduction.

This example focused on the development of a MOWS to allow spacecraft systems to survive one or more lunar night(s) and also operate in permanently shaded regions (PSRs). A thermal control system using MOWS can produce autonomous continuous on-demand heat, using highly exothermic chemical reactions, so it is suitable for proportional or on-off controllers. This system will be dust-proof, non-radioactive, throttleable, and have high specific energy and low mass. It is anticipated that such systems can have applications in other challenging environments, both terrestrial and extraterrestrial. For example, these systems can be used on space stations, satellites, planets, such as Mars, polar regions of the earth, the upper atmosphere of the earth, including the upper troposphere, and underwater, such as oceanic trenches.

### I-2. Objectives.

This example sought to develop and characterize a flight-like MOWS in an appropriate thermal vacuum environment. Spacecraft equipped with this warming system should be capable of surviving the lunar night and/or operating in PSRs, which will greatly expand the scope of lunar missions.

A range of thermal conditions was considered, varying selenographically from the poles to the equator (including PSRs) and chronologically from lunar day to lunar night. Thermal models were created to better understand components' thermal requirements and advance enclosure designs. A breadboard heating system was designed, manufactured, and tested.

### I-3. Work and Results.

Activities for this example included setting up a small-scale test tube reactor, testing two different metal-based fuels, assessing different water delivery systems, and experimentally evaluating one of the water delivery systems. A detailed breakdown is provided below.

### I-3.1 Small-Scale Test Tube Reactor: Setup and Procedure.

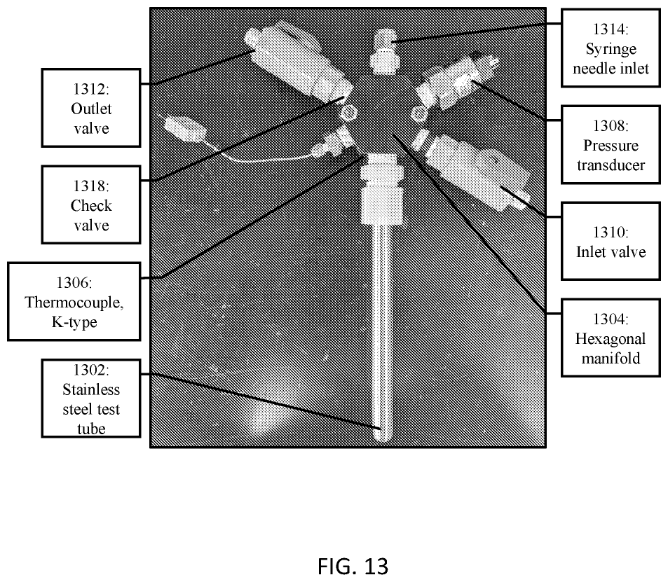

During an earlier phase of the project, fuels were evaluated by loading them in glass test tubes, and water was slowly added from above. Temperature evolution of the reactants was manually tracked over time. It was found that the glass test tube fittings were susceptible to leakage when over-pressured. FIG. 13 depicts components used to address some of these limitations. The test tubes were replaced with passivated stainless-steel test tubes 1302, with OD 12.7 mm. These were then fitted into a hexagonal manifold 1304, which was used to support a thermocouple 1306 and a pressure transducer 1308. The manifold 1304 was fitted with an inlet valve 1310 and an outlet valve 1312. The top of the hexagonal manifold 1304 supports a fitting with polyurethane packing 1314, through which a syringe needle can be inserted to introduce water into the assembly. A check valve 1318 is positioned in line with the outlet valve 1312.

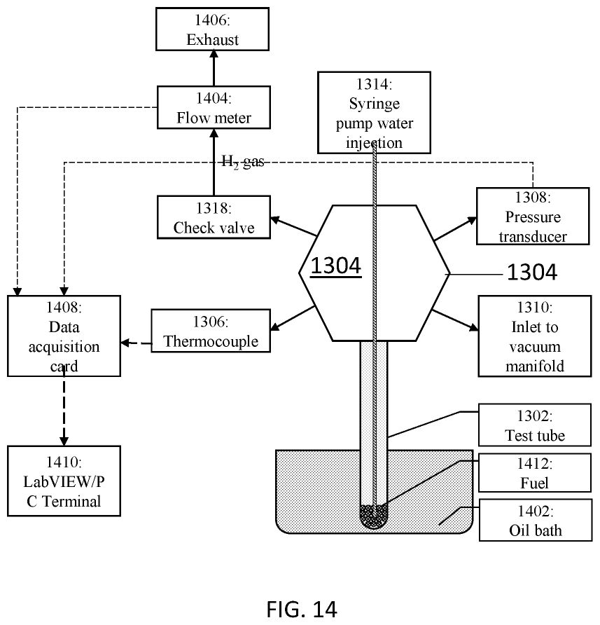

FIG. 14 shows an experimental setup layout for the improvements depicted by FIG. 13. The test tube 1302 was immersed in a mineral oil bath 1402, which kept the mineral oil recirculating through a cold plate. The temperature of this bath was maintained at 20° C. using a thermostat. A long K-type thermocouple 1306 was inserted into the test tube 1302 to measure the reaction zone temperature. The pressure transducer (Omega PX119-030A) 1308 was rated at 0-30 psia (0-2.07 bar absolute) and measured the hexagonal manifold pressure. The inlet valve 1310 connects or isolates the reactor from the vacuum manifold, which can be used to evacuate the reactor using a 2-stage vacuum pump or to pressurize it with inert argon gas (99.9% purity). The test tube 1302 was evacuated and then charged with argon to maintain an inert gas atmosphere before tests were conducted. A check valve 1318, with opening pressure 1 psi (0.07 bar), connected the outlet valve 1312 (FIG. 13) to the manifold 1304 and ensured positive flow. The outlet valve 1312 was connected to an in-line desiccant canister to remove all moisture. This canister flows into a thermal mass flow meter 1404 (Model UFC-1100, UFC Instruments) rated for 0-20 sccm (standard cubic centimeters per minute). After passing through the flow meter 1404, the gas exhausts into a fume hood 1406 located in the lab.

A data acquisition unit 1408 (LabJack Model T7) was used to continuously record data from the thermocouple, pressure transducer, and flow meter. The data was logged on a PC terminal 1410 using NI LabVIEW as a time series into an MS Excel spreadsheet. The data were also displayed live on the screen in real-time.

At the start of the experiments, the fuel 1412 was weighed inside a sealed glove box and loaded into the test tube 1302. The atmosphere inside the glove box was primarily argon, with internal measurements of <0.9% oxygen and <15% relative humidity. The test tube 1412 was then fitted into the manifold 1304, which was then cycled out of the glove box and fitted into a test stand so that the test tube 1412 was fully immersed into the oil bath. A syringe needle was then inserted through the syringe inlet 1314 until it contacted the test tube bottom. The needle was connected to a syringe, which was actuated using a syringe pump (New Era Pump Systems Model 300, Systems) at a constant pumping rate. A stopwatch was used for timekeeping.

I-3.2 Small-Scale Test Tube Reactor: Results with Lithium

Lithium fuel used for these experiments was in the form of cylindrical pellets of ˜6 mm diameter and ˜12 mm length, each weighing approximately 0.160 g. The oxidizer used was distilled water. The primary reaction is Equation 1 described above.

### I-3.2.1 Test 1: Three Lithium Pellets

In a first test, 0.512 g of Li fuel (3 pellets) were reacted in the test facility. Water was added at 0.01 ml min⁻¹ until 1× stoichiometric ratio. The water addition was then paused until a significant drop in the evolved hydrogen flow was noted. This process was repeated, with water addition at 0.02 ml min⁻¹ until 2× stoichiometric ratio of water was added, and then repeated again, with water addition at 0.03 ml min⁻¹ until 3× stoichiometric ratio of water was added.

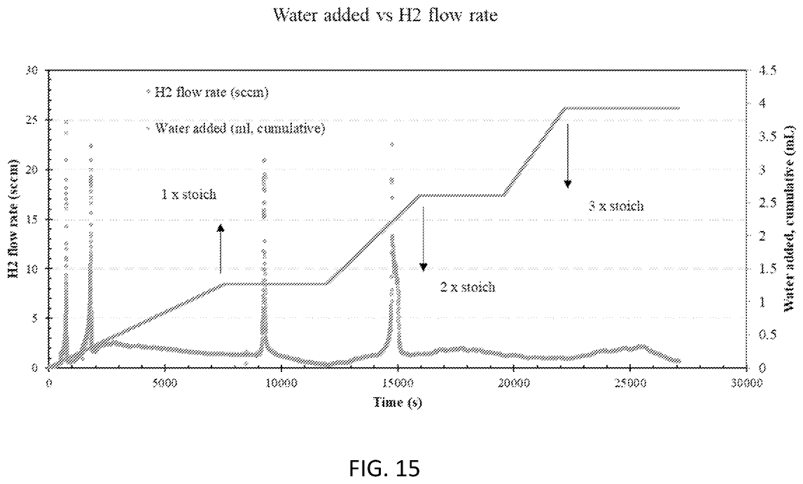

FIG. 15 shows a plot of water addition vs. hydrogen flow rate for Test 1. During the majority of the experiment, relatively steady hydrogen flow rates were measured, averaging at 1.7 sccm. However, the results showed intermittent spikes in hydrogen flow rate as water was added. These spikes in reaction rate may have occurred when the gradually rising water and wetted product level reached unreacted parts of the large lithium pellets. More uniform distribution of oxidizer or finer fuel grains can smooth out these spikes, as described below.

Ideally, the Li—H₂O reaction requires one mole of water to react one mole of lithium. However, for liquid water to reach unreacted Li, it must hydrate and diffuse through the LiOH passivation layer that forms on the outside surface of the fuel pellets. Therefore, enough water needs to be supplied to the reactor until the LiOH on the passivation layer is fully hydrated to LiOH·H₂O (2 moles H₂O per mole Li as shown in Equations 1 and 2 above).

Experimentally it is found that ˜3× the stoichiometric ratio of water is needed to fully react the lithium, instead of 2× the stoichiometric ratio. It is hypothesized the extra water is needed to dissolve and saturate some of the passivation layer for the water to reach the lithium under it.

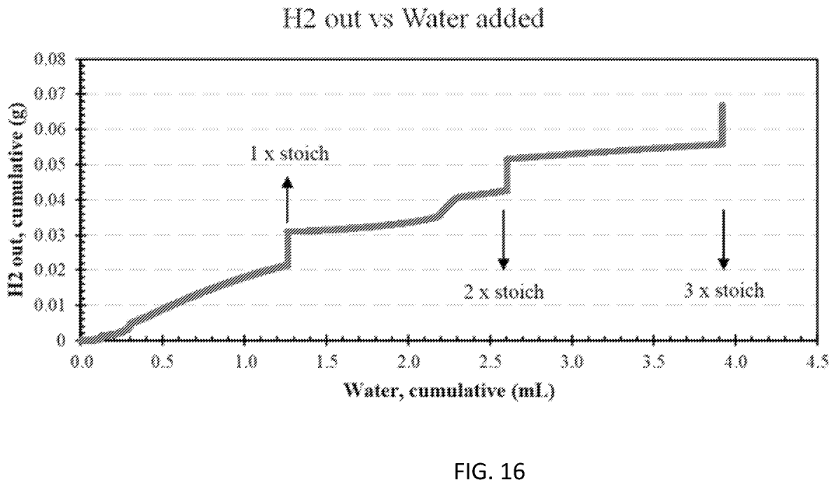

FIG. 16 shows the cumulative evolution of hydrogen as water is added. As water is added to the fuel, there is an initial delay in hydrogen production. Hydrogen evolution is faster in the first stage until 1× stoichiometric ratio of water is added, but the production slope slows down in the second stage until 2× stoichiometric ratio of water is added. It slows down even further in the third stage until 3× stoichiometric ratio of water is added. This suggests that there could be an optimal ratio of oxidizer-to-fuel that maximizes the reactant specific energy (i.e., most efficient use of reactants).

An initial optimization strategy from the above data can be developed to find the optimal fuel-oxidizer ratio:
M_{H}_{₂}=cumulative mass of hydrogen evolved by a given time during the reaction (g)
M_{Li}=total mass of lithium fuel added to reactor (g)
M_{H}_{₂}_{O}=cumulative mass of water (oxidizer) added by a given time during the reaction (g)
The heat of reaction of reaction (1) per mass of reactants is: Δh_{Li+H}_{₂}_{O}=8,100 J g⁻¹
Then the heat of reaction per mass of hydrogen is:

$$Δ {h}_{{H}_{2}} = 8100 * ( \frac{18 + 6.9}{0.5 * 2} ) = 201 , 700 {Jg}^{- 1}$$

Then, at any given stage of the reaction, the reactant specific energy based on the total lithium fuel at added water up to that point is:

$$R = \frac{( {M}_{{H}_{2}} ) ( Δ {h}_{{H}_{2}} )}{{M}_{L i} + {M}_{{H}_{2} O}} .$$

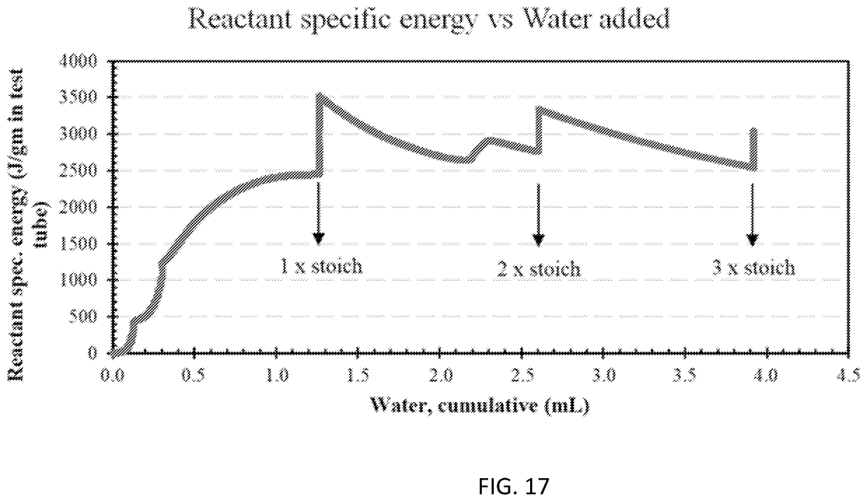

Plotting R against the cumulative water added at different stages of the experiment, as illustrated by FIG. 17, indicates that the maximum reactant specific energy is obtained with approximately 1.0×-2.5× the stoichiometric addition of water.

### I-3.2.2 Test 2: Single Lithium Pellet.

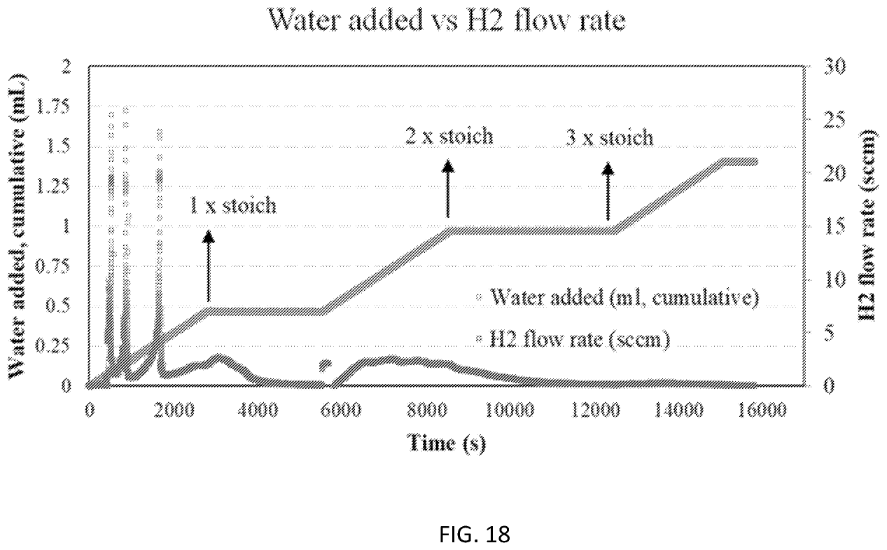

It was hypothesized that the way the lithium pellets stack in the test tube may affect reaction behavior. Test 1 was therefore repeated using a single lithium pellet (0.180 g). Water was added at 0.01 ml min⁻¹, with pauses at 1×, 2×, and 3× the stoichiometric ratio. Water addition was stopped at each step until the hydrogen flow rate reduced significantly. FIG. 18 shows the hydrogen flow rate trends. Intermittent hydrogen production spikes were observed, as in Test 1.

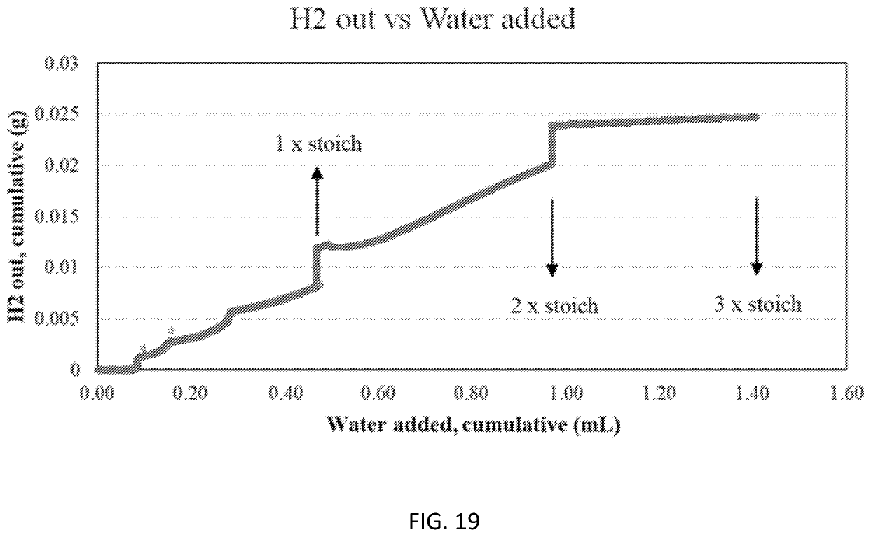

FIG. 19 shows the cumulative evolution of hydrogen as water was added. As in Test 1, there was an initial delay in hydrogen flow after the start of water addition. Rates of hydrogen flow were comparable in the first two stages of the reaction (until 1× and 2× stoichiometric water addition) but were significantly lower in the third stage.

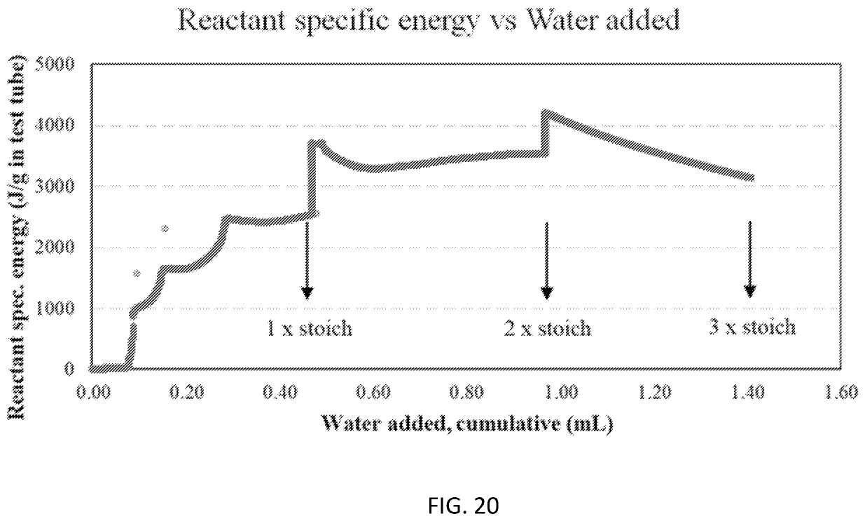

The trend for reactant specific energy R in the test tube for Test 2 is shown in FIG. 20. It is observed that the peak value of R occurs over a similar range of stoichiometric ratios, as in Test 1.

### I-3.2.3 Test 3: Finer Lithium Grains.

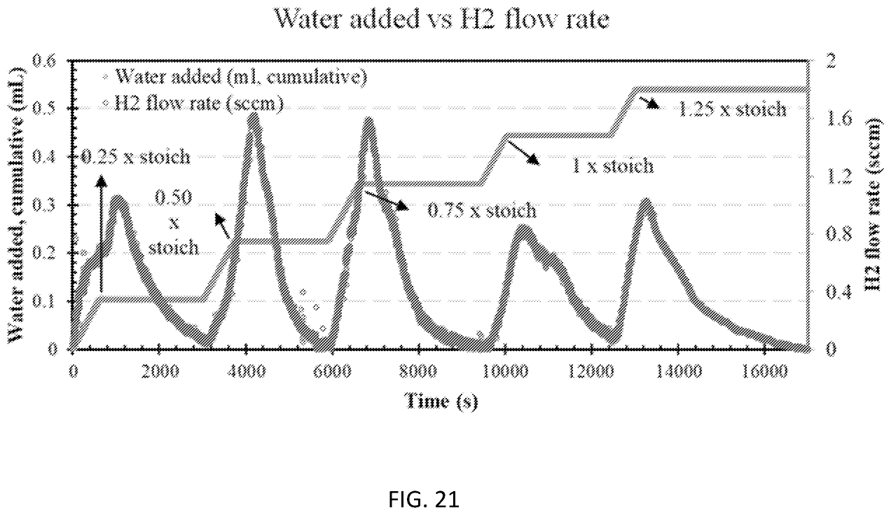

A third test was performed in which the lithium fuel was divided into smaller pieces. It was hypothesized that the smaller pellets would pack more densely in the reactor and provide more surface area, reducing the intermittency of reaction rates observed in Tests 1 and 2. A single fuel pellet (0.161 g) was cut into roughly equal 16 pieces inside the sealed glove box under argon. This reaction test was performed with water injection at 0.01 ml min⁻¹, with pauses at 0.25×, 0.50×, 0.75×, 1.00×, and 1.25× stoichiometric ratio of water. FIG. 21 indicates that these finer fuel grains yielded steadier reaction rates.

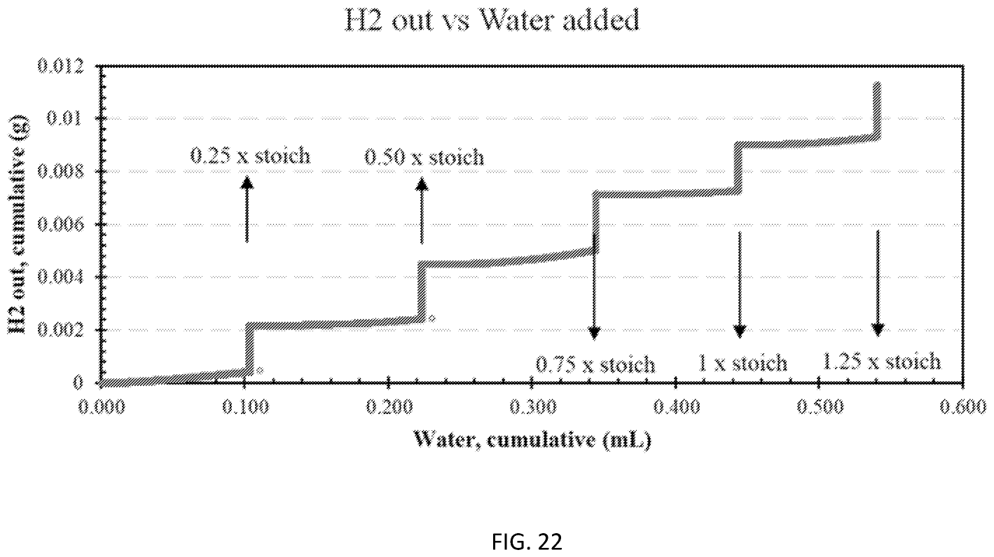

An additional objective of this experiment was to explore the reaction rates of lithium fuel when water was intermittently added at sub-1× stoichiometric ratios. Understanding how fast the reaction rate ramps up and settles after pulsed oxidizer addition is important to designing a robust control algorithm to regulate a lithium-based reactor. As can be seen, there is a fast reaction when water is added, followed by an exponential decay of the reaction when the water addition is paused. From a control-theoretic perspective, this closely resembles the impulse response of a first-order dynamic system. FIG. 22 shows the cumulative evolution of hydrogen as water was added.

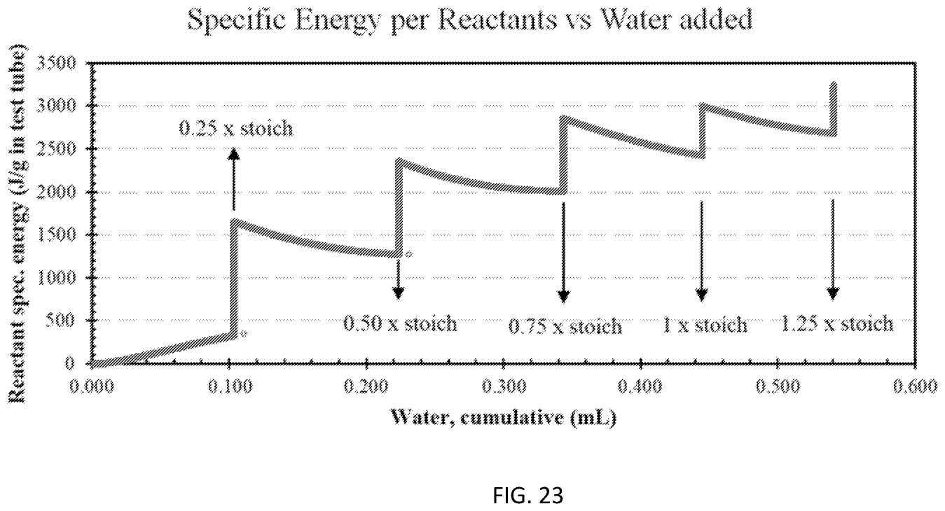

Similarly, the trend for reactant specific energy R in the test tube for the finer grain Test 3 shows a flattening of the reactant specific energy as more water is added, as shown in FIG. 23. This is similar to the first stage of the reactant specific energy trends for Test 1 and Test 2.

I-3.3 Small-Scale Test Tube Reactor: Results with Lithium Hydride

Another possible fuel for a warming system is lithium hydride. This fuel can be oxidized using water to generate water and heat (see Equation 3 above), just like lithium. The downside is that it generates only 60% of the heat compared to lithium, mole-per-mole, but this is offset by double the hydrogen generation (compare Equation 1 with 3). Lithium hydride also offers another practical benefit compared to lithium: it can be obtained at high purity in very fine powders, which leads to better reaction rates and makes the fuel easier to handle. Lithium hydride used for present research is in the form of a very fine, grey-colored powder of 30 mesh size or 595 μm. The oxidizer used is distilled water.

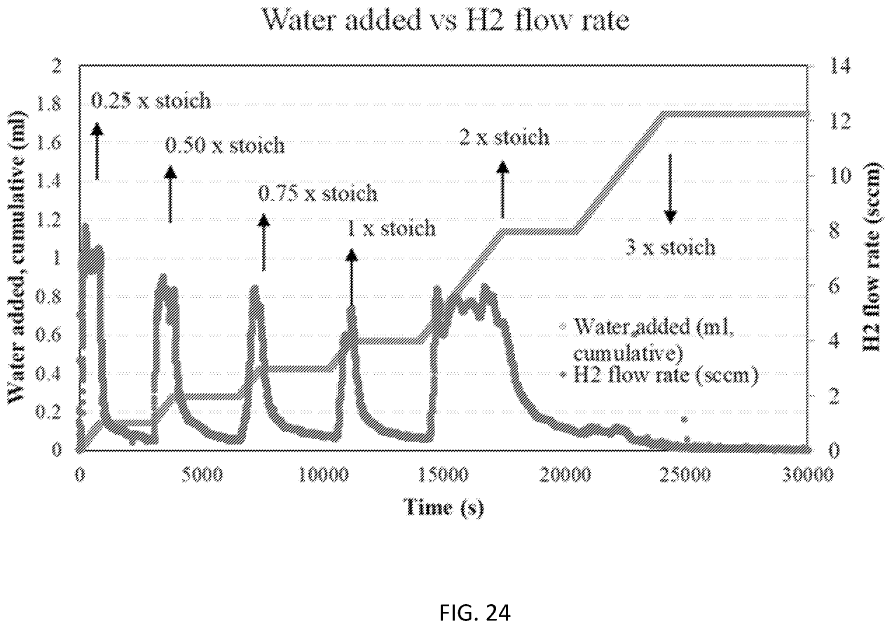

Water was added to the LiH fuel at 0.01 ml min⁻¹ at a constant rate, with pauses at 0.25×, 0.5×, 0.75×, 1×, 2×, 3× stoichiometric ratio of water. FIG. 24 shows the hydrogen flow rate as water was added. When water was added to the fuel, there were rapid spikes in measured hydrogen flow. Similarly, when water addition was paused, there were rapid drops in the hydrogen flow. This may be due to the much higher specific surface area of the lithium hydride fuel as compared to the lithium fuel, which leads to much higher reaction rates.

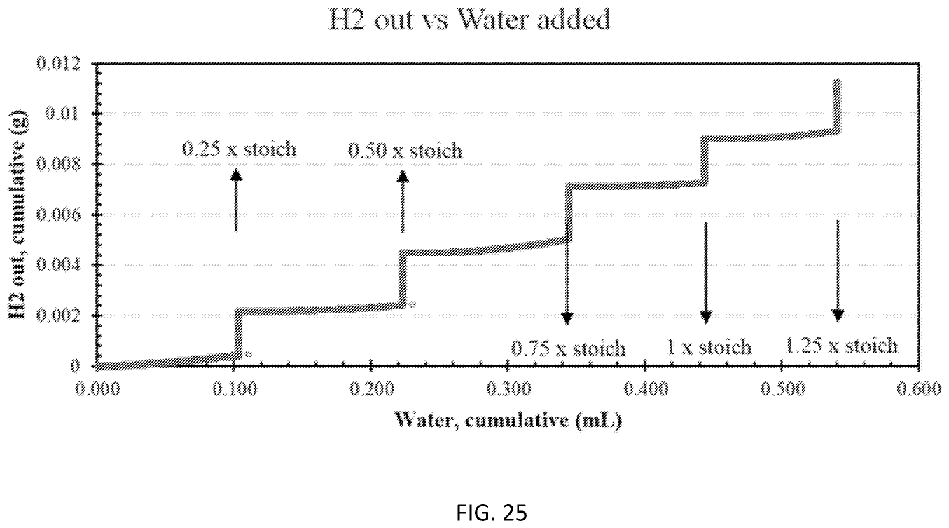

The LiOH formed in this reaction will also likely hydrate under test conditions, resulting in twice the stoichiometric water consumption of Equation 3. This is corroborated by the experimental results, which show significantly reduced hydrogen evolution for water added beyond the 2× stoichiometric ratio injection. Again, this can be attributed to the high specific area of this fuel. As the LiOH passivation layer forms, the hydrogen flow rate peaks drop down from the initial highs as more water is added. FIG. 25 shows the cumulative evolution of hydrogen as water is added. As water is added to the fuel, there is instantaneous hydrogen production. Hydrogen evolution stays more or less constant until 2× stoichiometric ratio of water is added, after which it flatlines.

As shown for Li, an initial optimization strategy from the above data can again be developed to find the fuel-oxidizer ratio for best heating results:
M_{H}_{₂}=cumulative mass of hydrogen evolved by a given time during the reaction (g)
M_{LiH}=total mass of lithium hydride fuel added to reactor (g)
M_{H}_{₂}_{O}=cumulative mass of water (oxidizer) added by a given time during the reaction (g)
Heat of reaction (in J g⁻¹ of reactants) of reaction (3) is: Δh_{LiH+H}_{₂}_{O}=5,070 J g⁻¹
Then heat of reaction per mass of hydrogen is:

$$Δ {h}_{{H}_{2}} = 5070 * ( \frac{18 + 7.9}{1 * 2} ) = 65 , 657 {Jg}^{- 1}$$

Then, at any given time, the reactant specific energy in the test tube as the oxidizer is added can be calculated as:

$$R = \frac{( {M}_{{H}_{2}} ) ( Δ {h}_{{H}_{2}} )}{{M}_{L i H} + {M}_{{H}_{2} O}} .$$

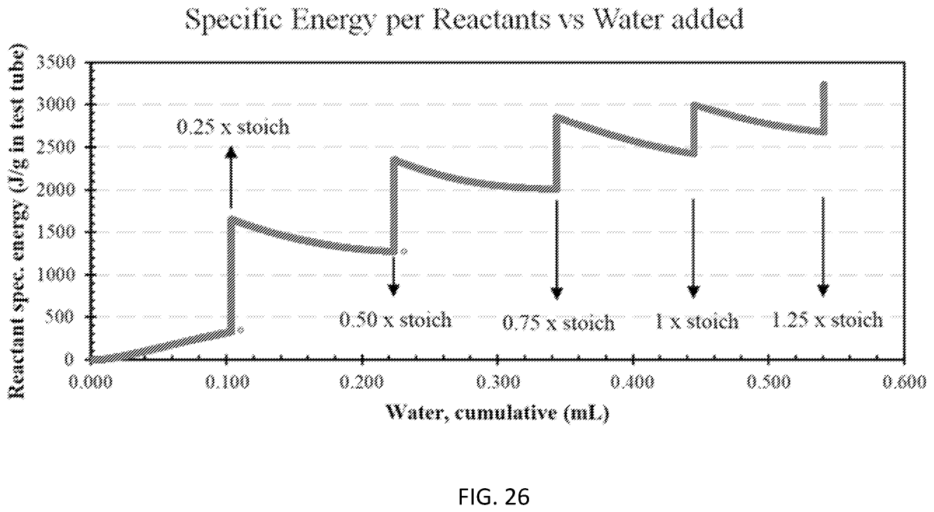

The plot of R vs. cumulative water addition then provides an insight into the optimal ratio of water to LiH fuel, as shown by FIG. 26. At the point when R is observed to flatline or decrease, the energy returns for investment of water added decreases. It is observed for the lithium hydride fuel that this inflection point occurs at 1-2× stoichiometric ratio of water.

### I-3.4 Water Delivery Systems.

Findings from experiments detailed in Sections I-3.1-3.3 determined the optimal ratio of water oxidizer to add for the two fuels (Li, LiH). The next research thrust seeks to evaluate mechanisms for delivering water to the fuels. It is expected that a final MOWS system would consist of a reactor or plurality of reactors with pre-loaded fuel, into which the oxidizer (water) can be added at desirable times to produce heat and hydrogen. This makes the water delivery system critical to the success of a MOWS system. An effective water delivery system would have the following desirable characteristics:
Ability to evenly irrigate maximum amount of fuel with a given amount of water
   High water-fuel contact area
Fine control over the amount of water delivered
Simplicity of control
   Minimum system inertia: in other words, fast reaction time
Simplicity of construction and operation
Agnostic to system orientation
   Ability to work in earth gravity, lunar gravity, microgravity, or zero gravity.

Three water delivery systems have been considered for present research:
Drip
Spray
Wick.

These are discussed individually in the below sub-sections.

### I-3.4.1 Water Delivery Systems: Drip.

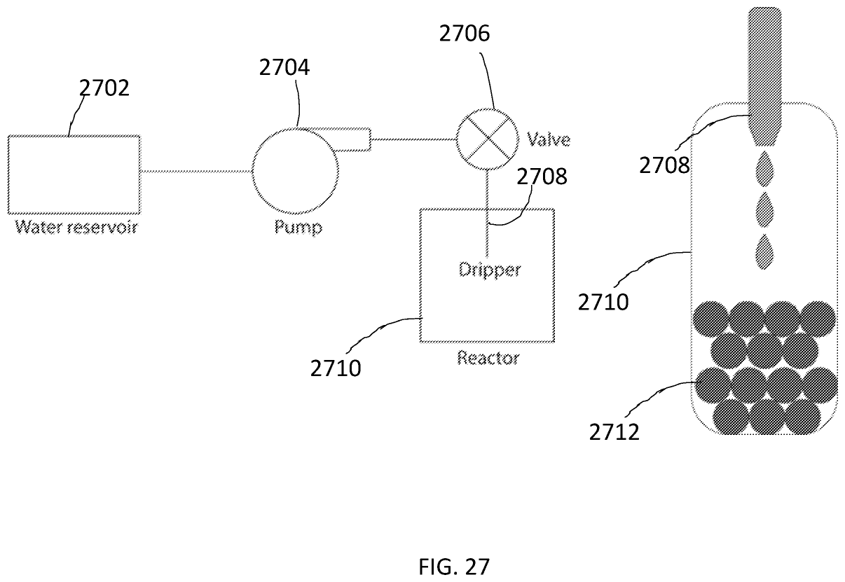

In reactor tests described thus far, the drip water system FIG. 27 has been used. On the left is shown a water reservoir 2702, connected to a pump 2704, which is connected to a valve 2706, controlling flow to a dripper 2708 in a reactor enclosure 2710. For example, the dripper can provide water drops having about 1-5 mm diameters at 1G. On the right is shown the reactor enclosure 2710 with Li or LiH 2712 and the dripper 2708. The outlet from a dripper (or multiple drippers) can be embedded into the fuel bed as well. Because this system uses a localized water delivery system, it may not distribute the oxidizer into the fuel bed evenly unless it is developed further into a sophisticated irrigation system. This may lead to over-saturation of fuel in some regions of the reactor, yielding lower overall specific energy. The system is also dependent on the presence of gravity and won't be as suitable for microgravity or zero gravity environments as other approaches. However, this system offers many advantages, simplicity of construction and operation chief among them.

### I-3.4.2 Water Delivery Systems: Spray.

A spray system can produce a spray of micron-sized oxidizer droplets and deliver it into a bed of fuel granules/pellets. If the mist is sufficiently fine, the delivery mechanism may have low sensitivity to gravity, and the spray could percolate through the fuel bed to react available fuel relatively uniformly. In this study, two spray systems have been investigated:
Pressure-driven spray nozzle
Ultrasonic atomizer.

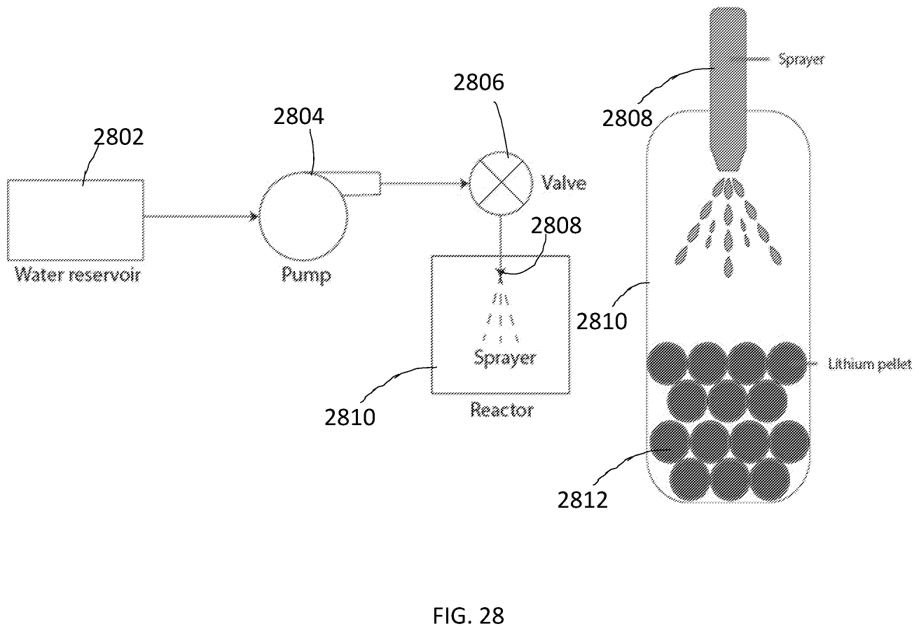

FIG. 28 illustrates a reactor with a water sprayer. On the left is shown a water reservoir 2802, connected to a pump 2804, which is connected to a valve 2806, controlling flow to a sprayer 2808 in a reactor enclosure 2810. On the right is shown the reactor enclosure 2810 with Li or LiH 2812 and the sprayer 2808.

The atomizing water spray nozzle (Hago Type M Model 29163, Danfoss) used for this test needed a high pressure of 45 psi (3 bar) and a high flow rate to effectively atomize droplets. This would require a large pump to build up a pressure head for the nozzle to operate, which would add a large amount of weight. Operating the pump would also incur a significant energy penalty, undesirable in implementations that must have minimal power consumption.

The ultrasonic atomizer (generic manufacturer) is a lightweight stainless steel disc with 20 mm diameter and 0.150 mm thickness with microporosities at its center. A piezo element is bonded to the surface to actuate the disc. The actuator is driven at 113 kHz by an oscillator circuit that draws a maximum of 0.5 A at 3.7 VDC.

To test the ultrasonic nozzle performance, the module was fixed on a stand and fed distilled water via a syringe pump. The spray was recorded using a Nikon D5100 camera (Nikon, Tokyo, Japan), fitted with a Tokina Macro 100 F2.8 D lens (Tokina, Tokyo, Japan) and operating at 30 fps. It was simultaneously recorded with a high-speed camera (Phantom Ametek Vision Research Miro Lab 340), fitted with a Nikon ED AF Micro Nikkor 200 mm 1:4 D (Nikon, Tokyo, Japan) operating at 1000 fps. The scene was backlit using a single bright white LED.

The ultrasonic nozzle was tested to evaluate the effects of varying:
Nozzle orientation;
Supply flow rate; and
Input power level.

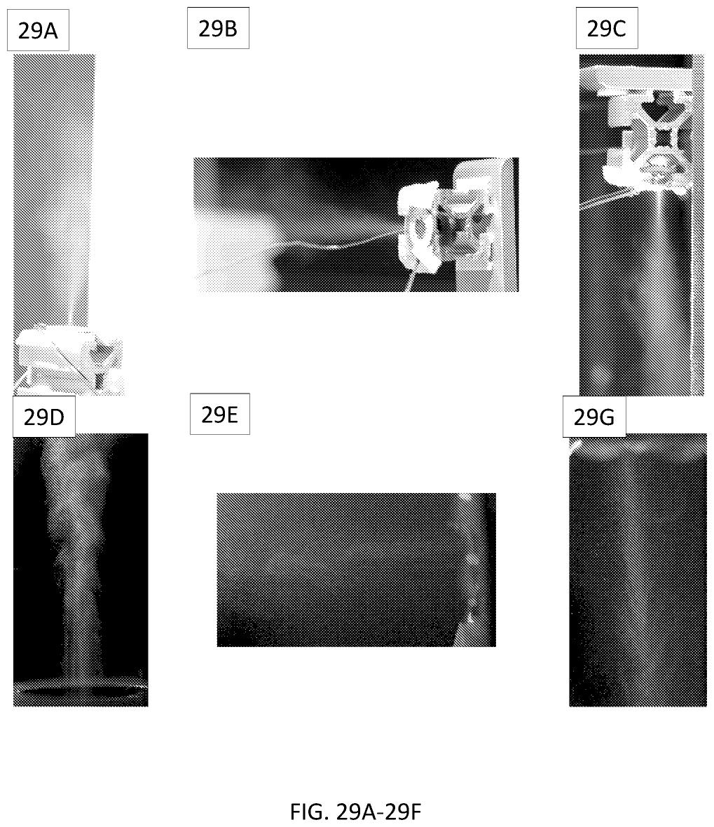

The ultrasonic nozzle was tested in quiescent air for upwards, sideways, and downwards spray. The performance was found to be dependent on orientation, with the downward spray orientation having the highest penetration depth and the smallest nominal droplet size. However, it is believed that mist generated in any orientation should be sufficiently fine for these reactors. FIG. 29A-29F show stills from high-speed photography: 29A, a Nikon D5100 camera upwards spray; 29B, a Nikon D5100 camera sideways/horizontal spray; 29C, a Nikon D5100 camera downwards spray; 29D, a Phantom camera upwards spray; 29E, a Phantom camera sideways/horizontal spray; and 29F, a Phantom camera downwards spray.

Supply flow rate to the nozzle was also found to affect the ultrasonic atomizer performance. The atomizer was tested at 0.35, 0.30, 0.25, 0.20, 0.15, 0.10, 0.05, and 0.01 ml min⁻¹. While at higher flow rates (e.g., 0.30 ml min⁻¹), the spray penetration was appreciable, at smaller flow rates (e.g., 0.01 ml min⁻¹), the atomizer produced a very weak stream of spray. Sometimes, it did not spray at all for a period of time until a critical amount of water had accumulated on the sprayer disk, and then it produced a strong spray until that water was exhausted. When a small amount of cotton wick was added to the sprayer disk, the spray performance became much more regular, but the spray produced was very weak and with small penetration depth.

It was also found that increasing the voltage level to the spray module produces a stronger spray.

The ultrasonic spray system faces two main challenges:
Its performance at very low flow rates is limited; and
It consumes 0.5 A at 3.7 VDC when operating, which is a relatively large amount of electric power.

The first problem can be ameliorated by running the atomizer at the lowest possible rates where it still performs well and by using it to add larger amounts of water intermittently as compared to adding smaller amounts of water constantly. This strategy will also ameliorate the second problem by using the atomizer for a smaller amount of time and, therefore, using less electric energy.

### I-3.4.3 Water Delivery Systems: Wick.

A wicking system can be used to deliver small amounts of water at low flow rates to all possible fuel surfaces. This system has two major challenges:
Wick material must be compatible with alkaline media; and
There is a mass and volume penalty associated with using the wick.

The first challenge can be met by using alkali-resistant wick material: currently, polypropylene and fiber glass are being investigated. Note that cotton-based wicks are not suitable for these implementations, because cotton is composed of cellulose, which dissolves in alkaline media. The second challenge can be met by determining the minimum amount of wick to deliver the maximum amount of water.

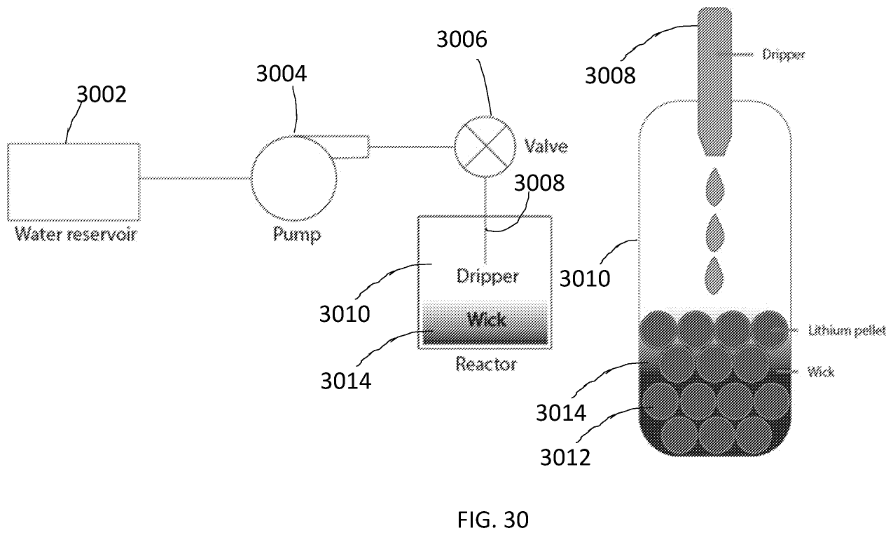

FIG. 30 illustrates a reactor with a wick. On the left is shown a water reservoir 3002, connected to a pump 3004, which is connected to a valve 3006 controlling flow to a dripper 3008, in a reactor enclosure 3010 equipped with a wick 3014. On the right is shown the reactor enclosure 3010 with Li or LiH 3012 and the dripper 3008. Although the dripper 3008 is shown as “dripping” a liquid, the outlet of the dripper can be directly in contact with wick material. Multiple drippers can also be used.

### I-3.5 MOWS Control Study.

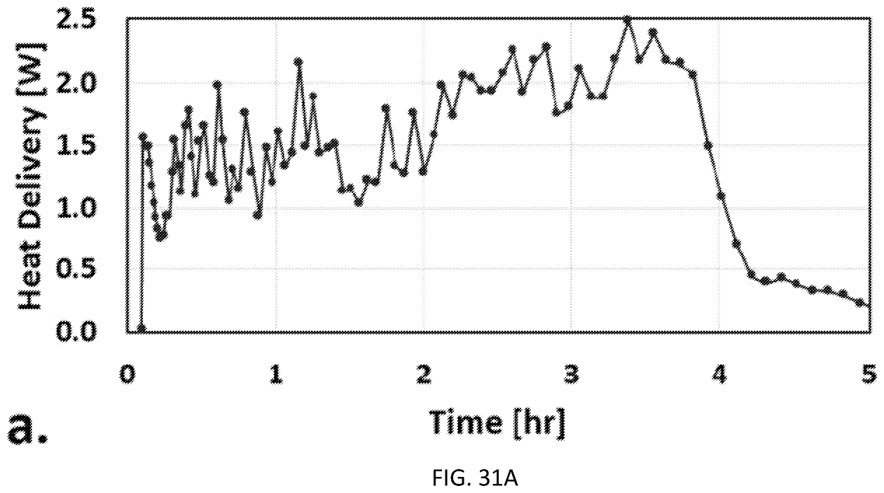

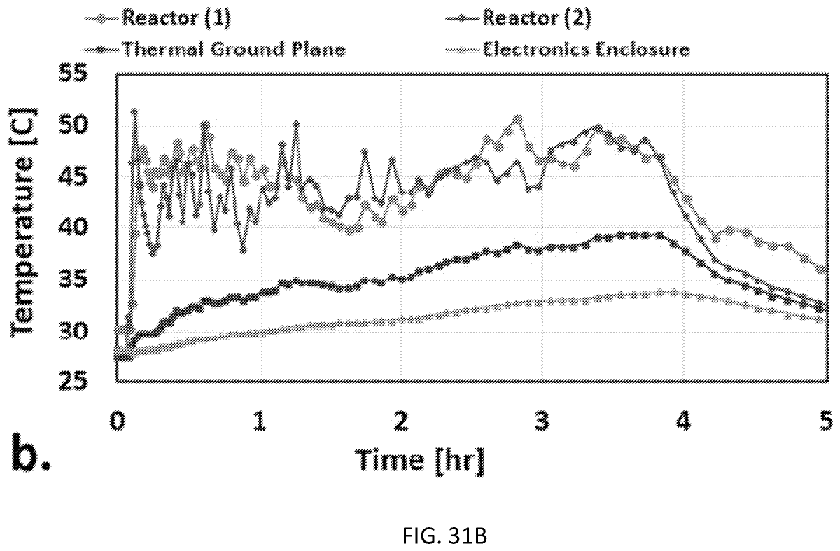

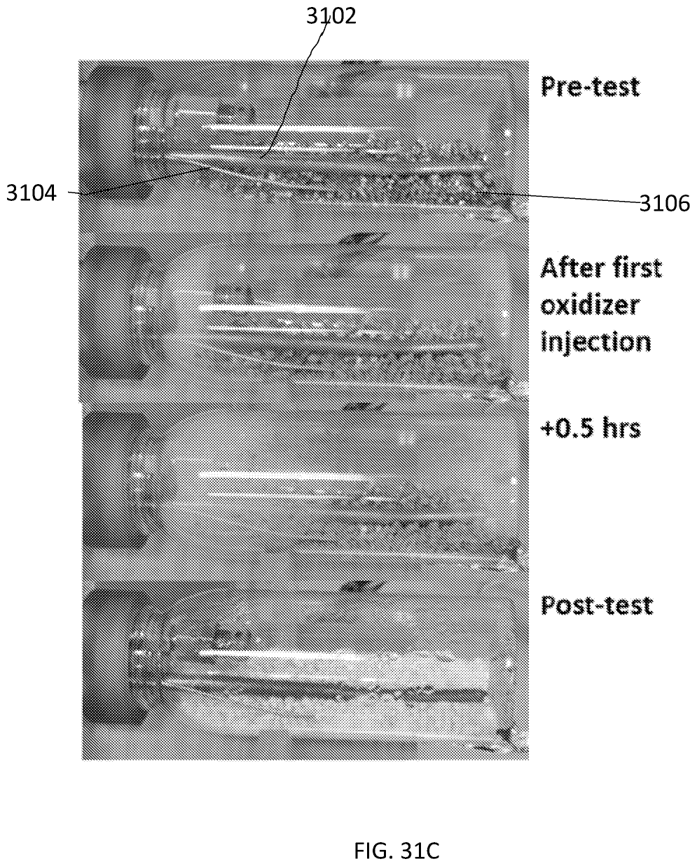

A bottle reactor was constructed (See Section II-3.8.1 Test Apparatus below). This reactor delivered heat via a heat pipe to a thermal ground plane with an integrated heat flux sensor. Lithium pellets were loaded into the reactor and sprayed with distilled water intermittently. Data were collected for heat delivery to the thermal ground plane and reactor temperature. In addition, data were collected for total dispensed water over 20-minute intervals. This water was added to the reactor at varying intervals by the operator to maintain a nominal heat delivery rate between 1.5-2.5 W. FIG. 31A-31B depict aspects of the bottle reactor. FIG. 31A is a plot of heat delivery vs. time. FIG. 31B is a plot of temperature vs. time. FIG. 31C shows the bottle reactor top to bottom: pre-test, after first oxidizer injection, after an additional 0.5 hours, and post-test. The heat pipe 3102, dripper 3104, and lithium pellets 3106 are indicated.

As can be seen in the initial test data, reactor temperatures averaged approximately 45° C. The enclosure temperature rose steadily from its initial value of 28° C. to a peak of around 34° C. before falling again as the reaction was halted. This demonstrates MOWS's ability to deliver sustained heating to a thermal load. In this test, the achievable heat rate and temperature range were limited by the small scale of the test apparatus, the desire to avoid excessive heating by throttling the oxidizer supply, and the fact that some amount of fuel did not react. All of these factors can be overcome by scaling up the reactor, and the geometry of the reactor and oxidizer supply can be redesigned for a more complete reaction.

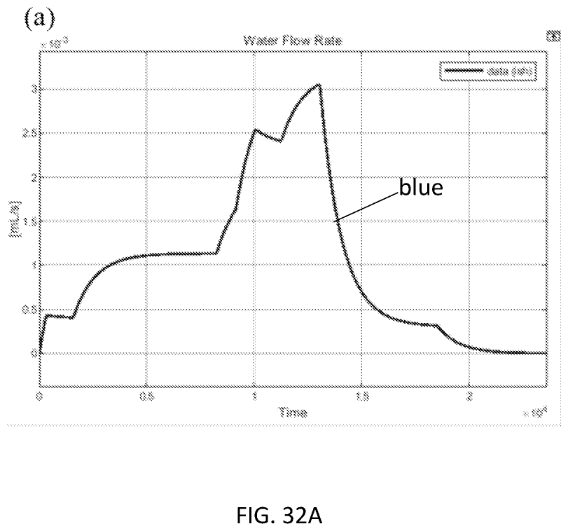

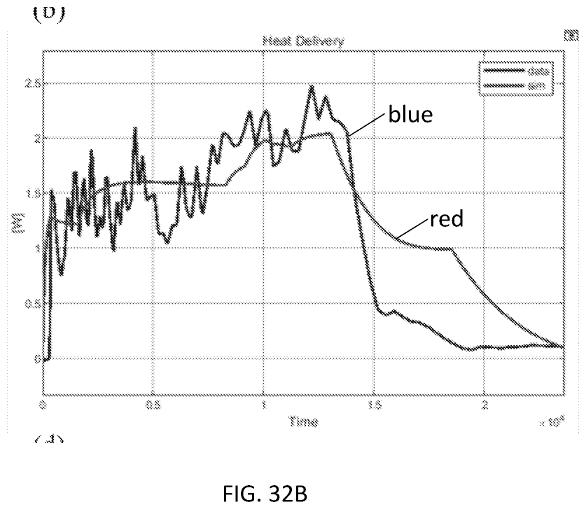

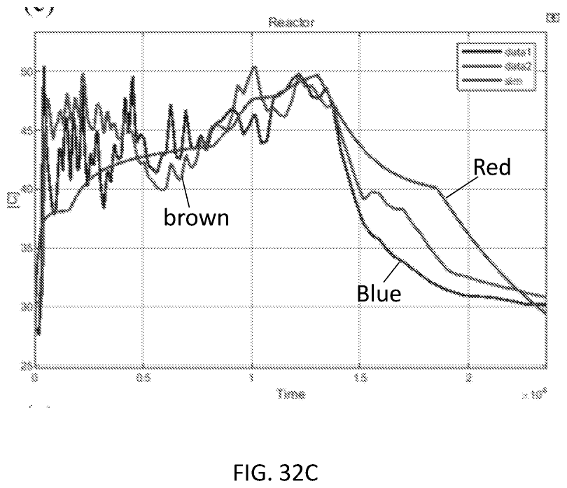

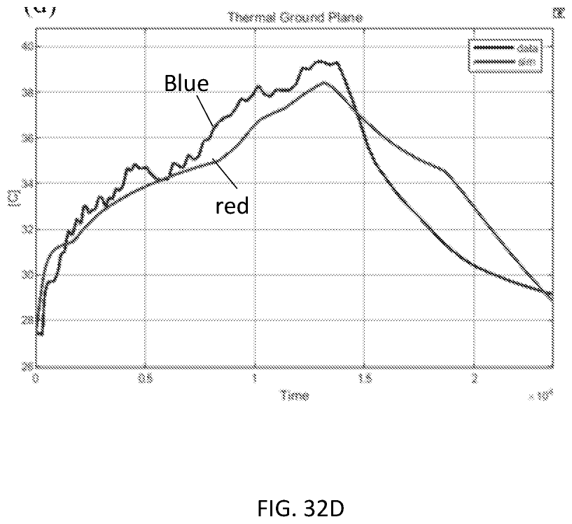

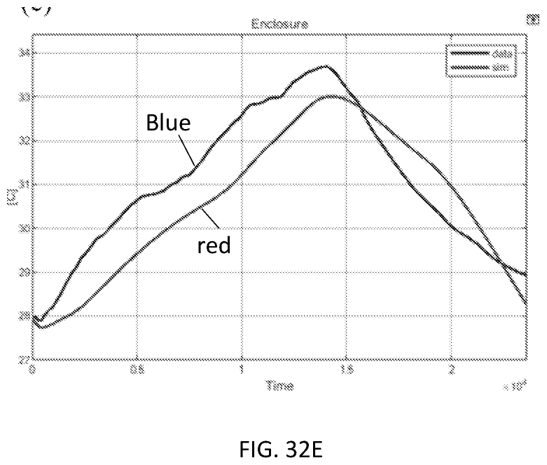

FIG. 32A-32E are time series plots showing experimental data (blue line, brown line) and lumped-parameter dynamic model outputs (red line) for the bottle reactor: 32A, estimated water flow rate (based on post-processing intermittent data); 32B, heat delivery; 32C reactor temperature; 32D thermal ground plane temperature; and 32E, enclosure temperature.

A lumped-parameter dynamic model was created, parameterized, and validated against the bottle reactor experimental data. A flow rate profile (FIG. 32A) was estimated from the dispensed water readings mentioned above. Parameters such as thermal resistance, thermal capacitance, and ambient temperature were tuned by inspection. A static mapping was obtained between the water flow rate profile and heat delivery by taking the former to the power of 0.25 and then applying a constant scaling (FIG. 32B). The dynamic model captures general trends for the reactor temperature (FIG. 32B), thermal ground plane temperature (FIG. 32D), and enclosure temperature (FIG. 32E). The present model generally captures the correct “gains” in the responses, typically with errors that are within the bound of what can be compensated for using feedback control.

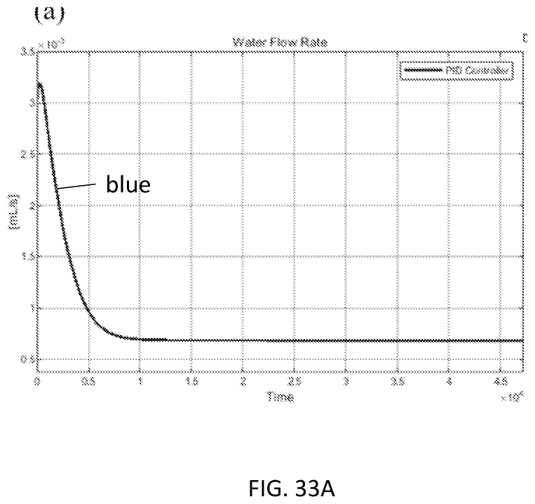

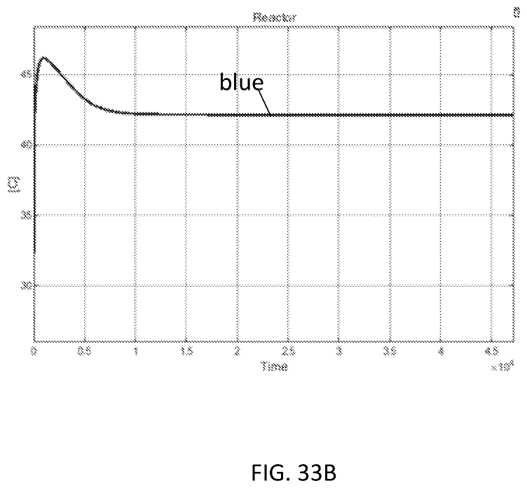

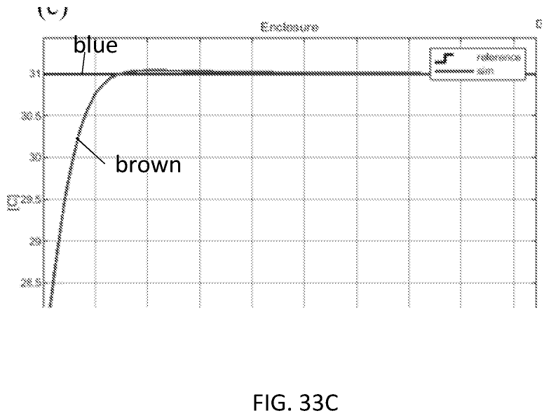

FIG. 33A-33C are time series plots for PI controller simulation: 33A, commanded water flow rate (blue line); 33B, reactor temperature (blue line); and 33C, enclosure temperature (reference: blue line, simulation output: brown).

Using the model above as the plant, a PI (proportional-integral) controller was applied in simulation to track an enclosure temperature setpoint. As is often the case in control design, it was found that the system tended to be unstable if the controller was tuned too aggressively, but with small gains, its performance was satisfactory. While a PI controller could be used to deliver a continuous heat output, a thermostatic control approach could be used to deliver intermittent heat. shows the simulation results from a “bang-bang” thermostat used to hold the enclosure temperature within ±2° C. of the setpoint.

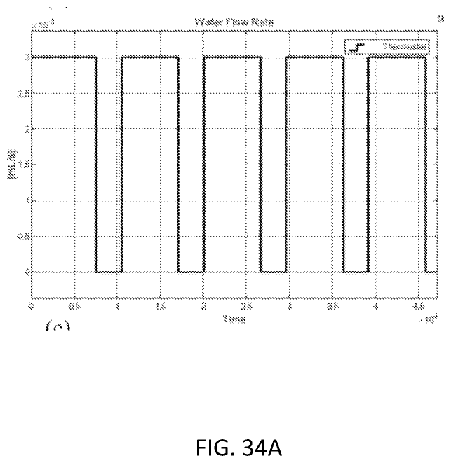

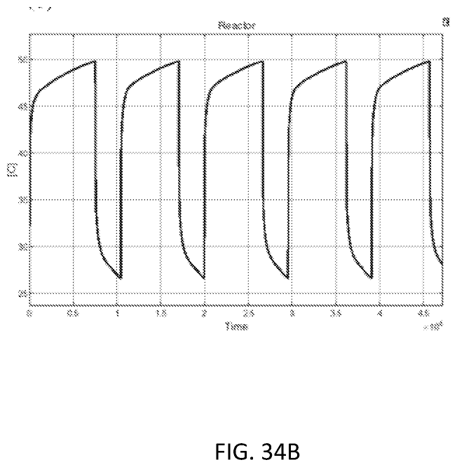

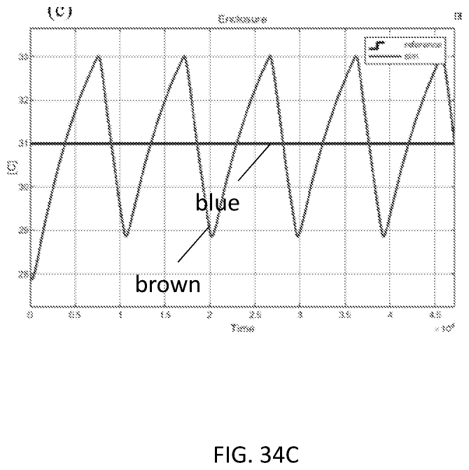

FIG. 34A-34C are time series plots for bang-bang thermostat controller simulation: 34A shows a commanded water flow rate; 32B shows reactor temperature; and 32C shows enclosure temperature (reference: blue line, simulation output: brown).

### Surviving the Lunar Night Using Metal Oxidation Warming Systems II

### II-1. Introduction.

This example focused on the development of a MOWS as described in section I-1. Additional aspects, including a more advanced MOWS system, a flight stack thermal load, and testing in vacuum, are described.

### II-2. Objectives.

This example effort sought, as described in section I-1, to develop and characterize a flight-like metal oxidation warming system in an appropriate thermal vacuum environment.

After identification of suitable chemistries for MOWS, heated enclosures were designed that can meet the thermal requirements of payloads and flight computers. A range of thermal conditions was considered, varying selenographically from the poles to the equator (including PSRs) and chronologically from lunar day to lunar night. Thermal models were created to better understand components' thermal requirements and advance enclosure designs. A breadboard heating system was designed and manufactured.

### II-2.2 Detailed Work Plan.

### II-2.2.1. Detailed Heater Requirements Definitions.

### II-2.2.1.1. Flight Computer Thermal Requirements.

This example effort sought to determine the thermal requirements for a typical lunar lander flight computer. The analysis considered the heating requirements of the flight computer, the heat generated by the flight computer, and the thermal properties of the typical flight computer mounting and enclosures. Cases for both lunar day and lunar night will be considered in this analysis. The Masten XL-1 flight computer used as a starting case, an LN200, and other lander/rover computers on the market were studied to ensure the development of a widely applicable solution.

### II-2.2.1.2. Payload Thermal Requirements.

This example effort sought to determine the thermal requirements for a typical lunar lander payload. This analysis considered the heating requirements of the payload, any heat generated by the payload, and the thermal properties of typical payload mounts and enclosures. Cases for both lunar day and lunar night were considered in this analysis.

### II-2.2.1.3. Review and Downselect Chemistries.

Candidate chemistries were downselected based on the requirements generated in tasks II-2.2.1.1 and II-2.2.1.2. Considerations included (but are not limited to) specific energy, performance at low temperatures and low rates, and the ability to sustain reactions for extended durations.

### II-2.2.2. Enclosure and System Design.

### II-2.2.2.1. Flight Computer Enclosure Design.

A flight computer enclosure heated using MOWS was designed based on the results of task II-2.2.1.1 and the chemistries selected in task II-2.2.1.3. This enclosure was designed such that the flight computer will survive the lunar night but will not overheat during the lunar day.

### II-2.2.2.2. Payload Enclosure Design.

A payload enclosure heated using MOWS was designed based on the results of task II-2.2.1.1 and the chemistries selected in task II-2.2.1.3. This enclosure was designed such that the payload will survive the lunar night but will not overheat during the lunar day.

### II-2.2.2.3. Mass and Performance Trade Study.

A trade study was conducted on heating systems using the reactions selected in task II-2.2.1.3. In addition to the considerations in task II-2.2.1.3, this study considered mass and volume requirements for pressure vessels and hardware, insulation and thermal isolation, heat pipe considerations, and the effect of these considerations on the duration of payload survival on the surface.

### II-2.2.3. Thermal Model.

### II-2.2.3.1. Lunar Landing Site and Spacecraft Thermal Environment.

A variety of lunar landing sites and lunar operational environments were considered. From these, a range of thermal environments for lunar landers will be created. This included various locations and times during the lunar day/night cycle. Thermal environments considered include XL-1 lander Design Reference Missions to Aristarchus and the lunar south pole. Data from those thermal models which span the lunar day, generated in Thermal Desktop, was used in this task.

### II-2.2.3.2. 3D Steady-State Enclosure Model.

Based on the thermal environments determined in task II-2.2.3.1, a steady-state model of a MOWS-heated enclosure from II-2.2.2.1 or II-2.2.2.2 was created. Design CAD files were used to build the steady-state model in a thermal analysis program, either SOLIDWORKS® Simulation or AUTODESK® Thermal Desktop. Boundary conditions were generated based on spacecraft thermal modeling best practices and consider different spacecraft orientations and starting temperatures.

### II-2.2.3.3. 3D Transient Enclosure Model.

Based on the thermal environments determined in task II-2.3.3.1 and the thermal model created in task II-3.3.3.2, a transient model of a MOWS-heated enclosure was created. Design CAD files were used to build the steady-state model in a thermal analysis program, either SOLIDWORKS® Simulation or AUTODESK® Thermal Desktop. Boundary conditions were generated based on spacecraft thermal modeling best practices and consider different spacecraft orientations and starting temperatures.

### II-2.2.4. Thermal Test Article.

### II-2.2.4.1. Design Test Article.

A breadboard heater test article was designed. This test article includes flow rate, temperature and pressure control, on/off cycling capability, varying thermal load, and other capabilities. A minimum number of instruments to fully capture the key variables and performance metrics of the test article were used.

### II-2.2.4.2. Manufacture Test Article.

The test article described in task II-2.2.4.1 was manufactured in-house. After assembly and inspection, the test article was transferred to a test site.

### II-3. Work

### II-3.1. Chemistry Evaluation and Downselect.

To enable the design and analysis of a MOWS heater, one of the earliest requirements was the selection of a metal oxidation reaction. This began with a literature survey of candidate chemistries. From this survey, several chemistries were selected for initial small-scale testing.

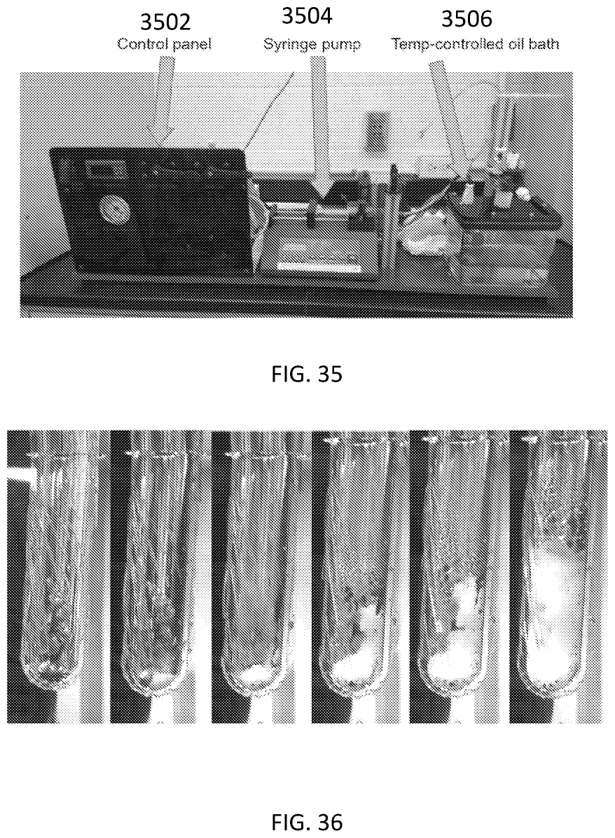

The first round of testing involved lithium, aluminum, titanium, and iron as fuels, with liquid water as the oxidizer. All these reactions were determined to be thermodynamically favorable at relevant conditions, with theoretical specific energies 5-10× those feasible with batteries. Micro- and nano-powder fuels were employed in Al, Ti, and Fe tests to mitigate slow reaction kinetics due to formation of passivating surface oxides. Fuel pellets or powder were introduced into a test tube under an inert argon atmosphere inside a glovebox. The test tube was placed in a temperature-controlled oil bath to ensure that initial temperature did not affect the reaction kinetics. The experimental setup is shown by FIG. 35, indicating a control panel 3502, a syringe pump 3504, and the temperature-controlled oil bath 3506. A plastic sleeve was placed over the test tube to prevent direct contact between the test tube and oil. The syringe pump was used to deliver oxidizer at a slow and controlled rate. Of the four metal fuels tested, Li was found to react most readily and at a consistent rate. FIG. 36 depicts the progression of the lithium-water reaction over time, from left to right. Al was found to react inconsistently, and Ti and Fe displayed limited reactivity. Based on these results, lithium was selected as the fuel for further work.

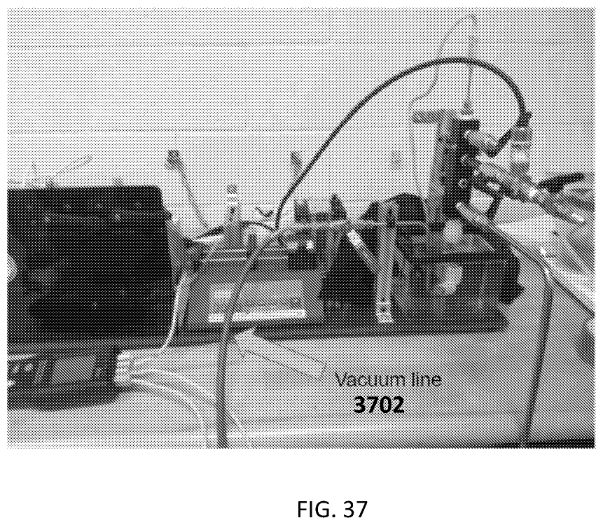

Next, the behavior of the lithium-water reaction was studied with respect to the state of the oxidizer (liquid vs. vapor). A vapor-phase oxidizer reactor could avoid sensitivity to gravity, while a liquid-phase oxidizer system would be susceptible to gravity's effects. The experimental setup for liquid oxidizer was the same as for previous tests. However, for vapor-phase oxidizer delivery, the flow path of the reactor was reconfigured so that steam would travel through the pellets instead of entering a manifold space above them. This stops hydrogen gas, produced by the reaction, from creating a diffusion barrier and preventing steam from reaching the lithium. Also, a vacuum line 3702 was used to draw steam over the lithium instead of using the steam's vapor pressure to induce flow, as illustrated by FIG. 37. This reaction did not proceed well and required frequent adjustments, so it was concluded that liquid-phase oxidizer delivery was better suited for this project.

At this point, the lithium-water reaction with liquid-phase oxidizer was selected for further study. The next step was the characterization of this reaction at a low startup temperature. This allowed verification that the reaction would start below room temperature and to explore any changes in the reaction as a function of temperature. This test was carried out using the same setup as previous tests, but the lithium was cooled to 12° C. before the test began. A thermocouple inserted into the lithium bed allowed the starting temperature to be measured directly.

The reaction started immediately when the oxidizer was introduced into the test tube. Temperature initially rose to 46° C. before settling to the high 30s° C. for the remainder of the test; the initial temperature spike can be attributed to more unreacted lithium in contact with the water. It is believed that higher reaction temperatures are possible, but more oxidizer was not introduced to avoid flooding the test tube.

Another option for lower-temperature operation was studied: a water/hydrogen peroxide mixture. Both should be effective oxidizers for lithium, and although both freeze at approximately 0° C., a 50/50 water/peroxide mixture freezes below −50° C. This can enable operations in colder areas where pure water would be ineffective, so a 50/50 water/peroxide mixture was tested under colder conditions than previous tests.

Instead of the oil bath used previously, the reaction test tube was placed in a beaker filled with low-viscosity silicone oil. A glycol loop connected to a circulating chiller was used to cool the beaker, which was wrapped with foam insulation to minimize heat transfer from the atmosphere. The test tube was cooled to −11° C., and the water/peroxide mixture was added to the lithium pellets as before. The reaction started immediately at −11° C. but displayed slightly different behavior, with more bubbles and foam than previous tests. The temperature in the test tube rose to 16° C. before oxidizer flow was paused. Oxidizer flow was stopped and restarted several times, and the temperature was held between 7° C. and −9° C. for the remainder of the test. The reaction stopped visually while there was unreacted lithium in the test tube, suggesting that the oxidizer was prevented from reaching the rest of the fuel. It is hypothesized that a passivating Li₂O₂ film may have been produced on the lithium fuel from reactions with the H₂O₂ oxidizer; it may be possible to disrupt this film with the addition of reaction promoters (chlorides, for example).

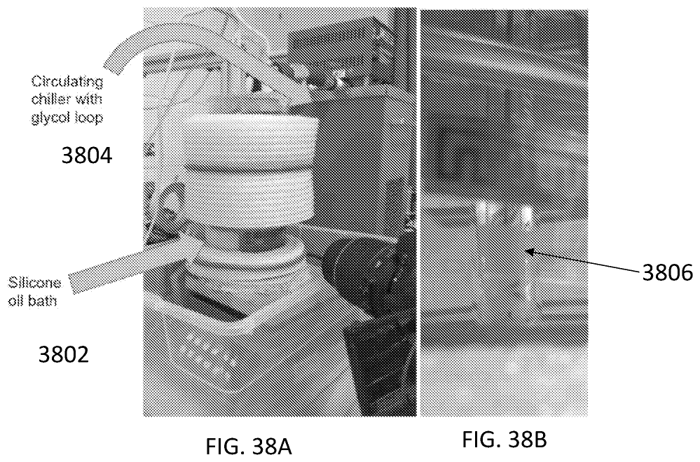

FIG. 38A-38B depict a testing apparatus for a 50/50 water/peroxide mixture. FIG. 38A shows an experimental apparatus including silicone oil bath 3802 and circulating chiller 3804. FIG. 38B shows reaction test tube 3806 displaying foaming behavior.

Based on the testing described here, a lithium-water reaction (without peroxide) was selected. This decision was driven by the foaming behavior and unreacted lithium observed in the peroxide reaction and material compatibility issues between peroxide and the test apparatus.

### II-3.2. Lunar Thermal Conditions Summary.

To inform the creation of thermal models, a study of the lunar thermal environment was conducted. This study included both mid-latitude regions and polar regions, including PSRs. This diversity allows MOWS heaters to be simulated in the extremes of the lunar environment.

### II-3.2.1. Mid-Latitude.

Most previous lunar missions (both manned and unmanned) have landed in mid-latitude regions, so there is considerable data available on this thermal environment. Surveyor I, III, and V all landed within 3° of the lunar equator. Their mission reports cite a lunar surface temperature range of ˜100 K to ˜400 K. In addition, data from the television camera on Surveyor I indicates that the camera experienced a minimum nighttime temperature of approximately 94 K.

These findings are corroborated by a study of thermocouples left on the Moon during Apollo 15 and 17. Apollo 15 landed at 26.13222° N, while Apollo 17 landed slightly further south at 20.19080°. These sites are not as close to the lunar equator as the Surveyor missions but can still be considered mid-latitude. This data indicates that the maximum daytime temperature varies between approximately 350 K and 375 K. Meanwhile, the “pre-sunrise temperature” (defined as the temperature at a specific time after sunset) varies in the range of 76-92 K. This is considered representative of the minimum temperature experienced during the lunar night.

Both the Surveyor and Apollo data sets suggest that to survive the lunar day-night cycle at mid-latitude sites, spacecraft components must survive temperatures as high as 400 K and as low as 75 K.

### II-3.2.2. Polar and Permanently Shadowed Region (PSRs)s.

Temperature data for the lunar poles and PSRs is mostly derived from the Lunar Reconnaissance Orbiter (LRO), specifically the Diviner Lunar Radiometer Experiment. LRO observations of the Lunar Crater Observation and Sensing Satellite (LCROSS) are especially useful, as LCROSS targeted the Cabeus crater near the lunar south pole. Summer solstice temperatures in the LCROSS impact region were measured by Diviner at 47 K during the lunar day and 39 K during the night. Topographic features within PSRs can create even colder areas, with midday temperatures as low as 29 K. Software models also predict annual average temperatures in this area to be around 38 K.

A lander at the poles may not be required to operate continuously in the coldest known regions, so these extreme temperatures (e.g., 30 K) were not used in this study. However, LRO data indicates that potential lander targets in the lunar south polar region are also extremely cold. The Haworth, Shoemaker, and Faustini craters have been considered as potential cold traps for water ice and thus are attractive areas for polar missions. LRO data suggests that Haworth has Tmax ˜60-80 K, Shoemaker has Tmax ˜70-95 K, and Faustini has Tmax ˜85-95 K. Given that any of the craters described above is a potential target for future missions, the lowest Tmax value was considered a good baseline for MOWS work. Therefore, MOWS development moved forward with a minimum operational temperature

### II-3.3. Thermal Requirements Definition.

Once the external thermal conditions were specified, the next step in MOWS heater design was to identify the thermal requirements of flight computers and payloads that may be used on polar missions.

### II-3.3.1 Flight Computers.

Several flight computers had been considered for Masten's XL-1 lunar lander, so these were used as a baseline for MOWS heater requirements. One such flight computer is SpaceCube, an FPGA-based data processing system developed by NASA GSFC. SpaceCube systems have flown on the International Space Station and are considered up to TRL 8. The operational temperature range for a baseplate conduction-cooled SpaceCube system is −40° C. to 65° C.

Another flight computer considered for lunar work is the Aitech SP0-S, a space-qualified 3U single-board computer. This computer is ruggedized for space operations and also has an operational temperature range of −40° C. to 65° C. under space vacuum.

In addition to these specifications, Masten referenced XL-1 thermal design work performed by Robert Hawkins of NASA MSFC under the NASA CATALYST program. This work also used −40° C. as a lower bound on avionics temperature. Since this matches the operating ranges of both candidate flight computers, −40° C. was selected as the minimum operating temperature for a generic lunar flight computer.

### II-3.3.2 Payloads.

The data available from lunar payload providers indicates that the thermal requirements for lunar payloads are very similar to those of flight computers and other electronics. An initial survey of LSITP payloads (L-CIRiS, Radsat, Lunar Sounder, and SAMPLR) indicates heater powers from 2-20 W. This was used to validate thermal models of MOWS heaters.

In addition to these heater power estimates, LSITP payload providers generally specify acceptable temperature ranges for their payloads. A review of the requirements for HEIMDALL, L-CIRIS, LETS, MoonRanger, NIRVSS, SAMPLR, and MSolo shows that most of these payloads have minimum temperatures between −50° C. and −30° C. Honeybee's LISTER payload is designed to measure heat flow from the Moon's interior, combining a pneumatic drill with thermal sensing equipment. According to Honeybee's engineers, the survival temperature range for LISTER is −40° C. to 70° C., with an operational temperature range of 0° C. to 50° C. These payload temperatures align well with the ranges described previously for flight computers, so for this study, it was assumed that a MOWS heater for flight computers would also provide effective heating for a generic payload. The greatest variation in payload thermal conditions, based on proposed payloads for Masten's XL-1 lunar lander, is the mounting location. Certain payloads may be sun-facing or shadow- and surface-facing. The worst-case considered for thermal modeling purposes was a space-facing payload mounted on the lander's top deck operating during the lunar night.

### II-3.4 Mass and Performance Trade Study.

A trade study was conducted to compare the different warming systems for space applications currently in use. The existing warming systems listed in Table. 1 are described along with their advantages and disadvantages. A thorough examination of the different options supports the simplicity, reliability, and feasibility of the MOWS approach.

TABLE 1
Warming systems trade study matrix.

| Warming | | | | |
|---|---|---|---|---|
| System | Heating Capability | Energy/Mass | Packaging/Safety | Availability |
| Li-ion | Very high thermal | Specific energy - | Extensive thermal | High availability |
| Batteries | efficiency - 99% | 250 Wh/kg | management | |
| | | | system required | |
| Alkaline | High thermal | Specific energy - | Short lifespan due | High-purity |
| Fuel Cells | efficiency - 60% | 450 Wh/kg | to electrolyte | hydrogen |
| | | | corrosion. Lifespan of | required raises |
| | | | 2600 h observed for | project costs |
| | | | space application | |
| RTGs/ | Very low thermal | Power density - | Very bad - radiation | Least available - |
| RHUS | efficiency (10%), | 540 W/kg | effect | high costs and |
| | but very reliable | | | regulatory |
| | | | | constraints from |
| | | | | plutonium core |
| Thermal | Half the energy | Specific energy - | Would require | TRL in space |
| Batteries/ | density of Li-ion | 100 Wh/kg | extremely well- | applications |
| Capacitors | batteries | | designed thermal | is low |
| | | | insulation | |
| MOWS | Very high thermal | Specific energy - | Packaged | Lithium/water |
| | efficiency - up to | 1305 to 1900 | hermetically | reactants readily |
| | 90% | Wh/kg | with inert gas | available |

### II-3.4.1. Existing Warming Systems.

Li-ion battery systems have been considered for use in shaded regions of the Moon. These systems are well established and not prohibitively expensive. However, the specific energy of state-of-the-art batteries is too low to make this system practicable. A Li-ion system to heat a lander throughout the lunar night is prohibitively heavy at 35-40 kg; this option can translate to over $10M in mass penalty costs to lunar providers. For commercial providers, this results in $10M less payload sales and lost revenue. The use of MOWS will provide mass savings in the tens of kilograms over the Li-ion solution. Preliminary designs suggest that MOWS for a small lander is less than 5 kg.

Radioisotope thermoelectric generators (also called radioisotope heating units (RHUs)) do not have this mass penalty but are extremely expensive and difficult to obtain and implement for regulatory reasons. Current RHUs are based on 238Pu, which is produced in the US at only ˜1 kg per year. The material is highly radioactive and hazardous during spacecraft integration, as well as crewed lunar operations. MOWS uses low-toxicity, commercially available reactants. While some must be handled carefully (lithium, for example), they are considerably less dangerous than plutonium; lithium is not considered toxic by the U.S. government. These reactants are also significantly cheaper than plutonium, allowing for larger-scale testing and use. Finally, RHUs produce heat continuously through radioactive decay and are not designed to be throttled or turned on and off. If excess power is generated by an RHU, it must be stored (adding mass and complexity) or rejected (making the system inefficient). By contrast, MOWS can increase or decrease heat generation on-demand by simply modulating an oxidizer (e.g., water) supply pump or valve. A valve could even be passively thermostatically actuated, as is done for temperature control of refrigeration systems for fully analog operation. For near-term commercial lunar missions, RHUs are not a practical solution due to their prohibitive costs ($75M+ in direct costs) and associated regulatory concerns.

Alkaline fuel cells produce an electrical current through the reaction of hydrogen and oxygen. The oxidation of hydrogen produces water and releases electrons. Alkaline fuel cells have significant NASA heritage, as they were used to provide power for the Apollo Command and Service Module and the Space Shuttle Orbiter. These fuel cells offer greater specific energy than lithium-ion batteries at up to 450 Wh/kg. Their lower mass makes alkaline fuel cells an enticing option, but they are not without problems: The relatively higher specific energy of alkaline fuel cells compared to lithium-ion batteries is balanced by their relatively lower thermal efficiency of approximately 60%. In the case of adding heat to the spacecraft to survive the lunar night, waste heat may not be a concern. However, this would require the fuel cell to be mounted close to other critical flight hardware, which presents some design, integration, and failure mode complexities. Therefore, a system that provides more flexible integration options and lower design costs is needed. On a lunar mission, redesigning and recertifying avionics packaging to include a fuel cell would cost millions of dollars. The nature of alkaline fuel cell reactions reduces the lifetime of the fuel cell to just 2,600 hours for space applications, which would only be enough to survive a few lunar nights. The hydrogen required for the alkaline fuel cell to operate must be of “technical-grade” purity (99.999%) or else impurities threaten to decrease the lifetime of the alkaline fuel cell even further. The necessarily high purity of hydrogen combined with the complex hydrogen storage solution required to maintain this high purity have been known to raise project costs.

Thermal capacitors, also known as thermal batteries, are simple physical structures that store and release thermal energy. Like RHUs, thermal capacitors eliminate the need for a heater and transfer heat directly where it is needed. Unfortunately, thermal capacitors have nearly half the energy density of lithium-ion batteries at approximately 100 Wh/kg, creating an even larger mass problem. In addition, the highest specific energy thermal capacitors have poor heat transfer characteristics, making them challenging to thermally charge and discharge. The nature of heat transfer within thermal capacitors necessitates a very well-designed thermal insulation system, increasing the complexity of the overall design. These factors, combined with the relatively low TRL of thermal capacitors in space applications, make them infeasible for surviving the lunar night.

Solar-powered systems require sunlight and can only be used during the lunar day. An energy storage system (batteries, for example) allows a few hours of nighttime operation, but such a system adds mass and complexity. Solar panels are vulnerable to obstruction by dust, as exemplified by the Opportunity rover on Mars, and lunar dust is known to be especially difficult to remove due to its electrostatic nature. Past lunar landers using solar-powered systems, including the Surveyor missions, were able to renew operations after a lunar night. However, instruments on these missions ultimately degraded and prematurely ended the mission due to the cold temperatures. A more reliable option is needed to reduce the risk to commercial missions.

### II-3.4.2. Metal Oxidation Warming Systems (MOWS).

MOWS is an alternative means of supplying heat to a spacecraft to survive the lunar night. In this system, lithium (or other active metals) reacts exothermically with water (or other oxidizers); the heat produced is transferred through a heat pipe to heat critical spacecraft hardware. MOWS allows specific components, such as the flight computer, to be kept within their operational temperature ranges over the 336-hour lunar night. By maintaining proper thermal management, the spacecraft can survive while hibernating or function throughout the lunar night. According to some calculated estimates, this solution has an approximate specific energy of 1305-1900 Wh/kg, making MOWS a low-mass solution that operates without batteries. Lastly, MOWS is designed for restart/reuse and requires materials that are readily available and affordable.

### II-3.4.3. Trade Study Conclusion.

Battery and fuel cell options are more efficient and feasible than their existing counterparts; however, they also have their respective problems. Solutions requiring batteries to power a heater create additional mass, higher potential malfunctions, and have limited operational temperatures restricting space applications. The MOWS solution combines the advantages of both types of systems without their disadvantages. MOWS is robust with minimal failure modes; it relies on a chemical reaction and convective heat transfer, with no moving parts. MOWS is reliable: batteries have limited operational temperatures restricting space applications, whereas MOWS can be restarted on-demand.

### II-3.5. Test Article Design.

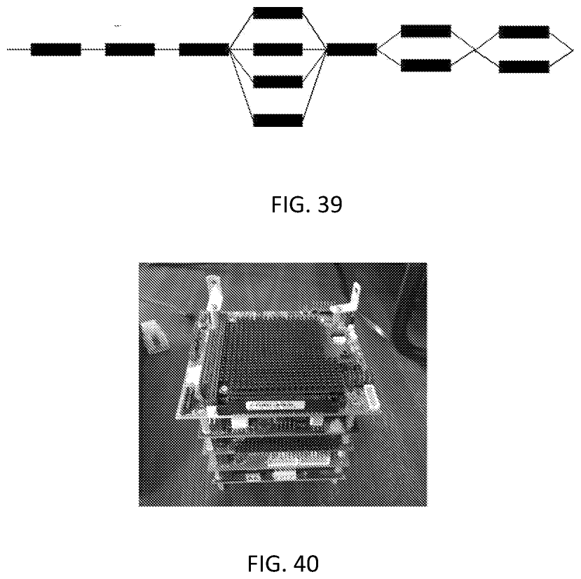

The test article was designed and manufactured with the goal of simulating the heat transfer rate of the final version. It features a reactor and an enclosure with a heat exchanger (heat pipe) between the two. The test article can be tested in a vacuum to simulate lunar night conditions, including no convection and low temperatures. The thermal resistance circuit for heat transfer from the reactor to the enclosure for vacuum conditions is shown in FIG. 39.

The thermal resistance circuit assumes adiabatic conditions radially around the heat pipe; neglects radiation from the heat pipe, heat spreader, flight computer stack, and fiberglass mounting plate; and neglects conduction to each plate on the flight stack individually. With the thermal resistance circuit constructed, the next step was to calculate each thermal resistance based on the thermal properties of each individual component.

### II-3.5.1 Thermal Analysis and Calculations.

Thermal conductivity and emissivity values were collected for the components in the assembly for calculation purposes. Some values are unknown, and some can vary around the given value. The thermal conductivities and emissivities are given in Table 2.

TABLE 2
Thermal conductivity and emissivity
values for current components.

| | Thermal | |
|---|---|---|
| | Conductivity | |
| Material & Component | (W/m-K) | Emissivity |
| Copper heat spreader | 388 | 0.07 |
| Aluminum enclosure case | 152 | 0.09 |
| Aluminum PC/104 standoffs | 152 | 0.09 |
| Fiberglass insulation mount | 0.04 | 0.75 |
| MLI | 1.0 | 0.04 |
| Thermal grease | 5.77 | Varies |
| Copper heat pipe | Varies | 0.07 |
| Fiberglass PC/104 board | Varies | Varies |

Using these reference values and the geometry of the components, the thermal resistances can be calculated according to the thermal resistance circuit shown in FIG. 39. In space conditions, the two primary modes of heat transfer are conduction and radiation. The following equations can be used to calculate the thermal resistances in each case.

$${R}_{cond} = \frac{t}{KA}$$

$${R}_{ra d} = \frac{1}{{h}_{ra d} A}$$

$${h}_{ra d} = δϵ ( {T}_{s}^{2} + {T}_{∞}^{2} ) ( {T}_{s} + {T}_{∞} )$$

$$t = thickness ( m )$$

$$K = thermal conductivity ( \frac{W}{mK} )$$

$$A = area ( {m}^{2} )$$

$$σ = Stefan ‐ Boltzman constant = 5.67 \times {10}^{- 8} \frac{Wm}{{K}^{4}}$$

$$ϵ = emissivity$$

$${T}_{s} = surface temperature ( K )$$

$${T}_{∞} = surrounding temperature ( K )$$

The thermal resistance values are shown in Table 3 along with the mode of heat transfer.

TABLE 3
Thermal resistance values and heat transfer modes.

| | Thermal | Heat |
|---|---|---|
| Thermal | Resistance | Transfer |
| Resistor | (K/W) | Mode |
| Rₕₑₐₜₚᵢₚₑ | 0.10-2.5 | Conduction |
| R_{thermalgrease} | 0.11583 | Conduction |
| R_{spreader} | 0.00033027 | Conduction |
| R_{leg1} | 23.745 | Conduction |
| R_{leg2} | 23.745 | Conduction |
| R_{leg3} | 23.745 | Conduction |
| R_{leg4} | 23.745 | Conduction |
| Rᵢₙₛᵤₗₐₜᵢₒₙₘₒᵤₙₜ | 13.623 | Conduction |
| R_{condbox} | 0.000049271 | Conduction |
| R_{radbox} | 160.65 | Radiation |
| R_{condmli} | 0.077653 | Conduction |
| R_{radmli} | 345.19 | Radiation |
| R_{radtoinf} | 17.495 | Radiation |

The equation relating thermal resistance to temperature change and heat transfer rate is shown here:

$$Q = \frac{{T}_{1} - {T}_{2}}{R} .$$

Using the thermal resistances, there are three unknowns remaining: heat transfer rate and the temperatures on each end. Assuming the radiation to space is to 4 K, the surrounding temperature is known. Inputting a desired reaction temperature of around 400 K results in an overall heat transfer rate of around 10 W. The temperature between each resistance can also be solved with the individual resistances. For a reaction temperature of 400 K and heat transfer rate of 10 W, the flight stack legs' temperature is 324-386 K, linearly decreasing along the stack. Some heat will be transferred to the PC/104 boards, which have a relatively low thermal conductivity due to the fiberglass material. The typical temperature operating range for the flight stack components is around 233-338 K, as outlined in the thermal requirements. Testing will help verify if the given heat transfer rate is sufficient to warm the flight stack components themselves. Temperatures along the thermal resistance circuit have been calculated and are shown below in Table 4. At a requirement of 10 W, MOWS is capable of meeting this need and keeping the flight computer alive through the lunar night.

### II-3.5.2 Flight Stack Enclosure Design.

The flight stack will need to accept the heat transferred from the metal oxide reaction to warm the payload or flight computer. A flight stack exemplifying components used is shown by FIG. 7A. A PC/104 flight stack with dimensions 3.55″×3.775″×4.25″, shown by FIG. 40, is used as the payload.

The flight stack is mounted to a fiberglass base on one of the side panels within the enclosure, and a heat pipe runs to it from the opposite side. The heat pipe connects to a sheath on a copper heat spreader plate, which is connected to the flight stack through the metal standoffs (e.g., spacers) of the PC/104 boards. The heat spreader aids in evenly distributing heat to the flight stack from the heat pipe through conduction.

A thermal grease allows for more uniform heat transfer from the heat pipe to the spreader. McMaster-Carr offers an electrically and thermally conductive grease with a thermal conductivity of 5.77 W/m-K which may be used for this purpose. In addition, Apiezon N thermal grease can be used, which is specially formulated for temperatures as low as −269° C. (4 K). Another option for attaching the copper heat pipe includes soldering or epoxying to the copper spreader.

The heat spreader needs high thermal conductivity to transfer heat from the heat pipe to the flight stack, so copper was the primary choice. The fiberglass material of the PC/104 boards does not allow them to transfer heat very effectively. Copper can be embedded into PC/104 boards to improve heat transfer capabilities, which would be highly considered for full-scale integration and spaceflight. Other options for improving heat transfer to the boards include connecting L-brackets to the flight stack and running aluminum rods or plates along the outside of the boards or custom heat spreader designs to transfer heat directly to the power components of the board rather than focusing on heating the boards themselves. For the test article, heat was transferred through the metal standoffs and the heat transfer was analyzed through testing.

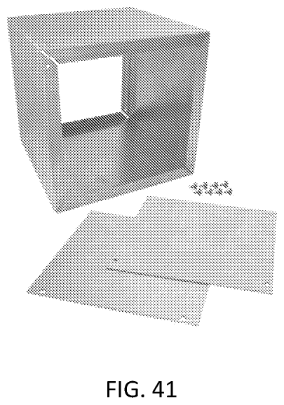

An enclosure casing to enclose the flight stack was commercially purchased from DIGI-KEY® Electronics. It has a footprint of 6″×6″×6″ and is made from aluminum with a thickness of 0.04″ and an overall weight of 0.75 lb. An illustration of the flight stack enclosure is shown in FIG. 41.

For testing the assembly in a vacuum, enclosure sealing is not necessary, so gaskets at all openings were not included. However, to avoid losing heat to the aluminum case, mounted components should still be insulated. Fiberglass plates, one for the flight stack attachment to the aluminum case and one for the case attachment to the vacuum chamber, were included to aid in retaining heat. McMaster-Carr has 1″ thick thermal fiberglass sheets with an R-value of 4.3.

Multi-layer insulation (MLI) is used on spacecraft to help with thermal control in vacuum. MLI manufacturers include Dunmore Aerospace and Aerospace Fabrication & Materials (AFM). MLI's total thickness is typically around 0.5″. Due to preliminary estimates for temperature change during the testing phase being lower than what the full-scale version will encounter, it was decided that MLI was not needed to further reduce the heat transfer rate of the system radiation.

### II-3.5.3 Heat Pipe Design.

To transfer thermal energy from the reactor vessel to the flight computer, copper bus bars and heat pipes were considered. Based on datasheets and bench testing, the heat pipe's performance proved it was the best choice for the prototype. Heat pipes use multiphase flow and capillary action to provide excellent heat transfer and are common in space hardware. Advanced Cooling Technologies (ACT) and Boyd Corporation are two heat pipe companies that were contacted regarding custom heat pipe solutions during the research process. Initially, the heat pipe itself was to include fin structures on both ends to distribute heat. After additional research, other options were presented. A copper heat spreader plate was identified as a better solution on the enclosure side, and a custom fin structure was considered on the reactor side. The lithium hydroxide produced in the metal oxide reaction is corrosive to copper, so a copper heat pipe cannot be in direct contact with the reaction. Nickel plating and additional heat pipe materials were discussed, but they would also be subject to corrosion if in contact with the reaction. For these reasons, a sheath structure was designed for the heat pipe to slide into on the reactor side. With neither end of the heat pipe requiring a custom fin structure, a commercial off the shelf (COTS) heat pipe could be selected. Commercial copper heat pipes in the range of 4-10 mm diameter with around 300 mm length should sufficiently transfer at least 20 W of heat.

Another key consideration in the heat pipe design is the temperature operating range for the working fluid. A heat pipe with a working fluid that can survive lunar night conditions could be very expensive. The reaction should be activated prior to entering very low temperatures to help maintain a warmer temperature in the heat pipe through the lunar night. Another potential solution for transferring heat from the reactor to the enclosure is a copper rod. Although the weight would be much higher (1,400 grams for a 1″ diameter copper rod compared to around 50 grams for a 22 mm heat pipe, with 12″ length in both cases), thermal resistance could be similar between the two. This would not be very feasible for the space version but could be an option for the test article if testing at very low temperatures is important. A 1″ diameter, 12″ length copper rod would have a thermal resistance around 1.55 K/W for conduction through the rod. Other studies have shown thermal resistances between 0.10-1.50 K/W for similarly sized heat pipes.

For the final design, two COTS heat pipes were considered, both available as commercial off-the-shelf hardware from DIGI-KEY® Electronics: a 4 mm heat pipe capable of transferring 20 W and a 10 mm heat pipe rated for 67 W. Both heat pipes are copper and use water as the working fluid. To investigate the thermal resistance of these heat pipes, one of each was purchased for testing.

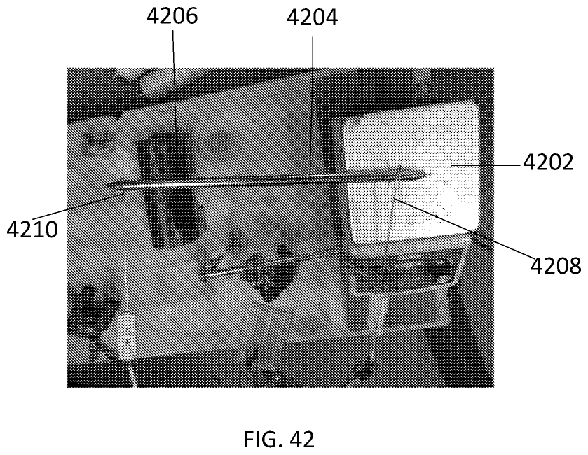

FIG. 42 depicts the test apparatus. A hot plate 4202 was used to heat one end of the heat pipe 4204, with the other end supported by foam insulation 4206. Both ends of the heat pipe were instrumented with K-type thermocouples 4208, 4210, and the temperature difference across the pipe was measured. The results are shown in Table 4.

TABLE 4
Comparison of Heat Pipes.

| Heat Pipe | T_{high} (° C.) | T_{low} (° C.) | ΔT (° C.) |
|---|---|---|---|
| 4 mm | 68 | 51 | 17 |
| 10 mm | 46 | 44 | 2 |

Table 5 shows that, while the 4 mm heat pipe developed a significant temperature differential, the 10 mm heat pipe showed much less temperature drop across the heat pipe. As the K-type thermocouples used have an accuracy of ±1° C., the 2° C. temperature change could be within the noise range of the thermocouples rather than an observable phenomenon. Based on this heat pipe testing, the 10 mm commercially available heat pipe was selected for further testing.

### II-3.5.4 Reactor Design.

As part of the overall test article design, a prototype MOWS reactor was designed for further testing. The exothermic chemical reaction at the heart of the MOWS concept occurs in this reactor. Preliminary work indicated that a 1-2 L reactor vessel would produce sufficient heat and be easily packaged for vacuum chamber testing, so this reactor size was baselined for this design. In addition, initial work has shown that reaction products can expand two to three times compared to the initial reactant volume. The reactor design must allow sufficient headspace for this expansion.

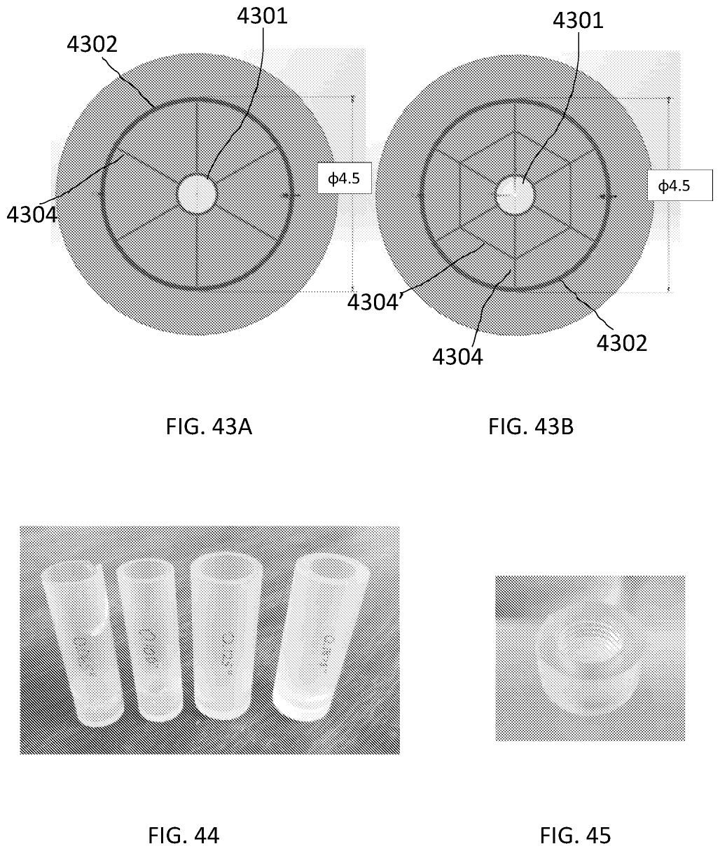

The reactor design must ensure that oxidizer is evenly distributed to the fuel and that the fuel reacts as thoroughly as possible. Therefore, a cylindrical reactor vessel was baselined for simplicity, ease of manufacturing, and the need to insert a heat pipe into the reactor. The reactor is divided into sections; each section for containing lithium fuel powder and have a supply of oxidizer delivered to it. Internal fin structures can increase heat transfer to the heat pipe and add more area for the lithium-water reaction to occur. FIGS. 43A and 43B illustrate a view looking down the reactor axis 4301. Outer walls of the reactor are indicated by 4302, walls in the interior of the enclosure are indicated by 4304 and 4304′. For the final design, a configuration with six longitudinal fins (FIG. 43A) was chosen to balance reaction area and heat transfer with ease of manufacturing and testing.

A significant aspect of reactor design involves compatibility with the substances involved. The lithium-water reaction produces lithium hydroxide (LiOH) as a product. LiOH is a strong base and is corrosive to many materials, including copper and aluminum. Suitable materials include stainless steel, titanium, and some plastics. While titanium is attractive for a flight system because of its high strength, low weight, and chemical compatibility, a titanium reactor would be difficult to manufacture and was out of budget range for initial prototyping. Stainless steel is cheaper and easier to fabricate and was initially considered for the reactor vessel. However, the key aspects of the reactor (oxidizer delivery, heat transfer fins, and a heat pipe sheath) suggested that the reactor vessel geometry could be fairly complex. Therefore, an additively manufactured plastic reactor vessel was made.

Several print tests were performed to ensure that a printed reactor vessel would perform well. These were printed in-house using the stereolithography (SLA) process on a Formlabs FORM2® printer and using Formlabs Clear v4 resin. SLA produces watertight parts with good chemical compatibility, unlike fused deposition modeling (FDM) processes. For the first print test, several plastic test tubes were printed and tested for compatibility. The test included reacting lithium and water in the test tubes. The same reaction was carried out in glass test tubes, with a sample of printed material inserted into the test tube as well. These tests showed no effect on the plastic, showing good material compatibility between the printed plastic and reaction products. Next, a series of test tubes with varying wall thicknesses were printed. FIG. 44 illustrates printed test tubes to check minimum wall thickness. From left to right, the thickness is 0.065″, 0.100″, 0.125″, and 0.1875″. Note the cracking in the 0.065″ wall tube (far left). Based on the printed test tubes, a minimum wall thickness of 0.100″ was baselined for the reactor vessel.

The next test involved printing NPT threads to ensure that printed threads would be usable and durable enough for use in a reactor vessel. It was theorized that printing threads would be easier than using threaded inserts of some kind since the printed plastic is brittle (precluding the use of press-fit inserts) and is somewhat sensitive to heat (making it inadvisable to use thermo-set inserts). A test part was also drilled and tapped by hand, but the resulting threads were rough and chipped. Several iterations were necessary to validate the thread profile, but the team found thread geometry that would print successfully, as shown by FIG. 45.

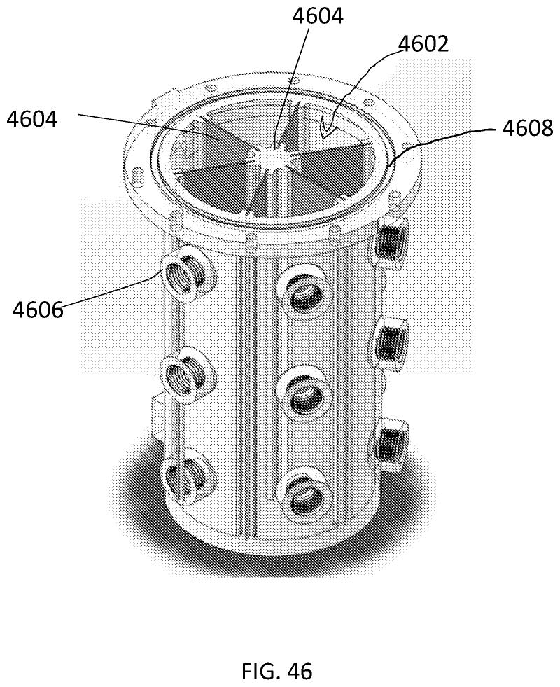

With these print tests complete, a printed reactor vessel for the test article was designed. FIG. 46 depicts a perspective view of the final design, featuring six sections 4602 attached to a central sheath 4604 for the heat pipe. The sections are separated with 0.024″ thick stainless steel sheets 4604 to help with heat transfer. The reactor body also features 12 instrumentation ports 4606 with ¼″ NPT threads. These ports allow measurement of pressure and temperature at various points inside the reactor vessel.

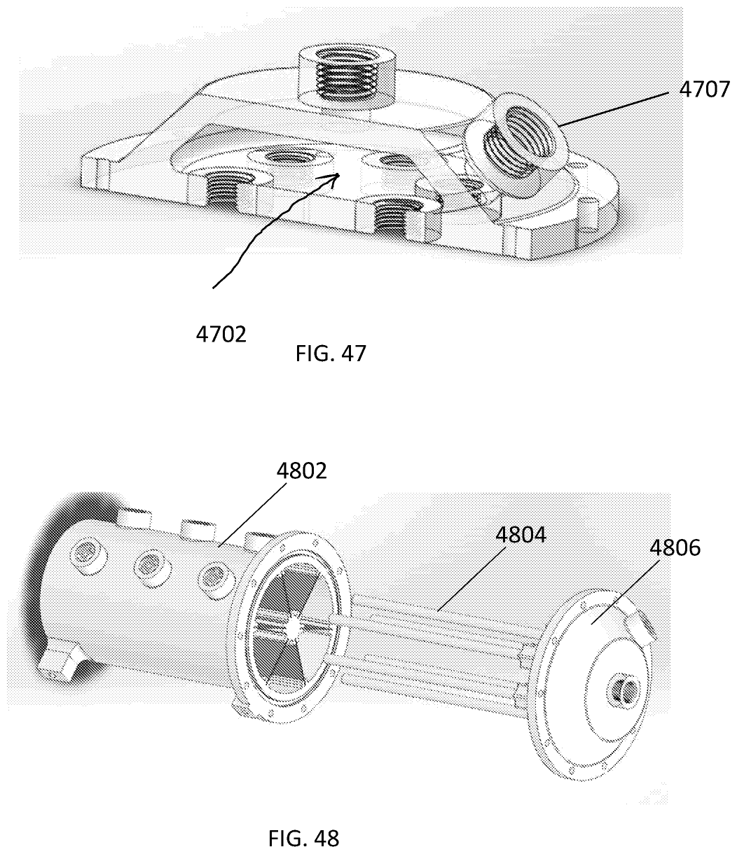

An SLA-printed cap, illustrated by FIG. 47, is attached to the reactor body via a flanged interface and groove 4608 (FIG. 46) for placement of an O-ring. The cap includes a manifold 4702, where oxidizer is delivered and distributed into each section of the reactor vessel. The cap also has a ¼″ NPT instrumentation port 4704 for measuring pressure and temperature inside the manifold. Oxidizer is delivered to each section through a polypropylene tube 4802, with radially drilled holes along its length, as illustrated in FIG. 48. FIG. 48 depicts an exploded view of the body 4804, tubes 4804, and cap 4806.

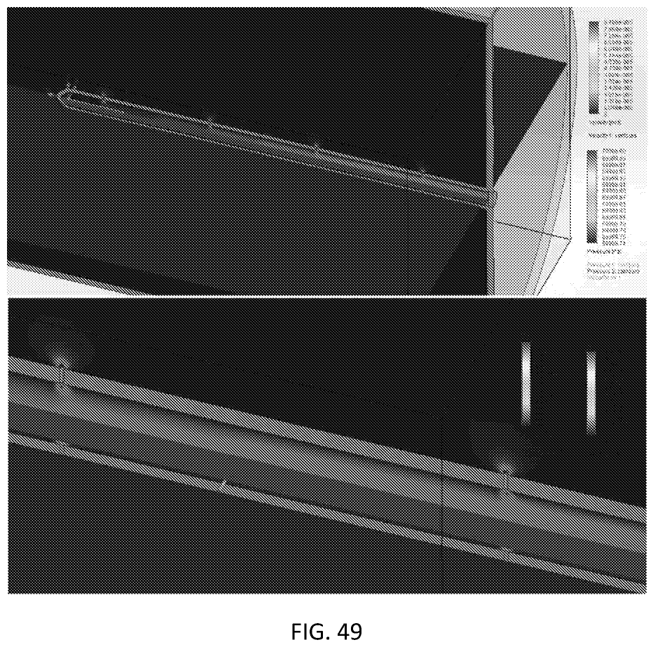

Characterization work suggested that, for the heat rates involved, the flow rate of water into the reactor would be on the order of 0.2 mL/min; this is then divided between the six reactor sections, resulting in extremely low flow rates inside each polypropylene tube. Therefore, the orifices to deliver oxidizer to the lithium need to be small, such that backpressure is built in the tubes to enable even flow. With insufficient backpressure, gravity effects will dominate, and most of the oxidizer will flow out of the first one or two orifices. To ensure that the holes are sized correctly, CFD analysis was performed in SOLIDWORKS® Flow Simulation. This analysis suggested that seven holes approximately 0.0125″ in diameter drilled through each tube would provide the desired combination of flow rate and backpressure. A #80 drill bit is 0.013″ in diameter, so seven #80 holes were drilled through each tube. FIG. 49 depicts computational fluid dynamics (CFD) analysis of oxidizer flow through the polypropylene tubes. Top: overall view of the analysis; bottom: detailed view of the 0.0125″ holes

### II-3.6 Thermal Models.

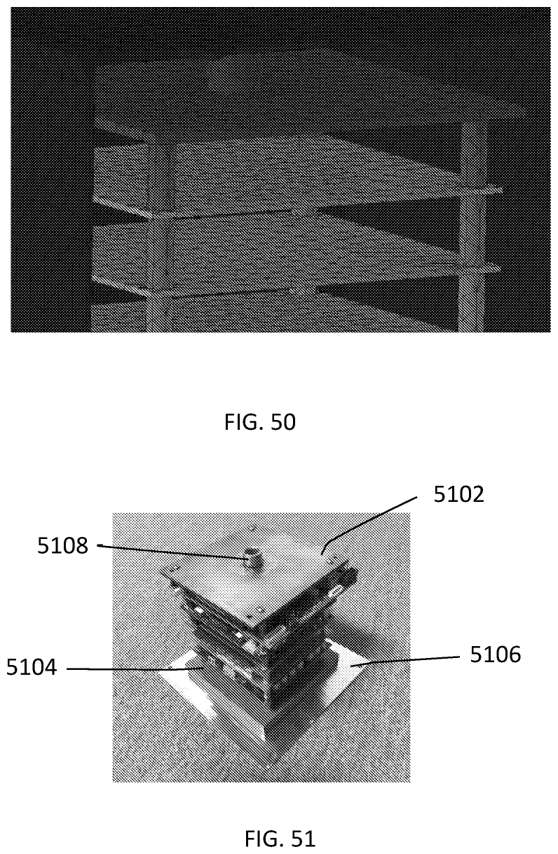

Thermal simulations were conducted in SOLIDWORKS® to replicate the heat transfer effects on the assembly. Both terrestrial and in-space cases were considered. This model was used in designing the enclosure and in verifying the thermal hand calculations. The same model build and mesh was used for all 3D thermal models for consistency; this mesh is shown in FIG. 50. The grey gradients represent temperature in the results. The changes were to the radiation boundary conditions, starting temperatures, and input thermal energy.

Thermal model runs were performed in SOLIDWORKS® Simulation for both steady-state and transient conditions. The thermal input boundary condition was modeled via a heat pipe with a high thermal conductivity. Setup between the space and lab environment simulations was similar, with differences in the external temperature to which the box is radiating, as well as the addition of conformal coating on the flight boards and a low-E coating on the interior of the enclosure. The parameters for the simulation are listed in Table 5.

TABLE 5
Parameters for Thermal Simulations.

| | | Thermal |
|---|---|---|
| | | Conductivity |
| Material | Emissivity | (W/m-K) |
| Heat Pipe | .04 | 5600 |
| Copper Plate | .04 | 390 |
| Aluminum Standoffs | 0.06 | 170 |
| Fiberglass Circuit Boards | 0.8 | 0.27 |
| (space) - conformal coated | | |
| Fiberglass Circuit Boards (lab) | 0.75 | 0.27 |
| Aluminum enclosure | 0.05 | 170 |
| Enclosure emissivity coating | 0.01 | n/a |
| Fiberglass Insulation Block | 0.75 | 0.233 |

### II-3.6.1 Steady-State Lab Environment.

The external boundary condition for this case assumes radiating to a constant temperature environment of 283 K, which represents the lab temperature and the outside of the vacuum chamber. The full set of boundary conditions is shown in Table 5.

TABLE 5
Boundary conditions for steady-state lab simulation.

| Boundary Condition | Description | Value |
|---|---|---|
| Heat pipe | Heat power input | 5 W |
| Box external | Radiation to ambient | 268 K, ε = 0.05 |
| Heat spreader | Radiation to components | ε = 0.04 |
| Box internal | Radiation to components | ε = 0.05 |
| Standoffs | Radiation to components | ε = 0.06 |
| PC/104 boards | Radiation to components | ε = 0.80 |
| Fiberglass base | Radiation to components | ε = 0.75 |
| Single external face | Radiation to ambient | 268 K, ε = 0.05 |
| Mounting feet temp | Constant temperature | 268 K |

The results of this study indicate that a MOWS heater supplying 5 W in a lab environment would maintain flight computer temperatures in the approximate range of 295 K to 340 K (22° C. to 67° C.). While the upper bound of this range is slightly outside the acceptable temperature range defined earlier, this can be overcome by tuning the heat input and improving the heat spreader design to transfer heat to the boards more uniformly.

### II-3.6.1 Steady-State Lunar Environment

Minor changes were necessary between the steady-state runs for a terrestrial vs. space environment. Specifically, the external temperatures to which the box radiates were changed. Instead of radiating to 283 K, all exterior faces except one were set to radiate to 4 K (the background temperature of space), while the remaining face was set to radiate to 150 K (the approximate lunar surface temperature). The boundary conditions for this study are shown in Table 6. This assumes the flight computer is mounted exposed on the upper deck with no other insulation or MLI and is radiating to space. This is considered an extreme worst-case scenario.

TABLE 6
Boundary conditions for steady-state lunar simulation.

| Boundary Condition | Description | Value |
|---|---|---|
| Heat pipe | Heat power input | 5 W |
| Box external | Radiation to ambient | 4 K, ε = 0.05 |
| Heat spreader | Radiation to components | ε = 0.04 |
| Box internal | Radiation to components | ε = 0.05 |
| Standoffs | Radiation to components | ε = 0.06 |
| PC/104 boards | Radiation to components | ε = 0.80 |
| Fiberglass base | Radiation to components | ε = 0.75 |
| Single external face | Radiation to ambient | 150 K, ε = 0.05 |

The results of this study indicate that a MOWS heater supplying 5 W in a space environment would maintain flight computer temperatures between approximately 350 K and 390 K (77° C. to 117° C.). This is outside the nominal range for payloads and flight computers, but the temperature could be brought inside acceptable limits by tuning the heat input or transmitting more heat to the enclosure walls to be radiated away from the enclosure.

### II-3.6.1 Transient Lunar Environment

For the transient lunar case, boundary conditions were the same as the steady-state lunar case. However, for a first transient case, an initial temperature of 200 K was specified for all components except the mounting feet, which start at 150 K. This assumes that a MOWS heater would begin supplying heat during lunar dusk, rather than during the lunar night when components have fully cooled. The full list of boundary conditions is shown in Table 7.

TABLE 7
Boundary conditions for initial transient lunar case.

| Boundary Condition | Description | Value | |
|---|---|---|---|
| Heat pipe | Heat power input | 5 | W |
| Box external | Radiation to ambient | 4 K, ε = 0.05 | |
| Heat spreader | Radiation to components | ε = 0.04 | |
| Box internal | Radiation to components | ε = 0.05 | |
| Standoffs | Radiation to components | ε = 0.06 | |
| PC/104 boards | Radiation to components | ε = 0.80 | |
| Fiberglass base | Radiation to components | ε = 0.75 | |
| Single external face | Radiation to ambient | 150 K, ε = 0.05 | |
| Feet initial temp | Initial temperature | 150 | K |
| All other initial temps | Initial temperature | 200 | K |

The results of the first transient study indicate that a heat rate of 5 W is not sufficient to keep the enclosure within the required temperature range. Board temperatures fall from 200 K initially to approximately 65 K after 60 sec. Board temperatures do not change appreciably after this point, although the enclosure continues to cool; it appears that the boards are close to thermal equilibrium under these conditions.

A second transient case was run to determine if the heater power is sufficient to keep the boards at the required temperatures. To bracket the anticipated heater power, a heat input of 40 W was chosen for the second case, while the initial temperature was increased from 200 K to 280 K. As a lower-fidelity study, only two time steps were used to minimize computing time. The updated boundary conditions should have pushed the board temperatures as high as the required temperature range, if not past the upper bound. However, this study also showed excessively low temperatures, similar to the first study.

The lack of heating in this second case indicates that some issues remain in the transient simulation setup; increased heat input does not lead to the expected increase in board temperatures. This may be an artifact in the simulation.

### II-3.7 Test Article Manufacturing

The enclosure and flight computer required minimal manufacturing work, as a COTS enclosure and a spare Masten Xaero-B flight stack were used. The assembled flight stack is shown in FIG. 51. A copper heat spreader 5102 and red fiberglass block 5104 are indicated. The aluminum plate 5106 at the bottom is one wall of the enclosure. The heat spreader was made by brazing a short copper tube 5108 (to hold the heat pipe) to a copper plate (the heat spreader itself), which was then bolted to the top of the flight stack. The fiberglass block 5104 forms the base of the flight stack to insulate it from the enclosure.

The heat pipe from DIGI-KEY® Electronics was modified by sanding down one end to provide more area for heat transfer and bending the heat pipe to fit inside the test apparatus. Several spares were procured to ensure that the final unit did not kink during the delicate bending operation.

The reactor vessel and cap were printed on using a FORM2® SLA printer. After printing, parts were cleaned with isopropyl alcohol, then cured under UV light for 3-6 hours. The flange sealing surfaces were sanded to ensure good contact.

### II-3.8 Testing of Manufactured Article.

A testing facility was used to show the promise of the MOWS technology and applicability for use on the Moon.

### II-3.8.1 Test Apparatus.

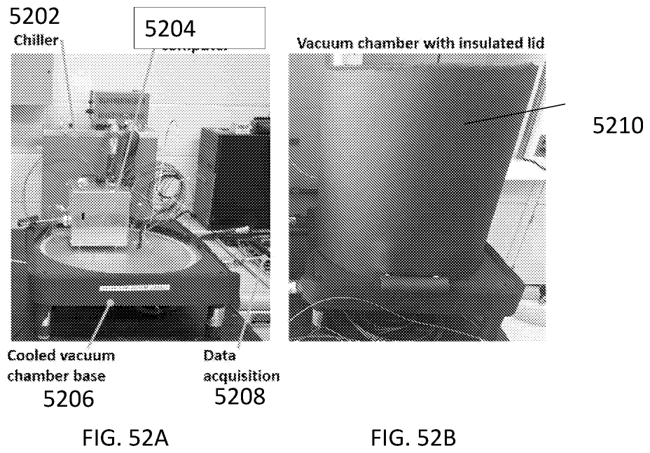

To support MOWS system-level testing and characterization under lunar night-like conditions, a laboratory-scale thermal vacuum chamber experimental facility was constructed at (I)=40 cm, H=50 cm). FIG. 52A shows the experimental setup including a chiller 5202, a flight stack 5204, a cooled vacuum base 5206, and a data acquisition unit 5208. FIG. 52B shows the experimental setup covered by a vacuum chamber 5210 with insulated lid. The chamber quickly reaches ˜1 mBar, at which pressure thermal radiation becomes the dominant mechanism of heat transfer, as on the lunar surface. The chamber base incorporates coolant passages, fed from a laboratory chiller for operation down to −10° C. Lower temperatures can be reached with open-loop liquid nitrogen cooling. The vacuum chamber has pressure instrumentation and multiple electrical and thermocouple feedthroughs for experimental logging on a dedicated data acquisition system. Liquid oxidizer can be supplied by an electronic syringe pump that gives precise control and totalization data. A flight stack is installed in an enclosure on the test stand with an integrated thermal ground plane for heat delivery from the warming system. A thin heat flux sensor (+5% uncertainty) is installed on the ground plane to measure instantaneous heat delivery to the electronics package.

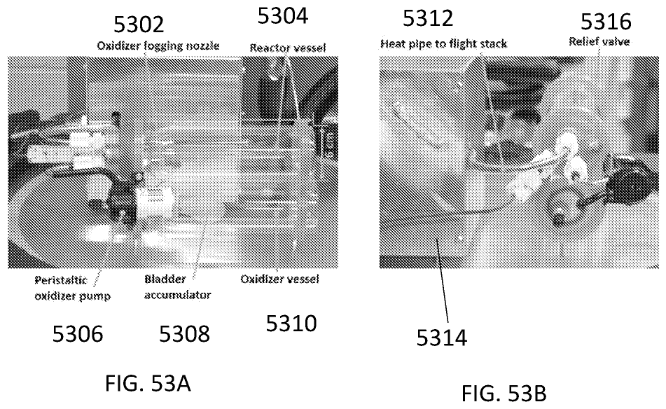

Two reactor prototypes were developed for evaluation in this facility. Unit A, illustrated by FIG. 53A-53B, was designed with an emphasis on minimizing mass for high system-specific energy. FIG. 53A shows an oxidizer fogging nozzle 5302, a reactor vessel 5304, a peristaltic oxidizer pump 5306, a bladder accumulator 5308, and an oxidizer vessel 5310. FIG. 53B shows a heat pipe 5312 to the flight stack 5314 and a relief valve 5316.)

Thin-wall blow-molded PET oxidizer and reactor vessels were used that could sustain operating pressures and would not be affected by reactant products. Additively manufactured plastic manifolds were employed for feedthroughs and porting. In this design, oxidizer is drawn from the upper vessel 5304 at a controlled rate by a miniature peristaltic dosing pump 5306. A gas-filled bladder accumulator 5308 expands as oxidizer is drawn to prevent flashing, allowing operation even in microgravity. The oxidizer is sprayed into the reactor vessel 5304 through a fogging nozzle. This nozzle atomizes and evenly disperses droplets throughout the fuel bed with low sensitivity to gravity variations. Heat is acquired from the reacting bed with a partially nickel plated (chemically resistant) heat pipe, and passively transferred to the thermal ground plane for efficient warming of the electronics enclosure. A detailed listing of reactor prototype unit A component masses is provided in Table 8.

TABLE 8
Breakdown of component masses for proof-
of-concept MOWS prototype Unit A.

| | Mass | | Mass |
|---|---|---|---|
| Component | (g) | Component | (g) |
| Oxidizer vessel (0.47 L) | 32 | Spray nozzle | 25 |
| Oxidizer manifold cap | 31 | Pressure relief valve | 28 |
| Oxidizer accumulator | 16 | Thermocouple | 10 |
| Oxidizer pump, tubing | 84 | Heat pipe | 38 |
| Reactor vessel (0.47 L) | 32 | Structural frame | 26 |
| Reactor manifold cap | 60 | | |

| | | |
|---|---|---|
| Total Hardware Mass | 356 | gm |
| Oxidizer (water) capacity | 400 | gm |
| Fuel (Li) charge | 153 | gm |
| Total system mass | 909 | gm |
| Specific system energy at 2250 Whₜₕ/kg_{reactants} | 1370 | Wh/kg |

In the Unit A breadboard prototype, reactants account for 61% of system mass. If fully charged with fuel and oxidizer, this system could potentially deliver 10 W of heat to warm thermal loads for 124 hrs. The system could be scaled up to operate for multiple lunar night cycles (approximately 340 hr each) without any increase in masses of the manifold, relief valve, nozzle, and similar components. As MOWS is matured to flight readiness, components will be mass optimized. It is anticipated that reactants could account for 85% of system mass in such a design, for a system specific thermal energy of 1900 Wh/kg, about 3× that of the highest specific energy (Li-CFx) primary batteries.

Prototype Unit B, based on the design illustrated by FIG. 46-48, had a fully additively manufactured construction. This enabled integration of heat transfer fins to acquire distributed heat throughout the reacting fuel bed and transfer it to a central passive heat pipe. The additive manufacturing construction also permitted many instrumentation ports for temperature and pressure monitoring.

### II-3.8.1 Test Procedure.

The unit A prototype was tested as previously described (see I-3.5 MOWS control study).

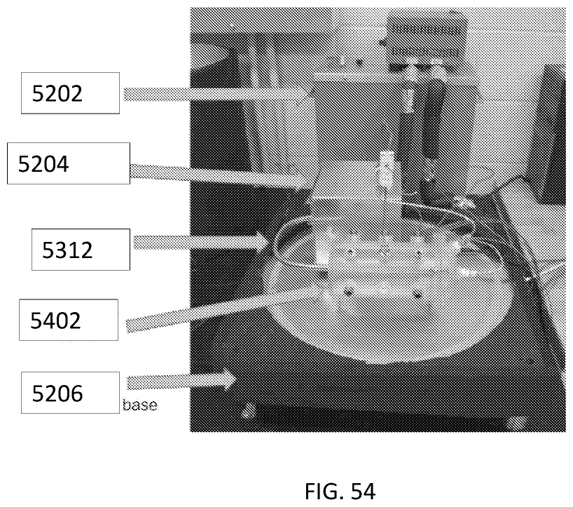

The unit B prototype can be tested similarly. FIG. 54 illustrates the experimental setup. The printed prototype 5402, chiller 5202, cooled vacuum chamber base 5206, flight stack 5204, are heat pipe 5312 are shown.

### Assessment of Technical Feasibility

The work to date shows that MOWS is technically feasible for spacecraft warming systems. Metal oxidation chemistries were found that are thermodynamically favorable, use safe and readily available reactants, function at a wide range of temperatures, and can be throttled to vary the heat output. Of the candidate chemistries, the lithium-water reaction was found to react readily and consistently, which is of great importance for heater controllability.

This reaction also has significant potential for in-situ resource utilization (ISRU). There is evidence that water exists in the coldest regions of the lunar surface, which are exactly the regions where a heating solution is needed. A MOWS heater using the lithium-water reaction could use lunar water resources to refuel itself. This would further extend mission times and minimize the system's mass, even beyond the anticipated savings compared to batteries or other warming systems.

Thermal analysis performed indicates that a system providing 5-10 W of heat input can keep a payload or flight computer within its required temperature range. Also, the throttling ability of a MOWS heater and the ability to stop and restart the reaction were thoroughly demonstrated in small-scale and integrated testing. This shows that heat input can easily be controlled in response to the temperature of the flight computer or payload being heated. In this respect, MOWS is superior to RTG-based heaters, whose heat generation cannot be paused or throttled.

The prototype MOWS heater tested by displayed consistent and controllable heating with a system mass of under 1 kg, including all reactants. Scale up calculations show MOWS represents an order-of-magnitude improvement over lithium-ion batteries or other thermal solutions. This work successfully demonstrated the feasibility of MOWS for payload and spacecraft thermal control and, given the significant interest from both government and commercial payload providers, it is anticipated that development of MOWS will continue toward future demonstrations and lunar payload integration.

Lastly, it is anticipated that such systems can have applications is other challenging environments, both terrestrial and extra-terrestrial. For example, these systems can be used on the Moon, space stations, satellites, planets such as Mars, polar regions of earth, the upper atmosphere in earth including the upper troposphere, and underwater such as oceanic trenches. Technologies for hydrogen storage such as for fuel cells can also be implemented as described herein.

### REFERENCES

Parks, R. J. “Surveyor I Mission Report. Part I—Mission Description and Performance.” NASA document 19660026658 (1966). Available at www.ntrs.nasa.gov/archive/nasa/casi.ntrs.nasa.gov/19660026658.pdf
Jet Propulsion Laboratory. “Surveyor III Mission Report. Part I—Mission Description and Performance.” NASA document 19670028267 (1967). Available at www.ntrs.nasa.gov/archive/nasa/casi.ntrs.nasa.gov/19670028267.pdf
Gunter, S. Z. et al. “Surveyor I Mission Report. Part III—Television Data.” NASA document 19670007837 (1967). Available at www.ntrs.nasa.gov/archive/nasa/casi.ntrs.nasa.gov/19670007837.pdf
Peters, Kenneth. “Lunar heat-flow experiment: Long term temperature observations on the lunar surface at Apollo sites 15 and 17.” NASA document 19760026028 (1975). Available at www.ntrs.nasa.gov/archive/nasa/casi.ntrs.nasa.gov/19760026028.pdf
“Apollo Landing Sites,” Smithsonian National Air and Space Museum, accessed October 2019 at www.airandspace.si.edu/explore-and-learn/topics/apollo/apollo-program/landing-missions/sites.cfm
Paige, David A. et al. “Diviner Lunar Radiometer Observations of Cold Traps in the Moon's South Polar Region.” Science 330 (2010): 479-482. DOI: 10.1126/science.1187726
Vasavada, Ashwin R., David A. Paige, and Stephen E. Wood. “Near-Surface Temperatures on Mercury and the Moon and the Stability of Polar Ice Deposits.” Icarus 141 (1999): 179-193. Available at www.doi.org/10.1006/icar.1999.6175
Hayne, Paul O. et al. “Evidence for exposed water ice in the Moon's south polar regions from Lunar Reconnaissance Orbiter ultraviolet albedo and temperature measurements.” Icarus 255 (2015): 58-69. Available at www.doi.org/10.1073/pnas.1802345115
Petrick, David et al. “SpaceCube v2.0 Space Flight Hybrid Reconfigurable Data Processing System.” NASA GSFC.
“Space Ruggedization Table,” Aitech, accessed October 2019.
“SP0-S 3U CompactPCI Radiation Tolerant PowerPC SBC,” Aitech, accessed October 2019 at www.rugged.com/sp0-s-3u-compactpci-radiation-tolerant-powerpc-sbc
Hawkins, Robert. “DR5 XL-1 Thermal,” CATALYST status update (2017).
“Honeybee Selected to Send Two Payloads to the Moon,” Honeybee Robotics, accessed November 2019 at www.honeybeerobotics.com/honeybee-selected-to-send-two-payloads-to-the-moon/
Manimaran, R. et al. “An Investigation of Thermal Performance of Heat Pipe Using Di-water.” Science and Technology 2 (2012): 77-80. DOI: 10.5923/j.scit.20120204.04
“Fundamentals: Effective Thermal Conductivity of a Heat Pipe,” DIGI-KEY® Corporation, accessed October 2019.
Park, Min Kyu, and Joon Hong Boo. “Thermal Performance of a Heat Pipe for Medium-Temperature Thermal Storage System.” 10th IHPS (2011). Available at www.thermalfluidscentral.org/e-resources/download.php?id=204
Ross, R. G. Jr. “Quantifying MLI Thermal Conduction in Cryogenic Applications from Experimental Data.” IOP Conf. Ser.: Mater. Sci. Eng. 101 (2015). Available at www.iopscience.iop.org/article/10.1088/1757-899X/101/1/012017/pdf
Finckenor, M. M., and D. Dooling. “Multilayer Insulation Material Guidelines.” NASA/TP—1999-209263. Available at www.ntrs.nasa.gov/archive/nasa/casi.ntrs.nasa.gov/19990047691.pdf
“Emissivity Values for Common Materials,” Infrared Thermography, accessed November 2019 at www.infrared-thermography.com/material-1.htm
“Solid-liquid Phase Diagram,” USP Technologies, accessed October 2019. Available at www.h2o2.com/technical-library/physical-chemical-properties/physical-properties/default.aspx?pid=23&name=Solid-liquid-Phase-Diagram
Burke, Kenneth A. 2003. “Fuel Cells for Space Science Applications.” NASA/TM—2003-212730, Glenn Research Center, Cleveland, OH. Available at www.ntrs.nasa.gov/archive/nasa/casi.ntrs.nasa.gov/20040010319.pdf
US Dept. of Energy. 2016. “Fuel Cells.” Fuel Cell Tech. Office Multi-Year Research, Development, and Demonstration Plan-Section 3.4. Available at www.energy.gov/sites/prod/files/2017/05/f34/fcto_myrdd_fuel_cells.pdf
Ulamec, Stephan, Jens Biele, and Ed Trollope, “How to survive a Lunar night,” Planetary and Space Science 58 (2010); 1985-1995. Available at www.dx.doi.org/10.1016/j.pss.2010.09.024
Katzan, Cynthia, David J. Brinker, and Robert Kress, “The Effects of Lunar Dust Accumulation on the Performance of Photovoltaic Arrays,” Space Photovoltaic Research and Technology Conference, May 7-9, 1991. Available at www.ntrs.nasa.gov/archive/nasa/casi.ntrs.nasa.gov/19910020924.pdf
United States Environmental Protection Agency, “Combined List of Individually-Listed Chemicals and Chemical Categories Subject to EPCRA Section 313”, accessed February 2020.

All patents and other publications identified in the specification and examples are expressly incorporated herein by reference for all purposes. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art. Furthermore, terms, such as those defined in commonly used dictionaries, should be interpreted as having a meaning that is consistent with their meaning in the context of the relevant art, and will not be interpreted in an idealized or overly formal sense unless expressly so defined herein.

While various embodiments of the present invention have been described above, it should be understood that they have been presented by way of example only, and not limitation. Numerous changes to the disclosed embodiments can be made in accordance with the disclosure herein, without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations, and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations, as may be desired and advantageous for any given or particular application.

1-138: (canceled)

139: A metal oxidation warming system comprising:
an enclosure subdivided into a plurality of compartments;
a fluid reservoir connected to a fluid manifold;
a plurality of fluid conduits connected through an inlet to the fluid manifold, each one of the plurality of fluid conduits fluidly connected to a corresponding one of the plurality of compartments through an outlet;
a thermal conduit connecting an interior of the enclosure to an exterior of the enclosure; and
a gas exhaust conduit having a first end positioned in the interior of the enclosure and a second end positioned exterior to the enclosure.

140: The metal oxidation warming system of claim 139, further comprising a mister/atomizer in line with the fluid conduits between the fluid manifold and the outlet of the fluid conduits.

141: The metal oxidation warming system of claim 139, wherein the outlet provides a mist of a liquid to the compartments.

142: The metal oxidation warming system of claim 140, wherein the outlet provides a mist of a liquid to the compartments.

143: The metal oxidation warming system of claim 139, wherein the outlet is configured as a water dripper.

144: The metal oxidation warming system of claim 139, wherein the interior of the enclosure includes an inert gas atmosphere.

145: The metal oxidation warming system of claim 139, further comprising:
a reactor including a plurality of compartments, each compartment connected to a fluid conduit, and a gas exhaust conduit having a first end positioned in the interior of the enclosure and a second end positioned exterior to the enclosure;
a fluid storage connected to a fluid manifold, the fluid manifold connected to the fluid conduit;
a thermal conduit connected to the reactor; and
a universal adaptor connected to the thermal conduit.

146: The metal oxidation warming system of claim 145, wherein:
the thermal conduit includes one or more internal walls defining an internal space, and the thermal conduit includes an external wall of the system;
the reactor, is positioned in the internal space; and
the universal adaptor is attached to the external wall.

147: The metal oxidation warming system of claim 146, wherein the fluid storage is positioned in the internal space.

148: The metal oxidation warming system of claim 147, wherein the internal space includes an opening, and the fluid storage is positioned at the opening and in contact with the reactor.

149: A co-generation system comprising:
an enclosure including a plurality of compartments, each compartment connected to a fluid conduit, and a gas exhaust conduit having a first end positioned in the interior of the enclosure and a second end positioned exterior to the enclosure;
a fluid reservoir connected to a fluid manifold, the fluid manifold connected to the fluid conduit;
a fuel cell connected to the second end of the gas conduit;
a thermal conduit connected to a reactor and directly or indirectly connected to the fuel cell; and
a universal adaptor connected to the fuel cell and to the thermal conduit.

150: A method of heating an object and producing electricity, the method comprising:
placing an active metal in a compartment of a co-generation system according to claim 149;
adding fluid to the fluid reservoir;
flowing the fluid to the fluid manifold;
flowing the fluid from the fluid manifold through the fluid conduit to the compartment; allowing the fluid to exothermically react with the active metal and produce hydrogen; directing the heat produced to an object by contacting the second end of the thermal conduit to the object; and
providing the hydrogen produced by the reaction to the fuel cell through the gas conduit.

151: The co-generation system of claim 149, wherein:
the thermal conduit includes an internal wall defining an internal space, and the thermal conduit includes an external wall of the system;
the reactor, the fluid reservoir, and the fuel cell are positioned in the internal space; and the universal adaptor is attached to the external wall.

152: The co-generation system of claim 151, wherein the system is configured as a rectangular, cylindrical, or spherical object, wherein the thermal conduit surrounds the enclosure, the enclosure surrounds the fluid reservoir, and the fluid reservoir surrounds the fuel cell, wherein the thermal conduit is indirectly connected to the fuel cell.

153: The co-generation system of claim 151, wherein the system is configured as a rectangular object wherein the fluid reservoir is connected on a first side to the fuel cell, the fluid reservoir is connected on a second side to the enclosure, and the fuel cell and reactor are connected to the internal wall of the thermal conduit.

154: A hydrogen storage system comprising:
an enclosure subdivided into a plurality of compartments;
a fluid reservoir connected to a fluid manifold;
a plurality of fluid conduits connected through an inlet to the fluid manifold, each one of the plurality of fluid conduits fluidly connected to a corresponding one of the plurality of compartments through an outlet; and
a hydrogen exhaust conduit having a first end positioned in the interior of the enclosure and a second end positioned exterior to the enclosure.

155: The hydrogen storage system of claim 154, wherein at least one of the compartments includes an active metal, wherein the active metal reacts with water producing hydrogen.

156: The hydrogen storage system of claim 155, wherein the active metal is an alkali metal, an alkali earth metal, a first row transition metal, a main group metal, a metalloid, yttrium, zirconium, a hydride thereof, a mixture thereof, or a salt thereof.

157: The hydrogen storage system of claim 156, wherein the active metal is a metal selected from the group consisting of Li, LiH, NaH, AlH₃, LiBH₄, NaBH₄, CaH₂, Al(BH₄)₃, and MgH₂.

158: The hydrogen storage system of claim 157, wherein the active metal is a finely divided powder with an average particle size diameter below about 10 mm.
